(19) United States
(12) Patent Application Publication
(10) Pub. No.: US 2026/0313452 A1
(43) Pub. Date: Oct. 8, 2026

(54) INTERWORKING BETWEEN CONGESTION INFORMATION EXPOSURE MECHANISMS FOR WIRELESS COMMUNICATIONS

(71) Applicant: Telefonaktiebolaget LM Ericsson (publ), Stockholm (SE)

(72) Inventors: Maria Luisa MAS ROSIQUE, Madrid (ES); Fuencisla GARCIA AZORERO, Madrid (ES); Ignacio RIVAS MOLINA, Madrid (ES); Paul SCHLIWA-BERTLING, Ljungsbro (SE); Angelo CENTONZA, Granada (ES)

(21) Appl. No.: 19/481,382

(22) PCT Filed: May 10, 2024
(86) PCT No.: PCT/IB2024/054577

§ 371 Date: Nov. 4, 2025

(30) Foreign Application Priority Data
May 12, 2023 (EP) 23382446.5

(51) Int. Cl. H04W 28/02; H04L 12/14

(52) U.S. Cl. CPC H04W 28/0289; H04L 12/1407

(57) ABSTRACT

A method, system and apparatus are disclosed. According to some embodiments, a method implemented by a core node is provided. The method includes managing a first congestion mechanism that is based on at least one Policy and Charging Control, PCC, rule, and managing the second congestion mechanism that is based on the at least one PCC rule where the managing of the first congestion mechanism is associated with one of enabling and disabling the first congestion mechanism based on an availability of the second congestion mechanism.

### FIELD

The present disclosure relates to wireless communications, and in particular, to interworking between congestion information exposure mechanisms.

### BACKGROUND

The Third Generation Partnership Project (3GPP) has developed and is developing standards for Fourth Generation (4G) (also referred to as Long Term Evolution (LTE)) and Fifth Generation (5G) (also referred to as New Radio (NR)) wireless communication systems. Such systems provide, among other features, broadband communication between network nodes, such as base stations, and mobile wireless devices (WD), as well as communication between network nodes and between WDs. The 3GPP is also developing standards for Sixth Generation (6G) wireless communication networks.

FIG. 1 is a block diagram of 5G reference architecture of policy and charging control framework as defined by 3GPP.

Some architectural aspects that are described below are as follows:
AF (Application Function)
PCF (Policy Control Function)
SMF (Session Management Function)
UPF (User Plane Function)
(R)AN ((Radio) Access Network)

As used herein, NG-RAN is a Radio access network that supports one or more of the following options with the common characteristics that it connects to 5GC:
1) Standalone New Radio.
2) New Radio is the anchor with E-UTRA extensions.
3) Standalone E-UTRA.

### AF

AF represents an external trusted or non-trusted function integrated in the operator network that interacts with 5GC. When the AF is non-trusted, a NEF (Network Exposure Function) may be required between the untrusted network and the 5GC. For ease of explanation, only the AF is considered below. The trusted AF/NEF is part of the 5GC architecture and uses the mechanisms and interfaces specified for 5GC and OAM.

In this scope, AF may request measurements of QoS parameters to the 5GS.

### PCF (Policy Control Function)

The Policy Control function (PCF) supports different functionality, e.g., unified policy framework to govern network behavior, provides policy rules to Control Plane function(s) to enforce them, and accesses subscription information relevant for policy decisions in a Unified Data Repository (UDR).

In this scope, PCF is the receiver of AF Subscription to measurements of QoS parameters, e.g. those provided by QoS Monitoring described below.

### SMF (Session Management Function)

The Session Management function (SMF) supports different functionalities, e.g., SMF receives PCC rules from the PCF and configures the UPF accordingly. In this scope, SMF may receive PCC rules from PCF which may include QoS and QoS Monitoring requirements

SMF is the network function that has the information of which network slice is the user PDU Session and which DN it accesses, e.g., which UPFs conform the user PDU Session and their role, e.g., PDU Session Anchor (PSA).

### UPF (User Plane Function)

The User Plane function (UPF) supports handling of user plane traffic based on the rules received from the SMF, e.g., packet inspection and different enforcement actions such as QoS handling.

In this scope, UPF may receive instructions by means of Session Reporting Rules (SRRs) to perform QoS Monitoring on certain QoS Flows of the PDU Session and report to SMF or another target entity.

### Congestion Information for XR Services (AR/VR Applications) and Interactive Media Services

3GPP is specifying as part of Release'18 5GS functionalities for support of XR services (AR/VR applications) and interactive media services that require high data rate and low latency communication, e.g., cloud gaming and tactile/multi-modal communication services. One such functionality is ECN Marking for L4S to expose Congestion Information (e.g., clause 5.37.3 in 3GPP TR 23.501 v18.1.0). Another is the extension of 5GS QoS monitoring functionality to also provide congestion information (e.g., clause 5.45.3 in 3GPP TR 23.501 v18.1.0). Both mechanisms can be used to expose 5G congestion information to applications that end-points can use to adapt their sending data rate.

### ECN Marking for L4S

L4S (Low Latency, Low Loss and Scalable Throughput) is described in, for example, IETF RFC 9330 [159], IETF RFC 9331 and IETF RFC 9332 [161]. L4S exposes congestion information by marking ECN bits in the IP header of the user IP packets between the wireless device and the application server to trigger application layer rate adaptation.

In 5GS, ECN marking for L4S is enabled on a per QoS Flow basis in the uplink and/or downlink direction and may be used for GBR and non-GBR QoS Flows. ECN marking for the L4S in the IP header is supported in either the NG-RAN (e.g., clause 5.37.3.2 and 3GPP TS 38.300 [27]), or in the PSA UPF (e.g., clause 5.37.3.3). Whether RAN or PSA UPF based ECN marking for L4S is used is determined by the SMF based on the operator's network configuration and policies. In the case of ECN marking for L4S by UPF, the NG-RAN is instructed to provide UPF with congestion information.

How ECN marking for L4S is enabled and how SMF sends instructions towards NG-RAN and UPF was discussed in, for example, SA2 WG #156e (e.g., 3GPP SA2 WG TDOC S2-2306190 and 3GPP SA2 WG TDOC S2-2306241)

It is a 3GPP assumption that the support for ECN marking for L4S may not be homogeneous in the network and that during, e.g., mobility due, e.g., to inter NG-RAN handover or local UPF PSA change, ECN marking for L4S support may not be available in the network.

Congestion Information Exposure with QoS Monitoring

QoS monitoring comprises measurements of QoS parameters for certain traffic flows that can be enabled based on the requests received from the AF and/or operator policies configured in the PCF. Examples include UL or DL packets delays between the wireless device and UPF PSA.

The PCF generates an authorized QoS Monitoring policy, e.g., based on the QoS Monitoring request received from the AF (as described in, e.g., 3GPP TR 23.503 v18.1.0 in clause 6.1.3.21) that includes in the PCC (Policy Control and Charging) rule together with QoS requirements and other requirements on that same traffic. PCC Rules are sent to SMF.

Based on this QoS Monitoring policy and/or local configuration, the SMF configures the UPF and the NG-RAN (when needed) to perform QoS monitoring and to report the monitoring results. When Congestion Information Monitoring is requested, SMF requests the NG-RAN to report congestion information via GTP-U header to UPF and to PSA UPF to expose the received information. The NG-RAN provided information is the same that is provided to UPF PSA to support ECN marking for L4S in PSA UPF described above.

While the NG-RAN provided information is same that is provided to UPF PSA to support ECN marking for L4S in PSA UPF, existing 3GPP specification does not specify how these two mechanisms are to coexist.

### SUMMARY

Some embodiments advantageously provide methods, systems, and apparatuses for interworking between congestion information exposure mechanisms.

One or more embodiments described herein solve at least one problem with existing systems by at least, in part, providing both mechanisms for congestion information exposure that can be enabled by the PCC Rule simultaneously, but they are not activated simultaneously by the SMF (e.g., no application should require receiving this information by two means at same time when information originates from same place (NG-RAN). SMF may give precedence to L4S marking for ECN and monitors 5GS support to ECN marking for L4S to (de) activate the QoS monitoring of Congestion information only when needed.

According to one aspect of the present disclosure, a method implemented by a core node is provided. A first congestion mechanism that is based on at least one Policy and Charging Control, PCC, rule is managed. The second congestion mechanism that is based on the at least one PCC rule is managed. The managing of the first congestion mechanism is associated with one of enabling and disabling the first congestion mechanism based on an availability of the second congestion mechanism.

According to one or more embodiments of this aspect, the first congestion mechanism is Quality of Service, QoS, monitoring, and the second congestion mechanism is Low Latency, Low Loss and Scalable Throughput, L4S, marking for Explicit Congestion Notification, ECN.

According to one or more embodiments of this aspect, the managing of the first congestion mechanism is associated with enabling the first congestion mechanism if the second congestion mechanism is unavailable.

According to one or more embodiments of this aspect, the first congestion mechanism is Quality of Service, QoS, monitoring and the second congestion mechanism is Low Latency, Low Loss and Scalable Throughput, L4S, marking for Explicit Congestion Notification, ECN, and the managing of the first congestion mechanism is associated with enabling the first congestion mechanism if the second congestion mechanism is unavailable.

According to one or more embodiments of this aspect, t the second congestion mechanism is prioritized over the first congestion mechanism.

According to one or more embodiments of this aspect, binding is performed to the at least one PCC rule to a Quality of Service, QoS, flow to take into account a requirement to apply QoS monitoring, and one of the first and second congestion mechanism being applied to the QoS flow based on the managing of the first and second congestion mechanism.

According to one or more embodiments of this aspect, a notification indicating that at least one of the first congestion mechanism and the second congestion mechanism indicated during protocol data unit, PDU, session establishment is supported by the target network node is received from the target network node. One of the first congestion mechanism and the second congestion mechanism is enabled based on the notification.

According to one or more embodiments of this aspect, a notification that one of the first congestion mechanism and the second congestion mechanism is not available at a target network node associated with a handover is received.

According to one or more embodiments of this aspect, congestion information is provided to at least one application end point based on one of the first and second congestion mechanism that is enabled.

According to one or more embodiments of this aspect, the core node is an application function, AF.

According to another aspect of the present disclosure, a core node configured to: manage a first congestion mechanism that is based on at least one Policy and Charging Control, PCC, rule, manage the second congestion mechanism that is based on the at least one PCC rule, and the managing of the first congestion mechanism is associated with one of enabling and disabling the first congestion mechanism based on an availability of the second congestion mechanism.

According to one or more embodiments of this aspect, the first congestion mechanism is Quality of Service, QoS, monitoring, and the second congestion mechanism is Low Latency, Low Loss and Scalable Throughput, L4S, marking for Explicit Congestion Notification, ECN.

According to one or more embodiments of this aspect, the managing of the first congestion mechanism is associated with activating the first congestion mechanism if the second congestion mechanism is unavailable.

According to one or more embodiments of this aspect, the first congestion mechanism is Quality of Service, QoS, monitoring and the second congestion mechanism is Low Latency, Low Loss and Scalable Throughput, L4S, marking for Explicit Congestion Notification, ECN, and the managing of the first congestion mechanism is associated with enabling the first congestion mechanism if the second congestion mechanism is unavailable.

According to one or more embodiments of this aspect, the core node is configured to prioritize the second congestion mechanism over the first congestion mechanism.

According to one or more embodiments of this aspect, the core node is configured to bind the at least one PCC rule to a Quality of Service, QoS, flow to take into account a requirement to apply QoS monitoring, and one of the first and second congestion mechanism being applied to the QoS flow based on the managing of the first and second congestion mechanism.

According to one or more embodiments of this aspect, the core node is configured to: receive, from a target handover network node, a notification indicating that at least one of the first congestion mechanism and the second congestion mechanism indicated during during protocol data unit, PDU, session establishment is supported by the target network node, and enable one of the first congestion mechanism and the second congestion mechanism based on the notification.

According to one or more embodiments of this aspect, the core node is further configured to receive a notification that one of the first congestion mechanism and the second congestion mechanism is not supported at a target network node associated with a handover.

According to one or more embodiments of this aspect, the core node is further configured to provide, to at least one application end point, congestion information based on one of the first and second congestion mechanism that is enabled.

According to one or more embodiments of this aspect, the core node is an application function, AF.

According to another aspect of the present disclosure, a method implemented by a network node is provided. A request to implement one of a first congestion mechanism and a second congestion mechanism is received where the first congestion mechanism is Quality of Service, QoS, monitoring and the second congestion mechanism is Low Latency, Low Loss and Scalable Throughput, L4S, marking for Explicit Congestion Notification, ECN. A determination is performed as to whether the requested one of the first congestion mechanism or the second congestion mechanism is supported at the network node. If the requested one of the first congestion mechanism or the second congestion mechanism is not supported by the network node, an indication is provided to a core node that the request is not supported.

According to one or more embodiments of this aspect, if the requested one of the first congestion mechanism or the second congestion mechanism is supported by the network node, an indication is provided to the core node that the request is supported, and the network node 16 implements the requested one of the first congestion mechanism or the second congestion mechanism.

According to one or more embodiments of this aspect, the indication comprises one of: a list of QoS flows with ECN markings for L4S that are one of enabled and disabled; and a list of QoS flows with a QoS monitoring configuration that are one of enabled and disabled.

According to one or more embodiments of this aspect, the indication is an implicit indication that does not include information associated with whether one of ECN markings for L4S or QoS monitoring is enabled or disabled.

According to one or more embodiments of this aspect, the core node is an application function, AF.

According to one or more embodiments of this aspect, the network node is a target network node, and the request is received from one of a source network node and core node.

According to another aspect of the present disclosure, a network node configured to: receive a request to implement one of a first congestion mechanism and a second congestion mechanism, where the first congestion mechanism is Quality of Service, QoS, monitoring and the second congestion mechanism is Low Latency, Low Loss and Scalable Throughput, L4S, marking for Explicit Congestion Notification, ECN, determine whether the requested one of the first congestion mechanism or the second congestion mechanism is supported at the network node, and if the requested one of the first congestion mechanism or the second congestion mechanism is not supported by the network node, indicate, to a core node, that the request is not supported.

According to one or more embodiments of this aspect, the network node is further configured to: if the requested one of the first congestion mechanism or the second congestion mechanism is supported by the network node, indicate, to the core node, that the request is supported, and implement the requested one of the first congestion mechanism or the second congestion mechanism.

According to one or more embodiments of this aspect, the indication comprises one of: a list of QoS flows with ECN markings for L4S that are one of enabled and disabled, and a list of QoS flows with a QoS monitoring configuration that are one of enabled and disabled.

According to one or more embodiments of this aspect, the indication is an implicit indication that does not include information associated with whether one of ECN markings for L4S or QoS monitoring is enabled or disabled.

According to one or more embodiments of this aspect, the core node is an application function, AF.

According to one or more embodiments of this aspect, the network node is a target network node, and the request is received from one of a source network node and core node.

### BRIEF DESCRIPTION OF THE DRAWINGS

A more complete understanding of the present embodiments, and the attendant advantages and features thereof, will be more readily understood by reference to the following detailed description when considered in conjunction with the accompanying drawings wherein:

FIG. 1 is a diagram of a reference architecture of policy and charging control framework;

FIG. 2 is a schematic diagram of an example network architecture illustrating a communication system connected via an intermediate network to a host computer according to the principles in the present disclosure;

FIG. 3 is a block diagram of a host computer communicating via a network node with a wireless device over an at least partially wireless connection according to some embodiments of the present disclosure;

FIG. 4 is a flowchart illustrating example methods implemented in a communication system including a host computer, a network node and a wireless device for executing a client application at a wireless device according to some embodiments of the present disclosure;

FIG. 5 is a flowchart illustrating example methods implemented in a communication system including a host computer, a network node and a wireless device for receiving user data at a wireless device according to some embodiments of the present disclosure;

FIG. 6 is a flowchart illustrating example methods implemented in a communication system including a host computer, a network node and a wireless device for receiving user data from the wireless device at a host computer according to some embodiments of the present disclosure;

FIG. 7 is a flowchart illustrating example methods implemented in a communication system including a host computer, a network node and a wireless device for receiving user data at a host computer according to some embodiments of the present disclosure;

FIG. 8 is a flowchart of an example process in a core node according to some embodiments of the present disclosure;

FIG. 9 is a flowchart of another example process in a core node according to some embodiments of the present disclosure;

FIG. 10 is a flowchart of an example process in a network node according to some embodiments of the present disclosure;

FIG. 11 is a signaling diagram of an example Xn based inter NG-RAN handover without UPF re-allocation;

FIG. 12 is a signaling diagram of an example inter NG-RAN N2 based handover in the preparation phase;

FIG. 13 is a diagram of an example of UE-requested PDU Session Establishment for non-roaming and roaming with local breakout;

FIG. 14 is a diagram of an example of UE or network requested PDU Session Modification (for non-roaming and roaming with local breakout);

FIG. 15 is a diagram of an example of Xn based inter NG-RAN handover without UPF re-allocation;

FIG. 16 is a diagram of an example of Inter NG-RAN node N2 based handover, Preparation phase; and

FIG. 17 is a diagram of an example of inter NG-RAN node N2 based handover, execution phase.

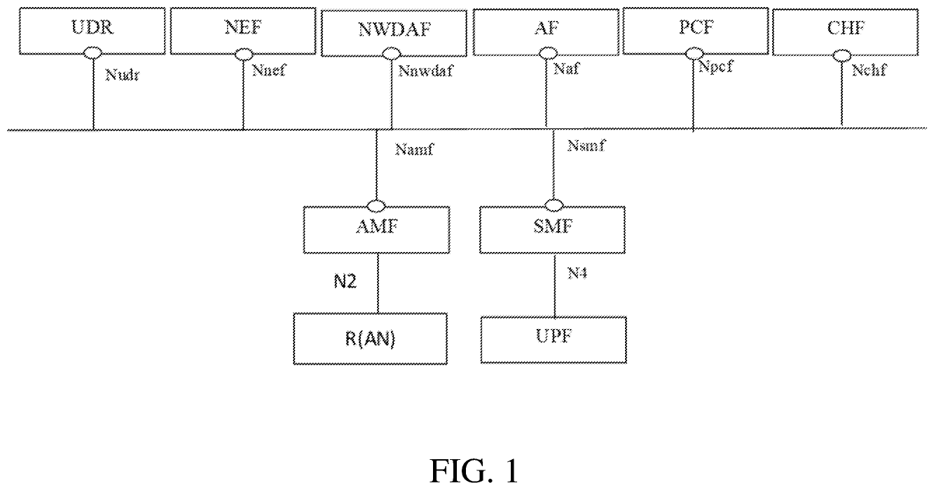

### DETAILED DESCRIPTION

As discussed above, specifications do not clarify how the NG-RAN provided information and ECN marking for L4S based information (e.g., two mechanisms) to expose congestion information are to coexist and whether they interwork:
Since both pursue the same or substantially similar purpose, that is, providing congestion information to application end points so that the application end points can use the congestion information to adapt their data rates, enabling both of them simultaneously can consume network resources for no added value.
AF could activate/deactivate the congestion information QoS Monitoring request based on awareness of ECN marking for L4S availability (e.g., via explicit system notification or monitoring ECN marking and/or as described herein). But it is unclear whether there are drivers for the AF to implement such a mechanism. This activation/deactivation may stress the system, e.g., if users switch often between areas with different ECN marking for L4S support.

One or more embodiments described herein solve at least one problem with existing systems by at least, in part, providing both mechanisms for congestion information exposure that can be enabled by the PCC Rule simultaneously, but they are not activated simultaneously by the SMF (e.g., no application should require receiving this information by two means at same time when information originates from same place (NG-RAN). SMF may give precedence to L4S marking for ECN and monitors 5GS support to ECN marking for L4S to (de) activate the QoS monitoring of Congestion information only when needed.

Before describing in detail example embodiments, it is noted that the embodiments reside primarily in combinations of apparatus components and processing steps related to interworking between congestion information exposure mechanisms. Accordingly, components have been represented where appropriate by conventional symbols in the drawings, showing only those specific details that are pertinent to understanding the embodiments so as not to obscure the disclosure with details that will be readily apparent to those of ordinary skill in the art having the benefit of the description herein. Like numbers refer to like elements throughout the description.

As used herein, relational terms, such as “first” and “second,” “top” and “bottom,” and the like, may be used solely to distinguish one entity or element from another entity or element without necessarily requiring or implying any physical or logical relationship or order between such entities or elements. The terminology used herein is for the purpose of describing particular embodiments only and is not intended to be limiting of the concepts described herein. As used herein, the singular forms “a”, “an” and “the” are intended to include the plural forms as well, unless the context clearly indicates otherwise. It will be further understood that the terms “comprises,” “comprising,” “includes” and/or “including” when used herein, specify the presence of stated features, integers, steps, operations, elements, and/or components, but do not preclude the presence or addition of one or more other features, integers, steps, operations, elements, components, and/or groups thereof.

In embodiments described herein, the joining term, “in communication with” and the like, may be used to indicate electrical or data communication, which may be accomplished by physical contact, induction, electromagnetic radiation, radio signaling, infrared signaling or optical signaling, for example. One having ordinary skill in the art will appreciate that multiple components may interoperate and modifications and variations are possible of achieving the electrical and data communication.

In some embodiments described herein, the term “coupled,” “connected,” and the like, may be used herein to indicate a connection, although not necessarily directly, and may include wired and/or wireless connections.

The term “network node” used herein can be any kind of network node comprised in a radio network which may further comprise any of base station (BS), radio base station, base transceiver station (BTS), base station controller (BSC), radio network controller (RNC), g Node B (gNB), evolved Node B (eNB or eNodeB), Node B, multi-standard radio (MSR) radio node such as MSR BS, multi-cell/multicast coordination entity (MCE), integrated access and backhaul (IAB) node, relay node, donor node controlling relay, radio access point (AP), transmission points, transmission nodes, Remote Radio Unit (RRU) Remote Radio Head (RRH), a core network node (e.g., mobile management entity (MME), self-organizing network (SON) node, a coordinating node, positioning node, MDT node, etc.), an external node (e.g., 3rd party node, a node external to the current network), nodes in distributed antenna system (DAS), a spectrum access system (SAS) node, an element management system (EMS), etc. The network node may also comprise test equipment. The term “radio node” used herein may be used to also denote a wireless device (WD) such as a wireless device (WD) or a radio network node.

In some embodiments, the non-limiting terms wireless device (WD) or a user equipment (UE) are used interchangeably. The WD herein can be any type of wireless device capable of communicating with a network node or another WD over radio signals, such as wireless device (WD). The WD may also be a radio communication device, target device, device to device (D2D) WD, machine type WD or WD capable of machine to machine communication (M2M), low-cost and/or low-complexity WD, a sensor equipped with WD, Tablet, mobile terminals, smart phone, laptop embedded equipped (LEE), laptop mounted equipment (LME), USB dongles, Customer Premises Equipment (CPE), an Internet of Things (IoT) device, or a Narrowband IoT (NB-IOT) device, etc.

Also, in some embodiments the generic term “radio network node” is used. It can be any kind of a radio network node which may comprise any of base station, radio base station, base transceiver station, base station controller, network controller, RNC, evolved

Node B (eNB), Node B, gNB, Multi-cell/multicast Coordination Entity (MCE), IAB node, relay node, access point, radio access point, Remote Radio Unit (RRU) Remote Radio Head (RRH).

Note that although terminology from one particular wireless system, such as, for example, 3GPP LTE and/or New Radio (NR), may be used in this disclosure, this should not be seen as limiting the scope of the disclosure to only the aforementioned system. Other wireless systems, including without limitation Wide Band Code Division Multiple Access (WCDMA), Worldwide Interoperability for Microwave Access (WiMax), Ultra Mobile Broadband (UMB) and Global System for Mobile Communications (GSM), may also benefit from exploiting the ideas covered within this disclosure.

Note further, that functions described herein as being performed by a wireless device or a network node may be distributed over a plurality of wireless devices and/or network nodes. In other words, it is contemplated that the functions of the network node and wireless device described herein are not limited to performance by a single physical device and, in fact, can be distributed among several physical devices.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

Some embodiments provide [introduce the invention; i.e., briefly explain what the invention is all about]

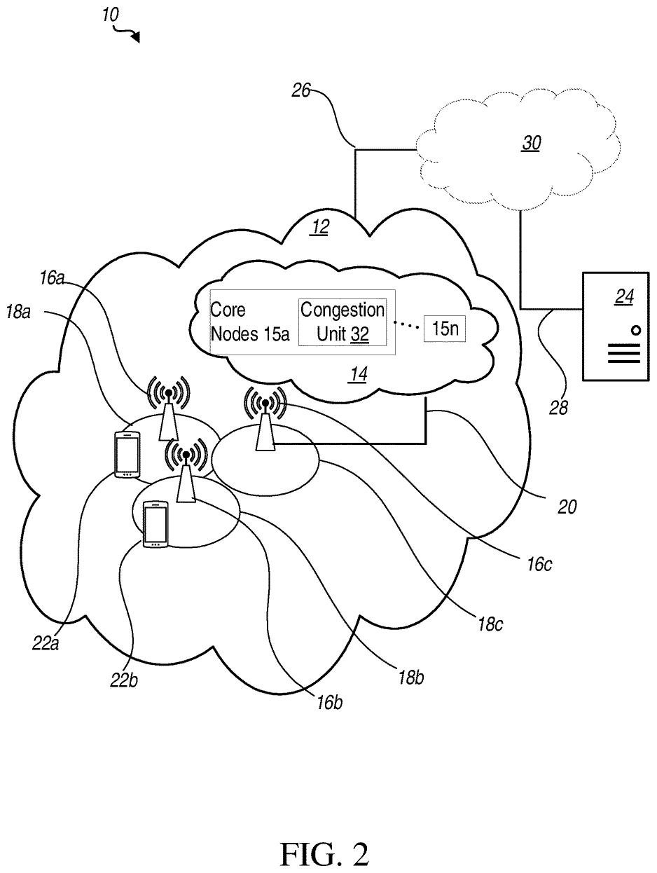

Referring again to the drawing figures, in which like elements are referred to by like reference numerals, there is shown in FIG. 2 a schematic diagram of a communication system 10, according to an embodiment, such as a 3GPP-type cellular network that may support standards such as LTE and/or NR (5G), which comprises an access network 12, such as a radio access network, and a core network 14 that includes one or more core nodes 15a-15n (referred to collectively as core node 15). According to one or more embodiments, core nodes 15a-15n may include one or more of AF, PCF, SMF, UPF, etc. The access network 12 comprises a plurality of network nodes 16a, 16b, 16c (referred to collectively as network nodes 16), such as NBs, eNBs, gNBs or other types of wireless access points, each defining a corresponding coverage area 18a, 18b, 18c (referred to collectively as coverage areas 18). Each network node 16a, 16b, 16c is connectable to the core network 14 over a wired or wireless connection 20. A first wireless device (WD) 22a located in coverage area 18a is configured to wirelessly connect to, or be paged by, the corresponding network node 16a. A second WD 22b in coverage area 18b is wirelessly connectable to the corresponding network node 16b. While a plurality of WDs 22a, 22b (collectively referred to as wireless devices 22) are illustrated in this example, the disclosed embodiments are equally applicable to a situation where a sole WD is in the coverage area or where a sole WD is connecting to the corresponding network node 16. Note that although only two WDs 22 and three network nodes 16 are shown for convenience, the communication system may include many more WDs 22 and network nodes 16.

Also, it is contemplated that a WD 22 can be in simultaneous communication and/or configured to separately communicate with more than one network node 16 and more than one type of network node 16. For example, a WD 22 can have dual connectivity with a network node 16 that supports LTE and the same or a different network node 16 that supports NR. As an example, WD 22 can be in communication with an eNB for LTE/E-UTRAN and a gNB for NR/NG-RAN.

The communication system 10 may itself be connected to a host computer 24, which may be embodied in the hardware and/or software of a standalone server, a cloud-implemented server, a distributed server or as processing resources in a server farm. The host computer 24 may be under the ownership or control of a service provider, or may be operated by the service provider or on behalf of the service provider. The connections 26, 28 between the communication system 10 and the host computer 24 may extend directly from the core network 14 to the host computer 24 or may extend via an optional intermediate network 30. The intermediate network 30 may be one of, or a combination of more than one of, a public, private or hosted network. The intermediate network 30, if any, may be a backbone network or the Internet. In some embodiments, the intermediate network 30 may comprise two or more sub-networks (not shown).

The communication system of FIG. 2 as a whole enables connectivity between one of the connected WDs 22a, 22b and the host computer 24. The connectivity may be described as an over-the-top (OTT) connection. The host computer 24 and the connected WDs 22a, 22b are configured to communicate data and/or signaling via the OTT connection, using the access network 12, the core network 14, any intermediate network 30 and possible further infrastructure (not shown) as intermediaries. The OTT connection may be transparent in the sense that at least some of the participating communication devices through which the OTT connection passes are unaware of routing of uplink and downlink communications. For example, a network node 16 may not or need not be informed about the past routing of an incoming downlink communication with data originating from a host computer 24 to be forwarded (e.g., handed over) to a connected WD 22a. Similarly, the network node 16 need not be aware of the future routing of an outgoing uplink communication originating from the WD 22a towards the host computer 24.

A core node 15 is configured to include a congestion unit 32 which is configured to perform one or more core node 15 functions as described herein such as with respect to, for example, interworking between congestion information exposure mechanisms.

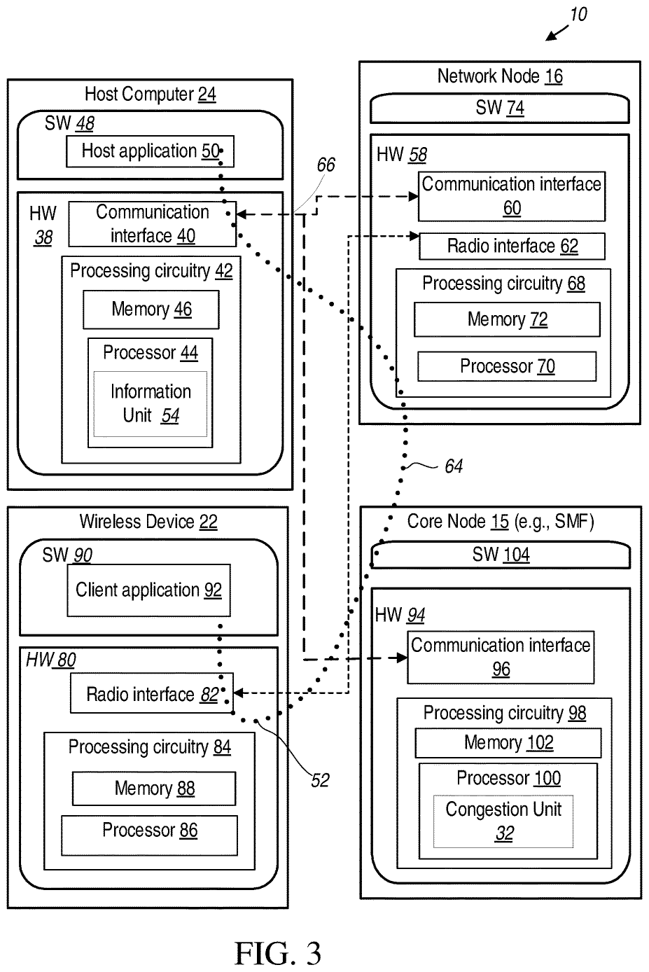

Example implementations, in accordance with an embodiment, of the WD 22, network node 16 and host computer 24 discussed in the preceding paragraphs will now be described with reference to FIG. 3. In a communication system 10, a host computer 24 comprises hardware (HW) 38 including a communication interface 40 configured to set up and maintain a wired or wireless connection with an interface of a different communication device of the communication system 10. The host computer 24 further comprises processing circuitry 42, which may have storage and/or processing capabilities. The processing circuitry 42 may include a processor 44 and memory 46. In particular, in addition to or instead of a processor, such as a central processing unit, and memory, the processing circuitry 42 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 44 may be configured to access (e.g., write to and/or read from) memory 46, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Processing circuitry 42 may be configured to control any of the methods and/or processes described herein and/or to cause such methods, and/or processes to be performed, e.g., by host computer 24. Processor 44 corresponds to one or more processors 44 for performing host computer 24 functions described herein. The host computer 24 includes memory 46 that is configured to store data, programmatic software code and/or other information described herein. In some embodiments, the software 48 and/or the host application 50 may include instructions that, when executed by the processor 44 and/or processing circuitry 42, causes the processor 44 and/or processing circuitry 42 to perform the processes described herein with respect to host computer 24. The instructions may be software associated with the host computer 24.

The software 48 may be executable by the processing circuitry 42. The software 48 includes a host application 50. The host application 50 may be operable to provide a service to a remote user, such as a WD 22 connecting via an OTT connection 52 terminating at the WD 22 and the host computer 24. In providing the service to the remote user, the host application 50 may provide user data which is transmitted using the OTT connection 52. The “user data” may be data and information described herein as implementing the described functionality. In one embodiment, the host computer 24 may be configured for providing control and functionality to a service provider and may be operated by the service provider or on behalf of the service provider. The processing circuitry 42 of the host computer 24 may enable the host computer 24 to observe, monitor, control, transmit to and/or receive from the network node 16 and or the wireless device 22. The processing circuitry 42 of the host computer 24 may include an information unit 54 configured to enable the service provider to one or more of process, analyze, store, forward, relay, transmit, receive, indicate, etc. information related to interworking between congestion information exposure mechanisms.

The communication system 10 further includes a network node 16 provided in a communication system 10 and including hardware 58 enabling it to communicate with the host computer 24 and with the WD 22. The hardware 58 may include a communication interface 60 for setting up and maintaining a wired or wireless connection with an interface of a different communication device of the communication system 10, as well as a radio interface 62 for setting up and maintaining at least a wireless connection 64 with a WD 22 located in a coverage area 18 served by the network node 16. The radio interface 62 may be formed as or may include, for example, one or more RF transmitters, one or more RF receivers, and/or one or more RF transceivers. The communication interface 60 may be configured to facilitate a connection 66 to the host computer 24. The connection 66 may be direct or it may pass through a core network 14 of the communication system 10 and/or through one or more intermediate networks 30 outside the communication system 10.

In the embodiment shown, the hardware 58 of the network node 16 further includes processing circuitry 68. The processing circuitry 68 may include a processor 70 and a memory 72. In particular, in addition to or instead of a processor, such as a central processing unit, and memory, the processing circuitry 68 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 70 may be configured to access (e.g., write to and/or read from) the memory 72, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Thus, the network node 16 further has software 74 stored internally in, for example, memory 72, or stored in external memory (e.g., database, storage array, network storage device, etc.) accessible by the network node 16 via an external connection. The software 74 may be executable by the processing circuitry 68. The processing circuitry 68 may be configured to control any of the methods and/or processes described herein and/or to cause such methods, and/or processes to be performed, e.g., by network node 16. Processor 70 corresponds to one or more processors 70 for performing network node 16 functions described herein. The memory 72 is configured to store data, programmatic software code and/or other information described herein. In some embodiments, the software 74 may include instructions that, when executed by the processor 70 and/or processing circuitry 68, causes the processor 70 and/or processing circuitry 68 to perform the processes described herein with respect to network node 16.

The communication system 10 further includes the WD 22 already referred to. The WD 22 may have hardware 80 that may include a radio interface 82 configured to set up and maintain a wireless connection 64 with a network node 16 serving a coverage area 18 in which the WD 22 is currently located. The radio interface 82 may be formed as or may include, for example, one or more RF transmitters, one or more RF receivers, and/or one or more RF transceivers.

The hardware 80 of the WD 22 further includes processing circuitry 84. The processing circuitry 84 may include a processor 86 and memory 88. In particular, in addition to or instead of a processor, such as a central processing unit, and memory, the processing circuitry 84 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 86 may be configured to access (e.g., write to and/or read from) memory 88, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Thus, the WD 22 may further comprise software 90, which is stored in, for example, memory 88 at the WD 22, or stored in external memory (e.g., database, storage array, network storage device, etc.) accessible by the WD 22. The software 90 may be executable by the processing circuitry 84. The software 90 may include a client application 92. The client application 92 may be operable to provide a service to a human or non-human user via the WD 22, with the support of the host computer 24. In the host computer 24, an executing host application 50 may communicate with the executing client application 92 via the OTT connection 52 terminating at the WD 22 and the host computer 24. In providing the service to the user, the client application 92 may receive request data from the host application 50 and provide user data in response to the request data. The OTT connection 52 may transfer both the request data and the user data. The client application 92 may interact with the user to generate the user data that it provides.

The processing circuitry 84 may be configured to control any of the methods and/or processes described herein and/or to cause such methods, and/or processes to be performed, e.g., by WD 22. The processor 86 corresponds to one or more processors 86 for performing WD 22 functions described herein. The WD 22 includes memory 88 that is configured to store data, programmatic software code and/or other information described herein. In some embodiments, the software 90 and/or the client application 92 may include instructions that, when executed by the processor 86 and/or processing circuitry 84, causes the processor 86 and/or processing circuitry 84 to perform the processes described herein with respect to WD 22.

The communication system 10 further includes a core node 15 provided in a communication system 10 and including hardware 94 enabling it to communicate with one or more elements in system 10. The hardware 94 may include a communication interface 96 for setting up and maintaining a wired or wireless connection with an interface of a different communication device of the communication system 10. The communication interface 96 may be configured to facilitate a connection 66 to the host computer 24. The connection 66 may be direct or indirect and/or may pass through one or more intermediate networks 30 outside the communication system 10.

In the embodiment shown, the hardware 94 of the core node 15 further includes processing circuitry 98. The processing circuitry 98 may include a processor 100 and a memory 102. In particular, in addition to or instead of a processor, such as a central processing unit, and memory, the processing circuitry 98 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 100 may be configured to access (e.g., write to and/or read from) the memory 102, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Thus, the core node 15 further has software 104 stored internally in, for example, memory 102, or stored in external memory (e.g., database, storage array, network storage device, etc.) accessible by the core node 15 via an external connection. The software 104 may be executable by the processing circuitry 98. The processing circuitry 98 may be configured to control any of the methods and/or processes described herein and/or to cause such methods, and/or processes to be performed, e.g., by core node 15. Processor 100 corresponds to one or more processors 100 for performing core node 15 functions described herein. The memory 102 is configured to store data, programmatic software code and/or other information described herein. In some embodiments, the software 104 may include instructions that, when executed by the processor 100 and/or processing circuitry 98, causes the processor 100 and/or processing circuitry 98 to perform the processes described herein with respect to core node 15. For example, processing circuitry 98 of the code node 15 may include congestion unit 32 configured to interworking between congestion information exposure mechanisms.

In some embodiments, the inner workings of the network node 16, WD 22, core node 15, and host computer 24 may be as shown in FIG. 3 and independently, the surrounding network topology may be that of FIG. 2.

In FIG. 3, the OTT connection 52 has been drawn abstractly to illustrate the communication between the host computer 24 and the wireless device 22 via the network node 16 and/or core node 15, without explicit reference to any intermediary devices and the precise routing of messages via these devices. Network infrastructure may determine the routing, which it may be configured to hide from the WD 22 or from the service provider operating the host computer 24, or both. While the OTT connection 52 is active, the network infrastructure may further take decisions by which it dynamically changes the routing (e.g., on the basis of load balancing consideration or reconfiguration of the network).

The wireless connection 64 between the WD 22 and the network node 16 is in accordance with the teachings of the embodiments described throughout this disclosure. One or more of the various embodiments improve the performance of OTT services provided to the WD 22 using the OTT connection 52, in which the wireless connection 64 may form the last segment. More precisely, the teachings of some of these embodiments may improve the data rate, latency, and/or power consumption and thereby provide benefits such as reduced user waiting time, relaxed restriction on file size, better responsiveness, extended battery lifetime, etc.

In some embodiments, a measurement procedure may be provided for the purpose of monitoring data rate, latency and other factors on which the one or more embodiments improve. There may further be an optional network functionality for reconfiguring the OTT connection 52 between the host computer 24 and WD 22, in response to variations in the measurement results. The measurement procedure and/or the network functionality for reconfiguring the OTT connection 52 may be implemented in the software 48 of the host computer 24 or in the software 90 of the WD 22, or both. In embodiments, sensors (not shown) may be deployed in or in association with communication devices through which the OTT connection 52 passes; the sensors may participate in the measurement procedure by supplying values of the monitored quantities exemplified above, or supplying values of other physical quantities from which software 48, 90 may compute or estimate the monitored quantities. The reconfiguring of the OTT connection 52 may include message format, retransmission settings, preferred routing etc.; the reconfiguring need not affect the network node 16, and it may be unknown or imperceptible to the network node 16. Some such procedures and functionalities may be known and practiced in the art. In certain embodiments, measurements may involve proprietary WD signaling facilitating the host computer's 24 measurements of throughput, propagation times, latency and the like. In some embodiments, the measurements may be implemented in that the software 48, 90 causes messages to be transmitted, in particular empty or ‘dummy’ messages, using the OTT connection 52 while it monitors propagation times, errors, etc.

Thus, in some embodiments, the host computer 24 includes processing circuitry 42 configured to provide user data and a communication interface 40 that is configured to forward the user data to a cellular network for transmission to the WD 22. In some embodiments, the cellular network also includes the network node 16 with a radio interface 62. In some embodiments, the network node 16 is configured to, and/or the network node's 16 processing circuitry 68 is configured to perform the functions and/or methods described herein for preparing/initiating/maintaining/supporting/ending a transmission to the WD 22, and/or preparing/terminating/maintaining/supporting/ending in receipt of a transmission from the WD 22.

In some embodiments, the host computer 24 includes processing circuitry 42 and a communication interface 40 that is configured to a communication interface 40 configured to receive user data originating from a transmission from a WD 22 to a network node 16. In some embodiments, the WD 22 is configured to, and/or comprises a radio interface 82 and/or processing circuitry 84 configured to perform the functions and/or methods described herein for preparing/initiating/maintaining/supporting/ending a transmission to the network node 16, and/or preparing/terminating/maintaining/supporting/ending in receipt of a transmission from the network node 16.

Although FIGS. 2 and 3 shows “unit” such as congestion unit 32 as being within a respective processor, it is contemplated that these units may be implemented such that a portion of the unit is stored in a corresponding memory within the processing circuitry. In other words, the units may be implemented in hardware or in a combination of hardware and software within the processing circuitry.

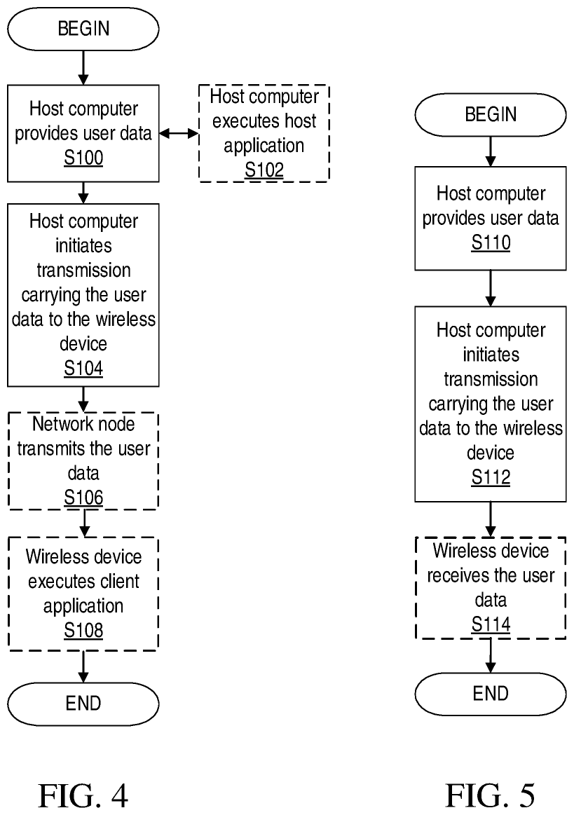

FIG. 4 is a flowchart illustrating an example method implemented in a communication system, such as, for example, the communication system of FIGS. 2 and 3, in accordance with one embodiment. The communication system may include a host computer 24, a network node 16 and a WD 22, which may be those described with reference to FIG. 3. In a first step of the method, the host computer 24 provides user data (Block S100). In an optional substep of the first step, the host computer 24 provides the user data by executing a host application, such as, for example, the host application 50 (Block S102). In a second step, the host computer 24 initiates a transmission carrying the user data to the WD 22 (Block S104). In an optional third step, the network node 16 transmits to the WD 22 the user data which was carried in the transmission that the host computer 24 initiated, in accordance with the teachings of the embodiments described throughout this disclosure (Block S106). In an optional fourth step, the WD 22 executes a client application, such as, for example, the client application 92, associated with the host application 50 executed by the host computer 24 (Block S108).

FIG. 5 is a flowchart illustrating an example method implemented in a communication system, such as, for example, the communication system of FIG. 2, in accordance with one embodiment. The communication system may include a host computer 24, a network node 16 and a WD 22, which may be those described with reference to FIGS. 2 and 3. In a first step of the method, the host computer 24 provides user data (Block S110). In an optional substep (not shown) the host computer 24 provides the user data by executing a host application, such as, for example, the host application 50. In a second step, the host computer 24 initiates a transmission carrying the user data to the WD 22 (Block S112). The transmission may pass via the network node 16, in accordance with the teachings of the embodiments described throughout this disclosure. In an optional third step, the WD 22 receives the user data carried in the transmission (Block S114).

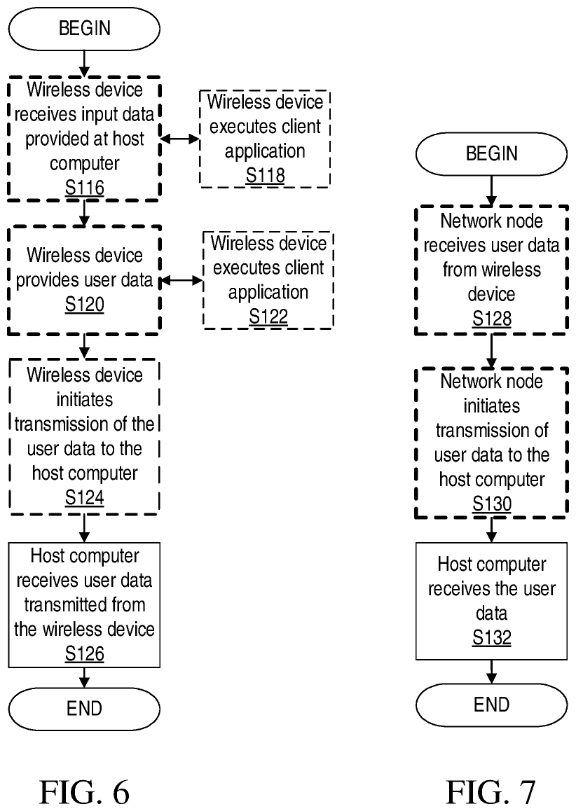

FIG. 6 is a flowchart illustrating an example method implemented in a communication system, such as, for example, the communication system of FIG. 2, in accordance with one embodiment. The communication system may include a host computer 24, a network node 16 and a WD 22, which may be those described with reference to FIGS. 2 and 3. In an optional first step of the method, the WD 22 receives input data provided by the host computer 24 (Block S116). In an optional substep of the first step, the WD 22 executes the client application 92, which provides the user data in reaction to the received input data provided by the host computer 24 (Block S118). Additionally or alternatively, in an optional second step, the WD 22 provides user data (Block S120). In an optional substep of the second step, the WD provides the user data by executing a client application, such as, for example, client application 92 (Block S122). In providing the user data, the executed client application 92 may further consider user input received from the user. Regardless of the specific manner in which the user data was provided, the WD 22 may initiate, in an optional third substep, transmission of the user data to the host computer 24 (Block S124). In a fourth step of the method, the host computer 24 receives the user data transmitted from the WD 22, in accordance with the teachings of the embodiments described throughout this disclosure (Block S126).

FIG. 7 is a flowchart illustrating an example method implemented in a communication system, such as, for example, the communication system of FIG. 2, in accordance with one embodiment. The communication system may include a host computer 24, a network node 16 and a WD 22, which may be those described with reference to FIGS. 2 and 3. In an optional first step of the method, in accordance with the teachings of the embodiments described throughout this disclosure, the network node 16 receives user data from the WD 22 (Block S128). In an optional second step, the network node 16 initiates transmission of the received user data to the host computer 24 (Block S130). In a third step, the host computer 24 receives the user data carried in the transmission initiated by the network node 16 (Block S132).

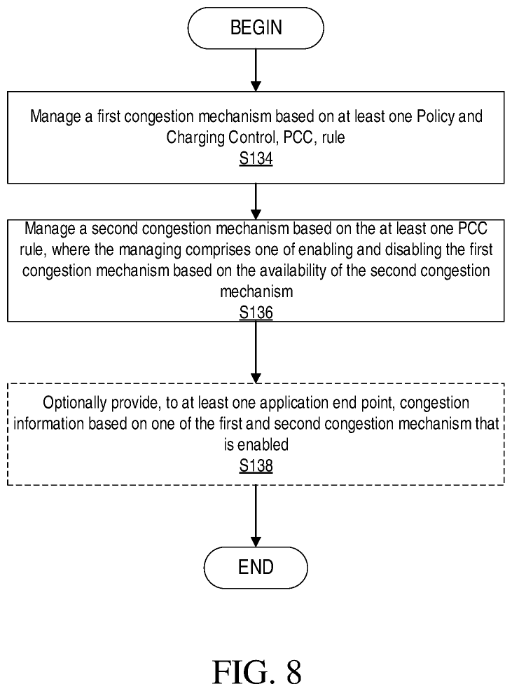

FIG. 8 is a flowchart of an example process in a core node 15 according to some embodiment of the present disclosure. One or more blocks described herein may be performed by one or more elements of network node 16 such as by one or more of processing circuitry 98 (including the congestion unit 32), processor 100, and/or communication interface 96. Core node 15 is configured to manage (Block S134) a first congestion mechanism based on at least one Policy and Charging Control, PCC, rule, as described herein. Core node 15 is configured to manage (Block S136) a second congestion mechanism based on the at least one PCC rule, where the managing comprises one of enabling and disabling the first congestion mechanism based on the availability of the second congestion mechanism, as described herein. Core node 15 is configured to optionally provide (Block S138), to at least one application end point, congestion information based on one of the first and second congestion mechanism that is enabled, as described herein.

According to one or more embodiments, the PCC rule mechanism may be used between PCF and SMF, and may be used to signal the need to perform L4S marking for ECN and also QoS monitoring.

According to one or more embodiments, the first congestion mechanism is Quality of Service, QoS, monitoring, and the second congestion mechanism is Low Latency, Low Loss and Scalable Throughput, L4S, marking for Explicit Congestion Notification, ECN; and

According to one or more embodiments, the core node 15 is configured to prioritize the second congestion mechanism over the first congestion mechanism.

According to one or more embodiments, the managing of the first congestion mechanism comprises activating the first congestion mechanism if the second congestion mechanism is unavailable.

According to one or more embodiments, the core node 15 is configured to bind the at least one PCC rule to a Quality of Service, QoS, flow, and one of the first and second congestion mechanism is applied to the QoS flow based on the managing of the first and second congestion mechanism.

According to one or more embodiments, the core node 15 is configured to receive, from a target handover network node, congestion information associated with the first congestion mechanism, determine the received congestion information is different information requested during protocol data unit, PDU, session establishment or modification, and enable the second congestion mechanism based on the determination.

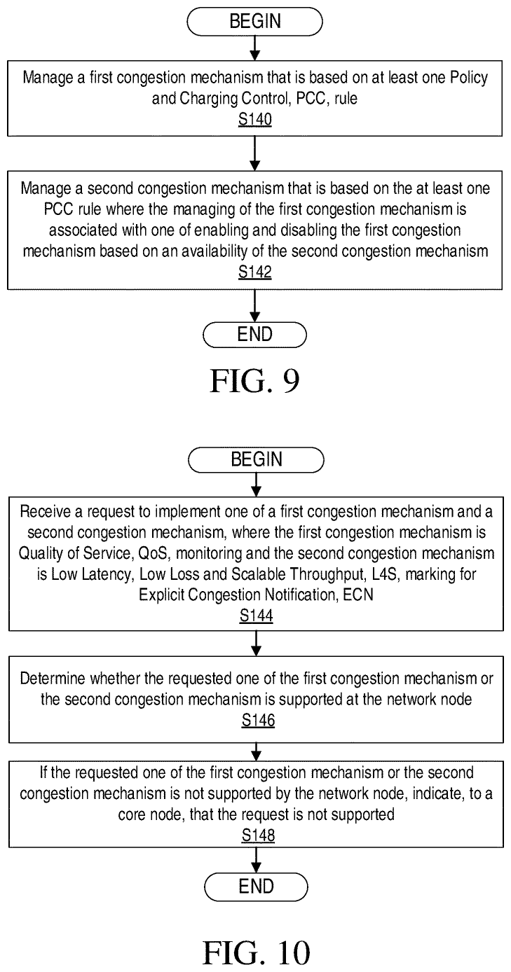

FIG. 9 is a flowchart of an example process in a core node 15 according to some embodiment of the present disclosure. One or more blocks described herein may be performed by one or more elements of network node 16 such as by one or more of processing circuitry 98 (including the congestion unit 32), processor 100, and/or communication interface 96. Core node 15 is configured to manage (Block S140) a first congestion mechanism that is based on at least one Policy and Charging Control, PCC, rule, as described herein. Core node 15 is configured to manage (Block S142) the second congestion mechanism that is based on the at least one PCC rule, where the managing of the first congestion mechanism is associated with one of enabling and disabling the first congestion mechanism based on an availability of the second congestion mechanism, as described herein.

According to one or more embodiments, the first congestion mechanism is Quality of Service, QoS, monitoring, and the second congestion mechanism is Low Latency, Low Loss and Scalable Throughput, L4S, marking for Explicit Congestion Notification, ECN. According to one or more embodiments, the managing of the first congestion mechanism is associated with enabling the first congestion mechanism if the second congestion mechanism is unavailable.

According to one or more embodiments, the first congestion mechanism is Quality of Service, QoS, monitoring and the second congestion mechanism is Low Latency, Low Loss and Scalable Throughput, L4S, marking for Explicit Congestion Notification, ECN, and the managing of the first congestion mechanism is associated with enabling the first congestion mechanism if the second congestion mechanism is unavailable.

According to one or more embodiments, the core node 15 is configured to prioritize the second congestion mechanism over the first congestion mechanism.

According to one or more embodiments, the core node 15 is configured to bind the at least one PCC rule to a Quality of Service, QoS, flow to take into account a requirement to apply QoS monitoring, and one of the first and second congestion mechanism is applied to the QoS flow based on the managing of the first and second congestion mechanism.

According to one or more embodiments, the core node 15 is configured to: receive, from a target handover network node 16, a notification indicating that at least one of the first congestion mechanism and the second congestion mechanism indicated during protocol data unit, PDU, session establishment is supported by the target network node 16, and enable one of the first congestion mechanism and the second congestion mechanism based on the notification.

According to one or more embodiments, the core node 15 is further configured to receive a notification that one of the first congestion mechanism and the second congestion mechanism is not supported at a target network node 16 associated with a handover.

According to one or more embodiments, the core node is further configured to provide, to at least one application end point, congestion information based on one of the first and second congestion mechanism that is enabled.

According to one or more embodiments, the core node 15 is an application function, AF.

FIG. 10 is a flowchart of an example process in a network node 16 according to some embodiment of the present disclosure. In one or more embodiments, the network node 16 is a target network node 16 involved in a handover. One or more blocks described herein may be performed by one or more elements of network node 16 such as by one or more of processing circuitry 68, processor 70, and/or communication interface 60. Network node 16 is configured to receive (Block S144) a request to implement one of a first congestion mechanism and a second congestion mechanism, where the first congestion mechanism is Quality of Service, QoS, monitoring and the second congestion mechanism is Low Latency, Low Loss and Scalable Throughput, L4S, marking for Explicit Congestion Notification, ECN, as described herein. Network node 16 is configured to determine (Block S146) whether the requested one of the first congestion mechanism or the second congestion mechanism is supported at the network node 16, as described herein. If the requested one of the first congestion mechanism or the second congestion mechanism is not supported by the network node 16, network node 16 is configured to indicate (Block S148), to a core node 15, that the request is not supported, as described herein.

According to one or more embodiments, the network node 16 is further configured to: if the requested one of the first congestion mechanism or the second congestion mechanism is supported by the network node 16, indicate, to the core node 15, that the request is supported, and implement the requested one of the first congestion mechanism or the second congestion mechanism.

According to one or more embodiments, the indication comprises one of: a list of QoS flows with ECN markings for L4S that are one of enabled and disabled, and a list of QoS flows with a QoS monitoring configuration that are one of enabled and disabled.

According to one or more embodiments, the indication is an implicit indication that does not include information associated with whether one of ECN markings for L4S or QoS monitoring is enabled or disabled.

According to one or more embodiments, the core node 15 is an application function, AF.

According to one or more embodiments, the network node 16 is a target network node 16, and the request is received from one of a source network node 16 and core node 15.

Having described the general process flow of arrangements of the disclosure and having provided examples of hardware and software arrangements for implementing the processes and functions of the disclosure, the sections below provide details and examples of arrangements for interworking between congestion information exposure mechanisms.

Some embodiments provide interworking between congestion information exposure mechanisms. One or more core node 15 (e.g., SMF) functions described below may be performed by one or more of processing circuitry 98, processor 100, congestion unit 32, etc.

As part of PDU Session establishment or PDU Session modification, SMF may receive a PCC Rule which (implicitly or explicitly) enables ECN marking (e.g., ECN markings described in, for example, 3GPP SA2 WG TDOC S2-2306241). If that PCC Rule also includes a QoS Monitoring policy that requests Congestion information monitoring:

Step 1. SMF considers the QoS Monitoring Policy in the decision for the binding of the PCC Rule to a QoS Flow, but the SMF does not yet instruct NG-RAN and UPF PSA for QoS monitoring.

Step 2. SMF decides whether NG-RAN or UPF PSA should perform the ECN marking for L4S. SMF takes into account information of UPF PSA capabilities.

Step 3. SMF sends instructions to NG-RAN and if needed to UPF PSA according to the decision or determine in Step 2. As described in 3GPP SA2 WG TDOC S2-2306190, instructions to NG-RAN are one of the following:
a. An ECN marking for L4S indicator to AN for each corresponding QoS flow in the case of ECN marking for L4S in RAN;
b. A QoS monitoring configuration for congestion information as described in 3GPP specification such as in, for example, clause 5.45.3 of 3GPP TR 23.501 v18.1.0 for each corresponding QoS flow in the case of ECN marking for L4S by PSA UPF.

Step 4. NG-RAN provides information for whether the request could or could not be enabled, depending on what has been requested:
a. List of QoS Flows with ECN marking for L4S could/could not be enabled.
b. List of QoS Flows with QoS monitoring configuration for congestion information could/could not be enabled.
(When no information is provided that indicates that the function is not supported).

Step 5. If the iNG-RAN response does not include the information described above, or what NG-RAN has enabled differs from the SMF request, SMF decides whether a different mechanism needs to be selected:
a. If ECN marking for L4S may be supported by a different entity (NG-RAN or UPF PSA), SMF updates the request towards NG-RAN and if needed UPF PSA accordingly.
b. If neither NG-RAN nor UPF PSA can perform ECN marking for L4S, but Congestion information monitoring may be supported, SMF activates Congestion information monitoring towards NG-RAN and UPF PSA accordingly.

Step 6. If in the attempt to activate ECN marking for L4S (steps 3-5), SMF determines ECN markings for L4S are not available (neither in NG-RAN nor in UPF PSA), and if Congestion information monitoring may be supported (at this stage SMF may know that mechanism is not supported either), SMF instructs NG-RAN and UPF PSA accordingly (e.g., to enable Congestion information monitoring).

Due to wireless device mobility, the NG-RAN that is serving the wireless device 22 (e.g., user) may change, and so may the available support for ECN marking for L4S.

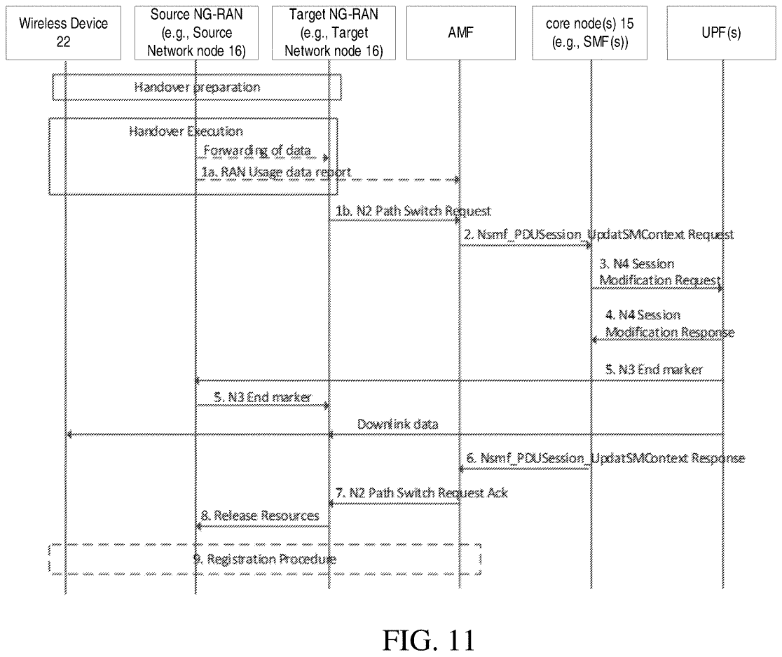

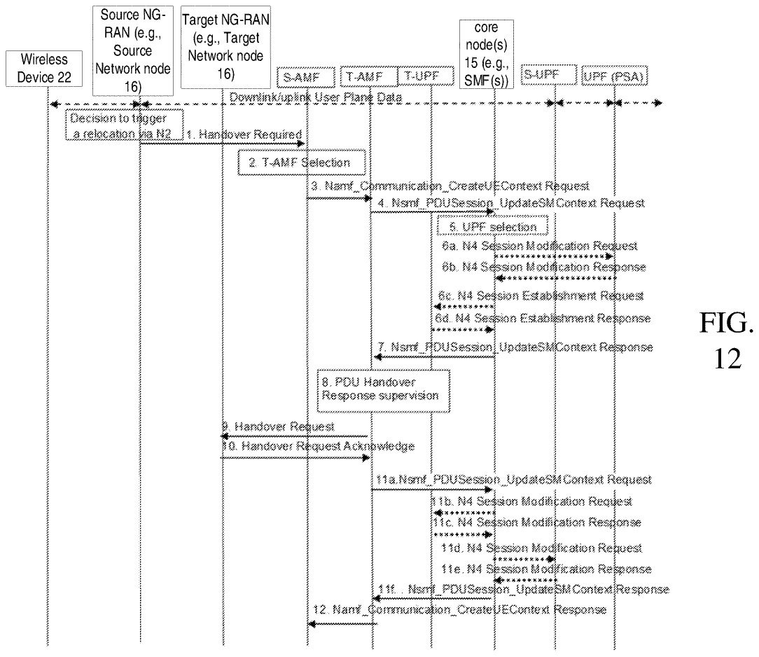

When Xn based inter NG-RAN handover without User Plane function re-allocation (e.g., 3GPP TS 23.502 v.18.1.0, clause 4.9.1.2.) is followed (e.g., as illustrated in FIG. 11):
During Handover Execution Target-NG-RAN may receive from source NG-RAN instructions related to ECN marking for L4S and/or congestion information monitoring, that is:
   An ECN marking for L4S indicator to AN for each corresponding QoS flow in the case of ECN marking for L4S in RAN,
   A QoS monitoring configuration for congestion information as described in 3GPP specification such as in, for example, clause 5.45.3 of 3GPP TR 23.501 v18.1.0 for each corresponding QoS flow in the case of ECN marking for L4S by PSA UPF.
In steps 1 and 2, target NG-RAN provides information according to the request, that indicates at least one of:
   whether List of QoS Flows with ECN marking for L4S could/could not be enabled.
   whether List of QoS Flows with QoS monitoring configuration for congestion information could/could not be enabled.
If target NG-RAN does not provide this information, or what it provides differs from what the SMF requested (to source NG-RAN at PDU Session establishment or modification), SMF decides whether a different mechanism is to be selected:
   If ECN marking for L4S may be supported by a different entity (e.g., NG-RAN or UPF PSA), SMF updates the request towards NG-RAN and if needed towards UPF PSA accordingly.
   If neither NG-RAN nor UPF PSA can perform ECN marking for L4S, but Congestion information monitoring may be supported, SMF activates Congestion information monitoring towards NG-RAN and UPF PSA accordingly.
If in the attempt to activate ECN marking for L4S above, SMF determines ECN marking for L4S is not available in the network (neither in NG-RAN nor in UPF PSA), and if Congestion information monitoring may be supported (at this stage SMF may know that mechanism is not supported either), SMF instructs NG-RAN and UPF PSA accordingly (e.g., to enable Congestion information monitoring).

In one or more alternative embodiments, Inter NG-RAN node N2 based handover procedure (e.g., handover procedure described in 3GPP specification such as in, for example, 3GPP TS 23.502 v.18.1.0, clause 4.9.1.2.3) may be followed (as illustrated in FIG. 12)
In Step 7, SMF provides instructions related to ECN marking for L4S, that is:
   An ECN marking for L4S indicator to AN for each corresponding QoS flow in the case of ECN marking for L4S in RAN, and/or
   A QoS monitoring configuration for congestion information as described in 3GPP specification such as in, for example, clause 5.45.3 of 3GPP TR 23.501 v18.1.0, for each corresponding QoS flow in the case of ECN marking for L4S by PSA UPF.
In steps 10/11a, target NG-RAN provides information according to the SMF instructions, that is the information indicates:
   Whether a List of QoS Flows with ECN marking for L4S could/could not be enabled, and/or
   Whether a List of QoS Flows with QoS monitoring configuration for congestion information could/could not be enabled.
If target NG-RAN does not provide this information, or what it provides differs from what SMF has requested, SMF decides whether a different mechanism is to be selected:
   If ECN marking for L4S may be supported by a different entity (NG-RAN or UPF PSA), SMF updates the request towards NG-RAN and if needed UPF PSA accordingly.
   If neither NG-RAN nor UPF PSA can perform ECN marking for L4S, but Congestion information monitoring may be supported, SMF activates the Congestion information monitoring towards NG-RAN and UPF PSA accordingly.
If in the attempt to activate ECN marking for L4S above, SMF determines the ECN marking feature is not available in the network (neither in NG-RAN nor in UPF PSA), and if Congestion information monitoring may be supported (at this stage SMF may know that mechanism is not supported either), SMF instructs NG-RAN and UPF PSA accordingly (e.g., instructs to activate the Congestion information monitoring).

Hence, one or more embodiments described herein describe that, when both ECN marking for L4S and Congestion information monitoring are enabled by a PCC Rule, one or more of:
SMF gives precedence to ECN marking for L4S whenever available (i.e., when supported by the network)
NG-RAN provides information of what has been possible to enable or not enable for the QoS Flow from SMF request.
SMF considers NG-RAN provided information (e.g., QoS monitoring based information) on what has been possible to enable in the selection of the mechanism to provide congestion information to the application (e.g., provide congestion information to NG-RAN (e.g., network node 16) or UPF PSA ECN marking for L4F or congestion information monitoring).
If ECN marking for L4S is not available, SMF activates Congestion information monitoring (if that is supported by the network), and dynamically activates/deactivates it as needed when the availability of ECN marking for L4S changes.

One or more embodiments described herein provide one or more of the following advantages:
It allows an AF that supports both mechanisms to receive congestion information according to what is available in the network at a given time.
The system dynamically adapts to provide congestion information if possible, all the time without further involvement of AF and/or PCF:
   Simplifying interaction with applications
   Reducing signaling
   With no impact on PCC biding to QoS Flows.

Below are non-limiting examples of how certain aspects of the proposed solutions could be implemented within the framework of a specific communication standard. In particular, the description below provide non-limiting examples of how the proposed solutions could be implemented within the framework of a 3GPP TSG RAN standard. The changes described below are merely intended to illustrate how certain aspects of the proposed solutions could be implemented in a particular standard. However, the proposed solutions could also be implemented in other suitable manners, both in the 3GPP Specification and in other specifications or standards.

Some of the changes in accordance with the teachings described herein are indicated in in strikethrough to show material being remove from the 3GPP standard, and/or underlined to show material being added to the 3GPP standard.

### First Change Request (CR)

A QoS flow may be enabled with ECN marking for L4S requirement, e.g., statically when a PDU session is established based on configuration in SMF or PCF. Therefore, SMF may provide a QoS Flow level ECN marking for L4S indication to NG-RAN or PSA UPF during the PDU session establishment/modification. Besides, in the case of ECN marking for L4S by UPF, SMF also indicates NG-RAN to report the congestion information during the PDU session establishment/modification.

One or more embodiments described below update the PDU session establishment/modification to support ECN marking for L4S.

### Start of Changes

### 4.3.2.2 UE Requested PDU Session Establishment

### 4.3.2.2.1 Non-Roaming and Roaming with Local Breakout

Clause 4.3.2.2.1 specifies PDU Session establishment in the non-roaming and roaming with local breakout cases. The procedure is used to:
Establish a new PDU Session;
Handover a PDN Connection in EPS to PDU Session in 5GS without N26 interface;
Switching an existing PDU Session between non-3GPP access and 3GPP access. The specific system behaviour in this case is further defined in clauses 4.9.2 and 4.9.3; or
Request a PDU Session for Emergency services.
   In the case of roaming, the AMF determines if a PDU Session is to be established in LBO or Home Routing. In the case of LBO, the procedure is as in the case of non-roaming with the difference that the AMF, the SMF, the UPF and the PCF are located in the visited network. PDU Sessions for Emergency services are never established in Home Routed mode. If Control Plane CIoT 5GS Optimisation is enabled for the PDU session with LBO, the NEF is not used as the anchor of this PDU Session.

NOTE 1: UE provides both the S-NSSAIs of the Home PLMN and Visited PLMN to the network as described in clause 5.15.5.3 of TS 23.501 [2].

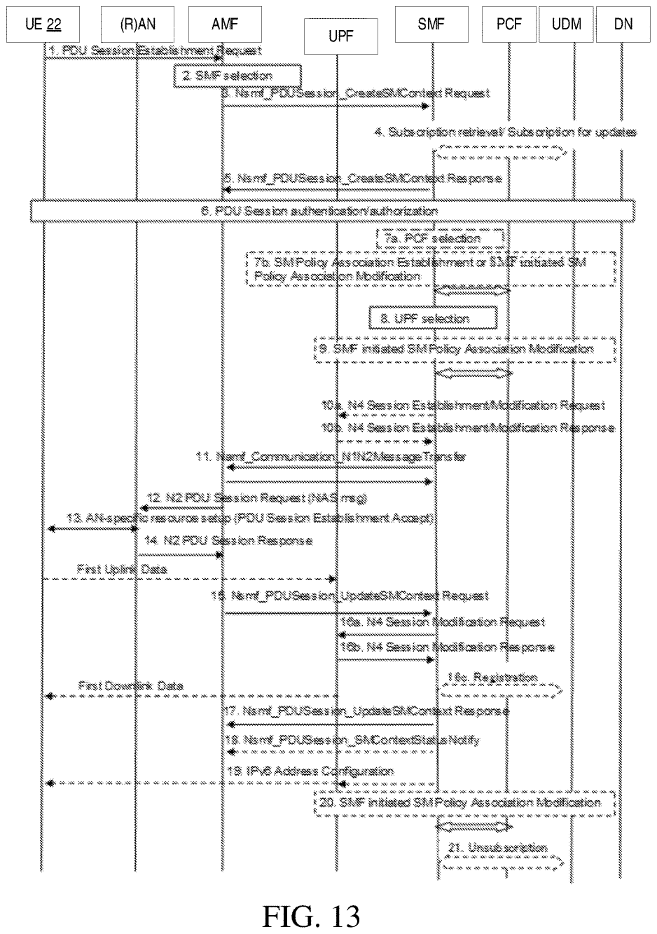

FIG. 13 (also referred to as FIG. 4.3.2.2.1-1) is a diagram of UE-requested PDU Session Establishment for non-roaming and roaming with local breakout.

The procedure assumes that the UE has already registered on the AMF thus unless the UE is Emergency Registered the AMF has already retrieved the user subscription data from the UDM.
1. From UE to AMF: NAS Message (S-NSSAI(s), UE Requested DNN, PDU Session ID, Request type, Old PDU Session ID, N1 SM container (PDU Session Establishment Request, [Port Management Information Container])).
   In order to establish a new PDU Session, the UE generates a new PDU Session ID. The UE initiates the UE Requested PDU Session Establishment procedure by the transmission of a NAS message containing a PDU Session Establishment Request within the N1 SM container. The PDU Session Establishment Request includes a PDU session ID, Requested PDU Session Type, a Requested SSC mode, 5GSM Capability, PCO, SM PDU DN Request Container, [Number Of Packet Filters], [Header Compression Configuration], UE Integrity Protection Maximum Data Rate, [Always-on PDU Session Requested], [RSN], [Connection Capabilities] and [PDU Session Pair ID].
   The Request Type indicates “Initial request” if the PDU Session Establishment is a request to establish a new PDU Session and indicates “Existing PDU Session” if the request refers to an existing PDU Session switching between 3GPP access and non-3GPP access or to a PDU Session handover from an existing PDN connection in EPC. If the request refers to an existing PDN connection in EPC, the S-NSSAI is set as described in clause 5.15.7.2 of TS 23.501 [2]
   When Emergency service is required and an Emergency PDU Session is not already established, a UE shall initiate the UE Requested PDU Session Establishment procedure with a Request Type indicating “Emergency Request”. The Request Type indicates “Emergency Request” if the PDU Session Establishment is a request to establish a PDU Session for Emergency services. The Request Type indicates “Existing Emergency PDU Session” if the request refers to an existing PDU Session for Emergency services switching between 3GPP access and non-3GPP access or to a PDU Session handover from an existing PDN connection for Emergency services in EPC.
   The 5GSM Core Network Capability is provided by the UE and handled by SMF as defined in clause 5.4.4b of TS 23.501 [2].
   The Number Of Packet Filters indicates the number of supported packet filters for signalled QoS rules for the PDU Session that is being established. The number of packet filters indicated by the UE is valid for the lifetime of the PDU Session. For presence condition, see TS 24.501 [25].
   The UE Integrity Protection Maximum Data Rate indicates the maximum data rate up to which the UE can support UP integrity protection. The UE shall provide the UE Integrity Protection Data Rate capability independently of the Access Type over which the UE sends the PDU Session Establishment Request.
   If the use of header compression for Control Plane CioT 5GS optimisation was negotiated successfully between the UE and the network in the previous registration procedure, the UE shall include the Header Compression Configuration, unless “Unstructured” PDU Session Type is indicated. The Header Compression Configuration includes the information necessary for the header compression channel setup. Optionally, the Header Compression Configuration may include additional header compression context parameters.
   The NAS message sent by the UE is encapsulated by the AN in a N₂ message towards the AMF that should include User location information and Access Type Information.
   The PDU Session Establishment Request message may contain SM PDU DN Request Container containing information for the PDU Session authorization by the external DN.
   The UE includes the S-NSSAI from the Allowed NSSAI of the current access type. If the Mapping of Allowed NSSAI was provided to the UE, the UE shall provide both the S-NSSAI of the VPLMN from the Allowed NSSAI and the corresponding S-NSSAI of the HPLMN from the Mapping Of Allowed NSSAI.
   If the procedure is triggered for SSC mode 3 operation, the UE shall also include the Old PDU Session ID which indicates the PDU Session ID of the on-going PDU Session to be released, in NAS message. The Old PDU Session ID is included only in this case.
   The AMF receives from the AN the NAS SM message (built in step 1) together with User Location Information (e.g. Cell Id in the case of the NG-RAN).
   The UE shall not trigger a PDU Session establishment for a PDU Session corresponding to a LADN when the UE is outside the area of availability of the LADN.
   If the UE is establishing a PDU session for IMS and the UE is configured to discover the P-CSCF address during connectivity establishment, the UE shall include an indicator that it requests a P CSCF IP address(es) within the SM container.
   The PS Data Off status is included in the PCO in the PDU Session Establishment Request message.
   The UE capability to support Reliable Data Service is included in the PCO in the PDU Session Establishment Request message.
   If the UE has indicated that it supports transfer of Port Management Information Containers as per UE 5GSM Core Network Capability and if the PDU session type is Ethernet, then the UE shall include the MAC address of the DS-TT Ethernet port used for this Ethernet PDU session. If the UE is aware of the UE-DS-TT Residence Time, then the UE shall additionally include the UE-DS-TT Residence Time. If the UE requests to establish always-on PDU session, the UE includes an Always-on PDU Session Requested indication in the PDU Session Establishment Request message.
   As described in TS 23.548 [74], a UE that hosts EEC(s) may indicate in the PCO that it supports the ability to receive ECS address(es) via NAS and to transfer the ECS Address(es) to the EEC(s).
   A UE that hosts the EDC functionality shall indicate in the PCO its capability to support the EDC functionality (see clause 5.2.1 of TS 23.548 [74]).
   The UE may also include PDU Session Pair ID and/or RSN in PDU Session Establishment Request message as described in clause 5.33.2.1 of TS 23.501 [2]. A UE that supports EAS re-discovery as described in clause 6.2.3.3 of TS 23.548 [74], may indicate so in the PCO.
   Port Management Information Container may be received from DS-TT and includes port management capabilities, i.e. information indicating which standardized and deployment-specific port management information is supported by DS-TT as defined in clause 5.28.3 of TS 23.501 [2].
   If UE supports to report URSP rule enforcement to network, the UE may provide Connection Capabilities as described in clause 6.6.2.4 of TS 23.503 [20].
2. For NR satellite access, the AMF may decide to verify the UE location as described in clause 5.4.11.4 of TS 23.501 [2].
   The AMF determines that the message corresponds to a request for a new PDU Session based on that Request Type indicates “initial request” and that the PDU Session ID is not used for any existing PDU Session of the UE. If the NAS message does not contain an S-NSSAI, the AMF determines an S-NSSAI of the Serving PLMN for the requested PDU Session from the current Allowed NSSAI for the UE. If there is only one S-NSSAI in the Allowed NSSAI, this S-NSSAI shall be used. If there is more than one S-NSSAI in the Allowed NSSAI, the S-NSSAI selected is either according to the UE subscription, if the subscription contains only one default S-NSSAI and the corresponding mapped HPLMN S-NSSAI of the Serving PLMN is included in the Allowed NSSAI, or based on operator policy (e.g. also ensures any UE Requested DNN is allowed for the selected S-NSSAI)). When the NAS Message contains an S-NSSAI of the Serving PLMN but it does not contain a DNN, the AMF determines the DNN for the requested PDU Session by selecting the default DNN for this S-NSSAI if the default DNN is present in the UE's Subscription Information (or for the corresponding S-NSSAI of the HPLMN, in the case of LBO); otherwise the serving AMF selects a locally configured DNN for this S-NSSAI of the Serving PLMN. If the AMF cannot select an SMF (e.g. the UE requested DNN is not supported by the network, or the UE requested DNN is not in the Subscribed DNN List for the S-NSSAI (or its mapped value for the HPLMN in the case of LBO) and wildcard DNN is not included in the Subscribed DNN list), the AMF shall, based on operator policies received from PCF, either reject the NAS Message containing PDU Session Establishment Request from the UE with an appropriate cause or request PCF to replace the UE requested DNN by a selected DNN. If the DNN requested by the UE is present in the UE subscription information but indicated for replacement in the operator policies received from PCF, the AMF shall request the PCF to perform a DNN replacement to a selected DNN. AMF requests DNN replacement as specified in clause 4.16.2.1.1. If the DNN requested by the UE is present in the UE subscription information but not supported by the network and not indicated for replacement in the operator policies received from PCF, the AMF shall reject the NAS Message containing PDU Session Establishment Request from the UE with an appropriate cause value.
   The AMF selects an SMF as described in clause 6.3.2 of TS 23.501 [2] and clause 4.3.2.2.3. If the Request Type indicates “Initial request” or the request is due to handover from EPS or from non-3GPP access serving by a different AMF, the AMF stores an association of the S-NSSAI(s), the DNN, the PDU Session ID, the SMF ID as well as the Access Type of the PDU Session.
   During registration procedures, the AMF determines the use of the Control plane CIoT 5GS Optimisation or User plane CIoT 5GS Optimisation based on UEs indications in the 5G Preferred Network Behaviour, the serving operator policies and the network support of CIoT 5GS optimisations. The AMF selects an SMF that supports Control plane CIoT 5GS optimisation or User plane CIoT 5GS Optimisation as described in clause 6.3.2 of TS 23.501 [2].
   If the Request Type is “initial request” and if the Old PDU Session ID indicating the existing PDU Session is also contained in the message, the AMF selects an SMF as described in clause 4.3.5.2 and stores an association of the new PDU Session ID, the S-NSSAI(s), the selected SMF ID as well as Access Type of the PDU Session.
   If the Request Type indicates “Existing PDU Session”, the AMF selects the SMF based on SMF-ID received from UDM. The case where the Request Type indicates “Existing PDU Session” and either the AMF does not recognize the PDU Session ID or the subscription context that the AMF received from UDM during the Registration or Subscription Profile Update Notification procedure does not contain an SMF ID corresponding to the PDU Session ID constitutes an error case. The AMF updates the Access Type stored for the PDU Session.
   If the Request Type indicates “Existing PDU Session” referring to an existing PDU Session moved between 3GPP access and non-3GPP access, then if the Serving PLMN S-NSSAI of the PDU Session is present in the Allowed NSSAI of the target access type, the PDU Session Establishment procedure can be performed in the following cases:
      the SMF ID corresponding to the PDU Session ID and the AMF belong to the same PLMN;
      the SMF ID corresponding to the PDU Session ID belongs to the HPLMN; Otherwise the AMF shall reject the PDU Session Establishment Request with an appropriate reject cause.
   NOTE 2: The SMF ID includes the PLMN ID that the SMF belongs to.
   The AMF shall reject a request coming from an Emergency Registered UE and the Request Type indicates neither “Emergency Request” nor “Existing Emergency PDU Session”. When the Request Type indicates “Emergency Request”, the AMF is not expecting any S-NSSAI and DNN value provided by the UE and uses locally configured values instead. The AMF stores the Access Type of the PDU Session. If the Request Type indicates “Emergency Request” or “Existing Emergency PDU Session”, the AMF selects the SMF as described in clause 5.16.4 of TS 23.501 [2].
3. From AMF to SMF: Either Nsmf_PDUSession_CreateSMContext Request (SUPI, selected DNN, UE requested DNN, S-NSSAI(s), PDU Session ID, AMF ID, Request Type, [PCF ID, Same PCF Selection Indication], Priority Access, [Small Data Rate Control Status], N1 SM container (PDU Session Establishment Request), User location information, Access Type, RAT Type, PEI, GPSI, UE presence in LADN service area, Subscription For PDU Session Status Notification, DNN Selection Mode, Trace Requirements, Control plane CIoT 5GS Optimisation indication, Control Plane Only indicator, Satellite backhaul category, GEO Satellite ID, [PVS FQDN(s) and/or PVS IP address(es), Onboarding Indication], Disaster Roaming service indication) or Nsmf_PDUSession_UpdateSMContext Request (SUPI, DNN, S-NSSAI(s), SM Context ID, AMF ID, Request Type, N1 SM container (PDU Session Establishment Request), User location information, Access Type, RAT type, PEI, Serving Network (PLMN ID, or PLMN ID and NID, see clause 5.18 of TS 23.501 [2]), Satellite backhaul category, GEO Satellite ID), [PCF binding information, notification of SM Policy Association establishment Indication].
   If the AMF does not have an association with an SMF for the PDU Session ID provided by the UE (e.g. when Request Type indicates “initial request”), the AMF invokes the Nsmf_PDUSession_CreateSMContext Request, but if the AMF already has an association with an SMF for the PDU Session ID provided by the UE (e.g. when Request Type indicates “existing PDU Session”), the AMF invokes the Nsmf_PDUSession_UpdateSMContext Request.
   The AMF sends the S-NSSAI of the Serving PLMN from the Allowed NSSAI to the SMF. For roaming scenario in local breakout (LBO), the AMF also sends the corresponding S-NSSAI of the HPLMN from the Mapping Of Allowed NSSAI to the SMF.
   The AMF ID is the UE's GUAMI which uniquely identifies the AMF serving the UE. The AMF forwards the PDU Session ID together with the N1 SM container containing the PDU Session Establishment Request received from the UE. The GPSI shall be included if available at AMF.
   The AMF determines Access Type and RAT Type, see clause 4.2.2.2.1.
   The AMF provides the PEI instead of the SUPI when the UE in limited service state has registered for Emergency services (i.e. Emergency Registered) without providing a SUPI. The PEI is defined in clause 5.9.3 of TS 23.501 [2]. If the UE in limited service state has registered for Emergency services (i.e. Emergency Registered) with a SUPI but has not been authenticated the AMF indicates that the SUPI has not been authenticated. The SMF determines that the UE has not been authenticated when it does not receive a SUPI for the UE or when the AMF indicates that the SUPI has not been authenticated.
   If the AMF determines that the selected DNN corresponds to an LADN then the AMF provides the “UE presence in LADN service area” that indicates if the UE is IN or OUT of the LADN service area.
   If the Old PDU Session ID is included in step 1 and if the SMF is not to be reallocated, the AMF also includes Old PDU Session ID in the Nsmf_PDUSession_CreateSMContext Request.
   DNN Selection Mode is determined by the AMF. It indicates whether an explicitly subscribed DNN has been provided by the UE in its PDU Session Establishment Request.
   The SMF may use DNN Selection Mode when deciding whether to accept or reject the UE request.
   When the Establishment cause received as part of AN parameters during the Registration procedure or Service Request procedure is associated with priority services (e.g. MPS, MCX), or when the AMF determines the UE has priority subscription (e.g. MPS, MCX) in the UDM, the AMF includes a Message Priority header to indicate priority information. The SMF uses the Message Priority header to determine if the UE request is subject to exemption from NAS level congestion control. Other NFs relay the priority information by including the Message Priority header in service-based interfaces, as specified in TS 29.500 [17].
   In the local breakout case, if the SMF (in the VPLMN) is not able to process some part of the N1 SM information that Home Routed Roaming is required and the SMF responds to the AMF that it is not the right SMF to handle the N1 SM message by invoking Nsmf_PDUSession_CreateSMContext Response service operation. The SMF includes a proper N11 cause code triggering the AMF to proceed with home routed case. The procedure starts again at step 2 of clause 4.3.2.2.2.
   In the non-roaming case, for PDU Session with Request Type “initial request”, the AMF checks if the PCF Selection Assistance info from the UDM indicates that the same PCF is required for the requested DNN and S-NSSAI and if required, the AMF includes in Nsmf_PDUSession_CreateSMContext Request both the Same PCF Selection Indication and the PCF ID selected by the AMF, this PCF ID identifies the H-PCF,
   If PCF Selection Assistance info is not received from the UDM, the AMF may include a PCF ID in the Nsmf_PDUSession_CreateSMContext Request based on operator policies. This PCF ID identifies the H-PCF in the non-roaming case and the V-PCF in the local breakout roaming case.
   The AMF includes Trace Requirements if Trace Requirements have been received in subscription data.
   If the AMF decides to use the Control plane CIoT 5GS Optimisation or User plane CIoT 5GS Optimisation as specified in step 2 or to only use Control plane CIoT 5GS Optimisation for the PDU session as described in clause 5.31.4 of TS 23.501 [2], the AMF sends the Control plane CIoT 5GS Optimisation indication or Control Plane Only indicator to the SMF.
   If the AMF determines that the RAT type is NB-IoT and the number of PDU Sessions with user plane resources activated for the UE has reached the maximum number of supported user plane resources (0, 1 or 2) based on whether the UE supports UP data transfer and the UE's 5GMM Core Network Capability as described in Clause 5.31.19 of TS 23.501 [2], the AMF may either reject the PDU Session Establishment Request or continue with the PDU Session establishment and include the Control plane CIoT 5GS Optimisation indication or Control Plane Only indicator to the SMF.
   The AMF includes the latest Small Data Rate Control Status if it has stored it for the PDU Session.
   If the RAT type was included in the message, then the SMF stores the RAT type in SM Context.
   If the UE supports CE mode B and use of CE mode B is not restricted according to the Enhanced Coverage Restriction information in the UE context in the AMF, then the AMF shall include the extended NAS-SM timer indication. Based on the extended NAS-SM timer indication, the SMF shall use the extended NAS-SM timer setting for the UE as specified in TS 24.501 [25].
   If the identity of an NWDAF is available to the AMF, the AMF informs the SMF of the NWDAF ID(s) used for UE related Analytics and corresponding Analytics ID(s).
   If the AMF, based on configuration, is aware that the UE is accessing over a gNB using satellite backhaul as defined in clause 5.43.4 of TS 23.501 [2], the AMF determines the type of satellite backhaul category and includes Satellite backhaul category to the SMF.
   If the AMF, based on configuration, is aware that the UE is accessing over a gNB using GEO satellite backhaul, the AMF may, based on configuration, include the GEO satellite ID as described in clause 5.43.2 of TS 23.501 [2].
   The AMF may provide the Disaster Roaming service indication as specified in TS 23.501 [2].
4. If Session Management Subscription data for corresponding SUPI, DNN and S-NSSAI of the HPLMN is not available, then SMF retrieves the Session Management Subscription data using Nudm_SDM_Get (SUPI, Session Management Subscription data, selected DNN, S-NSSAI of the HPLMN, Serving PLMN ID, [NID]) and subscribes to be notified when this subscription data is modified using Nudm_SDM_Subscribe (SUPI, Session Management Subscription data, selected DNN, S-NSSAI of the HPLMN, Serving PLMN ID, [NID]). UDM may get this information from UDR by Nudr_DM_Query (SUPI, Subscription Data, Session Management Subscription data, selected DNN, S-NSSAI of the HPLMN, Serving PLMN ID, [NID]) and may subscribe to notifications from UDR for the same data by Nudr_DM_subscribe.
   The SMF may use DNN Selection Mode when deciding whether to retrieve the Session Management Subscription data e.g. if the (selected DNN, S-NSSAI of the HPLMN) is not explicitly subscribed, the SMF may use local configuration instead of Session Management Subscription data.
   If the Request Type in step 3 indicates “Existing PDU Session” or “Existing Emergency PDU Session” the SMF determines that the request is due to switching between 3GPP access and non-3GPP access or due to handover from EPS. The SMF identifies the existing PDU Session based on the PDU Session ID. In such a case, the SMF does not create a new SM context but instead updates the existing SM context and provides the representation of the updated SM context to the AMF in the response.
   If the Request Type is “Initial request” and if the Old PDU Session ID is included in Nsmf_PDUSession_CreateSMContext Request, the SMF identifies the existing PDU Session to be released based on the Old PDU Session ID.
   Subscription data includes the Allowed PDU Session Type(s), Allowed SSC mode(s), default 5QI and ARP, subscribed Session-AMBR, SMF-Associated external parameters.
   IP Index or Static IP address/prefix may be included in the subscription data if the UE has subscribed to it.
   If the SMF has the LADN service area for a DNN and S-NSSAI, the SMF configures the DNN for the group as LADN DNN.
   The SMF checks the validity of the UE request: it checks:
      Whether the UE request is compliant with the user subscription and with local policies;
      (If the selected DNN corresponds to an LADN), whether the UE is located within the LADN service area based on the “UE presence in LADN service area” indication from the AMF. If the AMF does not provide the “UE presence in LADN service area” indication and the SMF determines that the selected DNN corresponds to a LADN, then the SMF considers that the UE is OUT of the LADN service area.
   The SMF determines whether the PDU Session requires redundancy and the SMF determines the RSN as described in clause 5.33.2.1 of TS 23.501 [2]. If the SMF determines that redundant handling is not allowed or not possible for the given PDU Session, the SMF shall either reject the establishment of the PDU Session or accept the establishment of a PDU session without redundancy handling based on local policy.
   If the UE request is considered as not valid, the SMF decides to not accept to establish the PDU Session.
   NOTE 3: The SMF can, instead of the Nudm_SDM_Get service operation, use the Nudm_SDM_Subscribe service operation with an Immediate Report Indication that triggers the UDM to immediately return the subscribed data if the corresponding feature is supported by both the SMF and the UDM.
   For a Disaster Roaming service, the UDM provides the Session Management Subscription data to the SMF based on the local policy and/or the local configuration as specified in clause 5.40.4 of TS 23.501 [2].
5. From SMF to AMF: Either Nsmf_PDUSession_CreateSMContext Response (Cause, SM Context ID or N1 SM container (PDU Session Reject (Cause))) or an Nsmf_PDUSession_UpdateSMContext Response depending on the request received in step 3.
   If the SMF received Nsmf_PDUSession_CreateSMContext Request in step 3 and the SMF is able to process the PDU Session establishment request, the SMF creates an SM context and responds to the AMF by providing an SM Context ID. If the UP Security Policy for the PDU Session is determined to have Integrity Protection set to “Required”, the SMF may, based on local configuration, decide whether to accept or reject the PDU Session request based on the UE Integrity Protection Maximum Data Rate.
   NOTE 4: The SMF can e.g. be configured to reject a PDU Session if the UE Integrity Protection Maximum Data Rate has a very low value, if the services provided by the DN would require higher bitrates.
   When the SMF decides to not accept to establish a PDU Session, the SMF rejects the UE request via NAS SM signalling including a relevant SM rejection cause by responding to the AMF with Nsmf_PDUSession_CreateSMContext Response. The SMF also indicates to the AMF that the PDU Session ID is to be considered as released, the SMF proceeds to step 20 and the PDU Session Establishment procedure is stopped.
6. Optional Secondary authentication/authorization.
   If the Request Type in step 3 indicates “Existing PDU Session”, the SMF does not perform secondary authentication/authorization.
   If the Request Type received in step 3 indicates “Emergency Request” or “Existing Emergency PDU Session”, the SMF shall not perform secondary authentication\authorization.
   If the SMF needs to perform secondary authentication/authorization during the establishment of the PDU Session by a DN-AAA Server as described in clause 5.6.6 of TS 23.501 [2], the SMF triggers the PDU Session establishment authentication/authorization as described in clause 4.3.2.3.
7a. If dynamic PCC is to be used for the PDU Session, the SMF performs PCF selection as described in clause 6.3.7.1 of TS 23.501 [2]. If the Request Type indicates “Existing PDU Session” or “Existing Emergency PDU Session”, the SMF shall use the PCF already selected for the PDU Session.
   Otherwise, the SMF may apply local policy.
7b. The SMF may perform an SM Policy Association Establishment procedure as defined in clause 4.16.4 to establish an SM Policy Association with the PCF and get the default PCC Rules for the PDU Session. The SMF shall include the 3GPP Data Off status if received in step 1. The GPSI, PVS FQDN(s) and/or PVS IP address(es) and the Onboarding Indication shall be included if available at SMF in the case of ON-SNPN. If the Request Type in step 3 indicates “Existing PDU Session”, the SMF provides information on the Policy Control Request Trigger condition(s) that have been met by an SMF initiated SM Policy Association Modification procedure as defined in clause 4.16.5.1. The PCF may provide policy information defined in clause 5.2.5.4 (and in TS 23.503 [20]) to SMF. The URSP rule enforcement in step 1 may be included if SMF receives the URSP rule enforcement from UE as described in clause 6.6.2.4 of TS 23.503 [20].
   The PCF for session may notify the PCF for UE about the URSP rule enforcement. Editor's note: How the PCF for UE subscribes/notified the URSP rule enforcement from PCF serving the session is FFS.
   During the SM Policy Association Establishment procedure, if the PCF detects the request relates to SM Policy Association enabling integration with TSN or TSC or Deterministic Networking (as defined in TS 23.501 [2] clause 5.28) based on local configuration, the PCF may provide policy control request trigger for 5GS Bridge/Router Information as defined in clause 6.1.3.5 of TS 23.503 [20]. The PCF, based on the Emergency DNN, sets the ARP of the PCC rules to a value that is reserved for Emergency services as described in TS 23.503 [20].
   NOTE 5: The purpose of step 7 is to receive PCC rules before selecting UPF. If PCC rules are not needed as input for UPF selection, step 7 can be performed after step 8.
8. If the Request Type in step 3 indicates “Initial request”, the SMF selects an SSC mode for the PDU Session as described in clause 5.6.9.3 of TS 23.501 [2]. The SMF also selects one or more UPFs as needed as described in clause 6.3.3 of TS 23.501 [2]. In the case of PDU Session Type IPv4 or IPv6 or IPv4v6, the SMF allocates an IP address/prefix for the PDU Session (unless configured otherwise) as described in clause 5.8.2 of TS 23.501 [2]. In the case of PDU Session Type IPv6 or IPv4v6, the SMF also allocates an interface identifier to the UE for the UE to build its link-local address. For Unstructured PDU Session Type the SMF may allocate an IPv6 prefix for the PDU Session and N6 point-to-point tunnelling (based on UDP/IPv6) as described in clause 5.6.10.3 of TS 23.501 [2]. For Ethernet PDU Session Type, neither a MAC nor an IP address is allocated by the SMF to the UE for this PDU Session.
   If the AMF indicated Control plane CIoT 5GS Optimisation in step 3 for this PDU session, then,
   1) For Unstructured PDU Session Type, the SMF checks whether UE's subscription include a “NEF Identity for NIDD” for the DNN/S-NSSAI combination. When the “NEF Identity for NIDD” is present in the UE's subscription data, the SMF will select the NEF identified for the S-NSSAI and selected DNN in the “NEF Identity for NIDD” as the anchor of this PDU Session. Otherwise, the SMF will select a UPF as the anchor of this PDU Session.
   2) For other PDU Session Types, the SMF will perform UPF selection to select a UPF as the anchor of this PDU Session.
   If the Request Type in Step 3 is “Existing PDU Session”, the SMF maintains the same IP address/prefix that has already been allocated to the UE in the source network.
   If the Request Type in step 3 indicates “Existing PDU Session” referring to an existing PDU Session moved between 3GPP access and non-3GPP access the SMF maintains the SSC mode of the PDU Session, the current PDU Session Anchor and IP address.
   NOTE 6: The SMF may decide to trigger, e.g., new intermediate UPF insertion or allocation of a new UPF as described in step 5 in clause 4.2.3.2.
   If the Request Type indicates “Emergency Request”, the SMF selects the UPF as described in clause 5.16.4 of TS 23.501 [2] and selects SSC mode 1.
   SMF may select a UPF (e.g. based on requested DNN/S-NSSAI) that supports NW-TT functionality.
9. SMF may perform an SMF initiated SM Policy Association Modification procedure as defined in clause 4.16.5.1 to provide information on the Policy Control Request Trigger condition(s) that have been met. If Request Type is “initial request” and dynamic PCC is deployed and PDU Session Type is IPv4 or IPv6 or IPv4v6, SMF notifies the PCF (if the Policy Control Request Trigger condition is met) with the allocated UE IP address/prefix(es).
   NOTE 7: If an IP address/prefix has been allocated before step 7 (e.g. subscribed static IP address/prefix in UDM/UDR) or the step 7 is performed after step 8, the IP address/prefix can be provided to PCF in step 7 and the IP address/prefix notification in this step can be skipped.
   PCF may provide updated policies to the SMF. The PCF may provide policy information defined in clause 5.2.5.4 (and in TS 23.503 [20]) to SMF. Editor's note: Whether and how the PCF serving the PDU session can use the received URSP rules enforcement report to take PCC decision is FFS.
10. If Request Type indicates “initial request”, the SMF initiates an N4 Session Establishment procedure with the selected UPF(s), otherwise it initiates an N4 Session Modification procedure with the selected UPF(s):
   10a. The SMF sends an N4 Session Establishment/Modification Request to the UPF and provides Packet detection, enforcement and reporting rules to be installed on the UPF for this PDU Session. If the SMF is configured to request IP address allocation from UPF as described in clause 5.8.2 of TS 23.501 [2] then the SMF indicates to the UPF to perform the IP address/prefix allocation and includes the information required for the UPF to perform the allocation. If the selective User Plane deactivation is required for this PDU Session, the SMF determines the Inactivity Timer and provides it to the UPF. The SMF provides Trace Requirements to the UPF if it has received Trace Requirements. If the Reliable Data Service is enabled for the PDU Session by the SMF as specified in TS 23.501 [2], the RDS Configuration information is provided to the UPF in this step. The SMF provides Small Data Rate Control parameters to the UPF for the PDU Session, if required. The SMF provides the Small Data Rate Control Status to the UPF, if received from the AMF. If the Serving PLMN intends to enforce Serving PLMN Rate Control (see clause 5.31.14.2 of TS 23.501 [2]) for this PDU session then the SMF shall provide Serving PLMN Rate Control parameters to UPF for limiting the rate of downlink control plane data packets.
   For a PDU Session of type Ethernet or IP, the SMF (e.g. for a certain requested DNN/S-NSSAI for which Time Sensitive Networking, Time Sensitive Communications, Time Synchronization and Deterministic Networking is applicable) may include an indication to request UPF to provide a port number. If SMF decides to perform redundant transmission for one or more QoS Flows of the PDU session as described in clause 5.33.1.2 of TS 23.501 [2], two CN Tunnel Info are requested by the SMF from the UPF. The SMF also indicates the UPF to eliminate the duplicated packet for the QoS Flow in uplink direction. The SMF indicates the UPF that one CN Tunnel Info is used as the redundancy tunnel of the PDU session described in clause 5.33.2.2 of TS 23.501 [2].
   If SMF decides to insert two I-UPFs between the PSA UPF and the NG-RAN for redundant transmission as described in clause 5.33.1.2 of TS 23.501 [2], the SMF requests the corresponding CN Tunnel Info and provides them to the I-UPFs and PSA UPF respectively. The SMF also indicates the PSA UPF to eliminate the duplicated packet for the QoS Flow in uplink direction. The SMF indicates the PSA UPF that one CN Tunnel Info is used as the redundancy tunnel of the PDU session described in clause 5.33.2.2 of TS 23.501 [2].
   NOTE 8: The method to perform elimination and reordering on RAN/UPF based on the packets received from the two GTP-U tunnels is up to RAN/UPF implementation. The two GTP-U tunnels are terminated at the same RAN node and UPF.
   If Control plane CIoT 5GS Optimisation is enabled for this PDU session and the SMF selects the NEF as the anchor of this PDU Session in step 8, the SMF performs SMF-NEF Connection Establishment Procedure as described in clause 4.25.2.
   If interworking with TSN deployed in the transport network is supported (see clause 4.4.8 of TS 23.501 [2]), the SMF includes a TL-Container with a get-request to the N4 Session Establishment or Modification request that is sent to the UPF, as described in clause 5.28a.2 of TS 23.501 [2].
   10b. The UPF acknowledges by sending an N4 Session Establishment/Modification Response.
   If the SMF indicates in step 10a that IP address/prefix allocation is to be performed by the UPF then this response contains the requested IP address/prefix. The requested CN Tunnel Info is provided to SMF in this step. If SMF indicated the UPF to perform packet duplication and elimination for the QoS Flow in step 10a, two CN Tunnel Info are allocated by the UPF and provided to the SMF. If SMF decides to insert two I-UPFs between the PSA UPF and the NG-RAN for redundant transmission as described in clause 5.33.1.2 of TS 23.501 [2], CN Tunnel Info of two I-UPFs and the UPF (PSA) are allocated by the UPFs and provided to the SMF. The UPF indicates the SMF that one CN Tunnel Info is used as the redundancy tunnel of the PDU session as described in clause 5.33.2.2 of TS 23.501 [2].
   If SMF requested UPF to provide a port number then UPF includes the port number and user-plane Node ID in the response according to TS 23.501 [2]. To support integration with IEEE TSN, the user-plane node ID is Bridge ID. Besides the network instance, the SMF may also provide DNN/S-NSSAI for the UPF to respond with user-plane Node ID based on pre-configuration information.
   If multiple UPFs are selected for the PDU Session, the SMF initiate N4 Session Establishment/Modification procedure with each UPF of the PDU Session in this step.
   NOTE 9: If the PCF has subscribed to the UE IP address change Policy Control Trigger (as specified in clause 6.1.3.5 of TS 23.503 [20]) then the SMF notifies the PCF about the IP address/prefix allocated by the UPF. This is not shown in FIG. 4.3.2.2.1-1.
   If interworking with TSN deployed in the transport network is supported and the UPF supports CN-TL and received a TL-Container with a get-request from the SMF/CUC in step 10a (see clause 4.4.8 of TS 23.501 [2]), the UPF/CN-TL includes a TL-Container with a get-response in the N4 Session Establishment or Modification response, as described in clause 5.28a.2 of TS 23.501 [2]. The SMF/CUC stores the get-response.
11. SMF to AMF: Namf_Communication_N1N2MessageTransfer (PDU Session ID, N2 SM information (PDU Session ID, QFI(s), QoS Profile(s), CN Tunnel Info, S-NSSAI from the Allowed NSSAI, Session-AMBR, PDU Session Type, User Plane Security Enforcement information, UE Integrity Protection Maximum Data Rate, RSN, PDU Session Pair ID, TL-Container), N1 SM container (PDU Session Establishment Accept ([QoS Rule(s) and QoS Flow level QoS parameters if needed for the QoS Flow(s) associated with the QoS rule(s)], selected SSC mode, S-NSSAI(s), UE Requested DNN, allocated IPv4 address, interface identifier, Session-AMBR, selected PDU Session Type, [Reflective QoS Timer] (if available), [P-CSCF address(es)], [Control Plane Only indicator], [Header Compression Configuration], [Always-on PDU Session Granted], [Small Data Rate Control parameters], [Small Data Rate Control Status], [Serving PLMN Rate Control], [PVS FQDN(s) and/or PVS IP address(es)]))). If multiple UPFs are used for the PDU Session, the CN Tunnel Info contains tunnel information related with the UPFs that terminate N3.
   The SMF may provide the SMF derived CN assisted RAN parameters tuning to the AMF by invoking Nsmf_PDUSession_SMContextStatusNotify (SMF derived CN assisted RAN parameters tuning) service. The AMF stores the SMF derived CN assisted RAN parameters tuning in the associated PDU Session context for this UE.
   The N2 SM information carries information that the AMF shall forward to the (R)AN which includes:
      The CN Tunnel Info corresponds to the Core Network address(es) of the N3 tunnel corresponding to the PDU Session. If two CN Tunnel Info are included for the PDU session for redundant transmission, the SMF also indicates the NG-RAN that one of the CN Tunnel Info used as the redundancy tunnel of the PDU session as described in clause 5.33.2.2 of TS 23.501 [2].
      One or multiple QoS profiles and the corresponding QFIs can be provided to the (R)AN. This is further described in clause 5.7 of TS 23.501 [2]. The SMF may indicate for each QoS Flow whether redundant transmission shall be performed by a corresponding redundant transmission indicator.
      The PDU Session ID may be used by AN signalling with the UE to indicate to the UE the association between (R)AN resources and a PDU Session for the UE.
      A PDU Session is associated to an S-NSSAI of the HPLMN and, if applicable, to a S-NSSAI of the VPLMN and a DNN. The S-NSSAI provided to the (R)AN, is the S-NSSAI with the value for the Serving PLMN (i.e. the HPLMN S-NSSAI or, in LBO roaming case, the VPLMN S-NSSAI).
      User Plane Security Enforcement information is determined by the SMF as described in clause 5.10.3 of TS 23.501 [2].
      If the User Plane Security Enforcement information indicates that Integrity Protection is “Preferred” or “Required”, the SMF also includes the UE Integrity Protection Maximum Data Rate as received in the PDU Session Establishment Request.
      The use of the RSN parameter and the PDU Session Pair ID by NG-RAN are described in clause 5.33.2.1 of TS 23.501 [2].
      For each QoS Flow, an ECN marking for L4S indicator to (R)AN in the case of ECN marking for L4S in RAN as described in clause 5.37.3 of TS 23.501 [2] or,
   a QoS monitoring configuration for congestion information as described in clause 5.45.3 of TS 23.501 [2] in the case of ECN marking for L4S by PSA UPF as described in clause 5.37.3 of TS 23.501 [2] or QoS monitoring for congestion information as described in clause 5.45.3 of TS 23.501 [2].
      TL-Container as described in clause 5.28a.2 of TS 23.501 [2]. If interworking with TSN deployed in the transport network is supported (see clause 4.4.8 of TS 23.501 [2]), the SMF includes a TL-Container with a get-request to the N2 SM information, as described in clause 5.28a.2 of TS 23.501 [2].
   The N1 SM container contains the PDU Session Establishment Accept that the AMF shall provide to the UE. If the UE requested P-CSCF discovery then the message shall also include the P-CSCF IP address(es) as determined by the SMF and as described in clause 5.16.3.4 of TS 23.501 [2]. The PDU Session Establishment Accept includes S-NSSAI from the Allowed NSSAI. For LBO roaming scenario, the PDU Session Establishment Accept includes the S-NSSAI from the Allowed NSSAI for the VPLMN and also it includes the corresponding S-NSSAI of the HPLMN from the Mapping Of Allowed NSSAI that SMF received in step 3.
   If the PDU Session being established was requested to be an always-on PDU Session, the SMF shall indicate whether the request is accepted by including an Always-on PDU Session Granted indication in the PDU Session Establishment Accept message. If the PDU Session being established was not requested to be an always-on PDU Session but the SMF determines that the PDU Session needs to be established as an always-on PDU Session, the SMF shall include an Always-on PDU Session Granted indication in the PDU Session Establishment Accept message indicating that the PDU session is an always-on PDU Session.
   If Control Plane CIoT 5GS Optimisation is enabled for this PDU session, the N2 SM information is not included in this step. If Control Plane CIoT 5GS optimisation is enabled for this PDU session and the UE has sent the Header Compression Configuration in the PDU Session Establishment Request and the SMF supports the header compression parameters, the SMF shall include the Header Compression Configuration in the PDU Session Establishment Accept message. If the UE has included Header Compression context parameters in Header Compression Configuration in the PDU Session Establishment Request, the SMF shall establish the header compression context and may acknowledge the Header Compression context parameters. If the header compression context is not established during the PDU Session Establishment procedure, before using the compressed format for sending the data, the UE and the SMF need to establish the header compression context based on the Header Compression Configuration. If the SMF has received the Control Plane Only Indicator in step 3, the SMF shall include the Control Plane Only Indicator in the PDU Session Establishment Accept message. The SMF shall indicate the use of Control Plane only on its CDR. If the Small Data Rate Control is configured in the SMF, the SMF shall also include Small Data Rate Control parameters and the Small Data Rate Control Status (if received from the AMF) in the PDU Session Establishment Accept message as described in clause 5.31.14.3 of TS 23.501 [2]. If the Serving PLMN intends to enforce Serving PLMN Rate Control (see clause 5.31.14.2 of TS 23.501 [2]) for this PDU session then the SMF shall include the Serving PLMN Rate Control parameters in the PDU Session Establishment Accept message. The UE shall store and use Serving PLMN Rate Control parameters as the maximum allowed limit of uplink control plane user data.
   If the UE indicates the support of RDS in the PCO in the PDU Session Establishment Request and RDS is enabled for the PDU Session, the SMF shall inform the UE that RDS is enabled in the PCO in the PDU Session Establishment Accept (see clause 5.31.6 of TS 23.501 [2]).
   If the NIDD parameters (e.g. maximum packet size) were received from NEF during the SMF-NEF Connection Establishment procedure in step 10, the SMF shall inform the UE of the NIDD parameters in the PCO in the PDU Session Establishment Accept (see clause 5.31.5 of TS 23.501 [2]).
   If the UE indicated in the PCO that it supports the ability to receive ECS address(es) via NAS, the SMF may provide the ECS Address Configuration Information (as described in clause 6.5.2 of TS 23.548 [74]) to the UE in the PCO. The SMF may derive the ECS Address Configuration Information based on local configuration and/or UE subscription information. In non-roaming scenarios, the SMF may also derive the ECS Address Configuration Information based on the UE's location.
   If the UE indicated in the PCO that it supports the EDC functionality, the SMF may indicate to the UE either that the use of the EDC functionality is allowed for the PDU Session or that the use of the EDC functionality is required for the PDU Session (see clause 5.2.1 of TS 23.548 [74]).
   Multiple QoS Rules, QoS Flow level QoS parameters if needed for the QoS Flow(s) associated with those QoS rule(s) and QoS Profiles may be included in the PDU Session Establishment Accept within the N1 SM and in the N2 SM information.
   The Namf_Communication_N1N2MessageTransfer contains the PDU Session ID allowing the AMF to know which access towards the UE to use.
   If the PDU session establishment failed anywhere between step 5 and step 11, then the Namf_Communication_N1N2MessageTransfer request shall include the N1 SM container with a PDU Session Establishment Reject message (see clause 8.3.3 of TS 24.501 [25]) and shall not include any N2 SM container. The (R)AN sends the NAS message containing the PDU Session Establishment Reject to the UE. In this case, steps 12-17 are skipped.
12. AMF to (R)AN: N2 PDU Session Request (N2 SM information, NAS message (PDU Session ID, N1 SM container (PDU Session Establishment Accept)), [CN assisted RAN parameters tuning]). If the N2 SM information is not included in the step 11, an N2 Downlink NAS Transport message is used instead.
   The AMF sends the NAS message containing PDU Session ID and PDU Session Establishment Accept targeted to the UE and the N2 SM information received from the SMF within the N2 PDU Session Request to the (R)AN.
   If the SMF derived CN assisted RAN parameters tuning are stored for the activated PDU Session(s), the AMF may derive updated CN assisted RAN parameters tuning and provide them the (R)AN.
13. (R)AN to UE: The (R)AN may issue AN specific signalling exchange with the UE that is related with the information received from SMF. For example, in the case of a NG-RAN, an RRC Connection Reconfiguration may take place with the UE establishing the necessary NG-RAN resources related to the QoS Rules for the PDU Session request received in step 12.
   (R)AN also allocates (R)AN Tunnel Info for the PDU Session. In the case of Dual Connectivity, the Master RAN node may assign some (zero or more) QFIs to be setup to a Master RAN node and others to the Secondary RAN node. The AN Tunnel Info includes a tunnel endpoint for each involved (R)AN node and the QFIs assigned to each tunnel endpoint. A QFI can be assigned to either the Master RAN node or the Secondary RAN node and not to both.
   If the (R)AN receives two CN Tunnel Info for a PDU session in step 12 for redundant transmission, (R)AN also allocates two AN Tunnel Info correspondingly and indicate to SMF one of the AN Tunnel Info is used as the redundancy tunnel of the PDU session as described in clause 5.33.2.2 of TS 23.501 [2].
   (R)AN forwards the NAS message (PDU Session ID, N1 SM container (PDU Session Establishment Accept)) provided in step 12 to the UE. (R)AN shall only provide the NAS message to the UE if the AN specific signalling exchange with the UE includes the (R)AN resource additions associated to the received N2 command.
   If MICO mode is active and the NAS message Request Type in step 1 indicated “Emergency Request”, then the UE and the AMF shall locally deactivate MICO mode.
   If the N2 SM information is not included in the step 11, then the following steps 14 to 16b and step 17 are omitted.
14. (R)AN to AMF: N2 PDU Session Response (PDU Session ID, Cause, N2 SM information (PDU Session ID, AN Tunnel Info, List of accepted/rejected QFI(s), User Plane Enforcement Policy Notification, TL-Container, [established QoS Flows status (active/not active) for QoS monitoring configuration for congestion information/ECN marking for L4S])).
   The AN Tunnel Info corresponds to the Access Network address of the N3 tunnel corresponding to the PDU Session.
   The (R)AN may reject the addition or modification of a QoS Flow, e.g. due to handling of the UE-Slice-MBR as described in clause 5.7.1.10 of TS 23.501 [2]. If the (R)AN rejects QFI(s) the SMF is responsible of updating the QoS rules and QoS Flow level QoS parameters associated to the rejected QoS Flow(s) in the UE accordingly.
   The NG-RAN rejects the establishment of UP resources for the PDU Session when it cannot fulfil User Plane Security Enforcement information with a value of Required. The NG-RAN notifies the SMF when it cannot fulfil a User Plane Security Enforcement with a value of Preferred.
   If the NG-RAN cannot establish redundant user plane for the PDU Session as indicated by the RSN parameter and PDU Session Pair ID, the NG-RAN takes the decision on whether to reject the establishment of RAN resources for the PDU Session based on local policies as described in TS 23.501 [2].
   If interworking with TSN deployed in the transport network is supported and the NG-RAN supports AN-TL and received a TL-Container with a get-request from the SMF/CUC in step 12 (see clause 4.4.8 of TS 23.501 [2]), the NG-RAN/AN-TL includes a TL-Container with a get-response to the N2 SM information, as described in clause 5.28a.2 of TS 23.501 [2].
15. AMF to SMF: Nsmf_PDUSession_UpdateSMContext Request (SM Context ID, N2 SM information, Request Type).
   The AMF forwards the N2 SM information received from (R)AN to the SMF.
   If the list of rejected QFI(s) is included in N2 SM information, the SMF shall release the rejected QFI(s) associated QoS profiles.
   If the N2 SM information indicates failure of user plane resource setup, the SMF shall reject the PDU session establishment by including a N1 SM container with a PDU Session Establishment Reject message (see clause 8.3.3 of TS 24.501 [25]) in the Nsmf_PDUSession_UpdateSMContext Response in step 17. Step 16 is skipped in this case and instead the SMF releases the N4 Session with UPF.
   If the User Plane Enforcement Policy Notification in the N2 SM information indicates that no user plane resources could be established and the User Plane Enforcement Policy indicated “required” as described in clause 5.10.3 of TS 23.501 [2], the SMF shall reject the PDU session establishment by including a N1 SM container with a PDU Session Establishment Reject message (see clause 8.3.3 of TS 24.501 [25]) in the Nsmf_PDUSession_UpdateSMContext Response in step
17. Step 16 is skipped in this case.
   If the N2 SM information includes a TL-Container with a get-response as described in clause 5.28a.2 of TS 23.501 [2], the SMF/CUC stores the get-response.
16a. The SMF initiates an N4 Session Modification procedure with the UPF. The SMF provides AN Tunnel Info to the UPF as well as the corresponding forwarding rules.
   If SMF decides to perform redundant transmission for one or more QoS Flows of the PDU, the SMF also indicates the UPF to perform packet duplication for the QoS Flow(s) in downlink direction by forwarding rules.
   In the case of redundant transmission with two I-UPFs for one or more QoS Flows of the PDU, the SMF provides AN Tunnel Info to two I-UPFs and also indicates the UPF (PSA) to perform packet duplication for the QoS Flow(s) in downlink direction by forwarding rules. The SMF also provides the UL Tunnel Info of the UPF (PSA) to the two I-UPFs and the DL Tunnel Info of the two I-UPFs to the UPF (PSA).
   NOTE 10: If the PDU Session Establishment Request was due to mobility between 3GPP and non-3GPP access or mobility from EPC, the downlink data path is switched towards the target access in this step.
16b. The UPF provides an N4 Session Modification Response to the SMF.
   If multiple UPFs are used in the PDU Session, the UPF in step 16 refers to the UPF terminating N3.
   After this step, the UPF delivers any down-link packets to the UE that may have been buffered for this PDU Session.
16c. If Request Type in step 3 indicates neither “Emergency Request” nor “Existing Emergency PDU Session” and, if the SMF has not yet registered for this PDU Session, then the SMF registers with the UDM using Nudm_UECM_Registration (SUPI, DNN, S-NSSAI of HPLMN, PDU Session ID, SMF Identity, Serving Node PLMN ID, [NID]) for a given PDU Session. As a result, the UDM stores following information: SUPI, SMF identity and the associated DNN, S-NSSAI of HPLMN, PDU Session ID and Serving Network (PLMN ID, [NID], see clause 5.18 of TS 23.501 [2]). The UDM may further store this information in UDR by Nudr_DM_Update (SUPI, Subscription Data, UE context in SMF data). If the UDM has existing applicable event exposure subscriptions for events detected in SMF for this UE or any of the groups this UE belongs to (possibly retrieved from UDR), UDM invokes the Nsmf_EventExposure_Subscribe service for creating the event exposure subscriptions.
   If the Request Type received in step 3 indicates “Emergency Request”:
      For an authenticated non-roaming UE, based on operator configuration (e.g. related with whether the operator uses a fixed SMF for Emergency calls, etc.), the SMF may register in the UDM using Nudm_UECM_Registration (SUPI, PDU Session ID, SMF identity, Indication of Emergency Services) for a given PDU Session that is applicable for emergency services. As a result, the UDM shall store the applicable PDU Session for Emergency services.
      For an unauthenticated UE or a roaming UE, the SMF shall not register in the UDM for a given PDU Session.
17. SMF to AMF: Nsmf_PDUSession_UpdateSMContext Response (Cause). The SMF may subscribe to the UE mobility event notification from the AMF (e.g. location reporting, UE moving into or out of Area Of Interest), after this step by invoking Namf_EventExposure_Subscribe service operation as specified in clause 5.2.2.3.2. For LADN, the SMF subscribes to the UE moving into or out of LADN service area event notification by providing the LADN DNN as an indicator for the Area Of Interest (see clause 5.6.5 and 5.6.11 of TS 23.501 [2]).
   After this step, the AMF forwards relevant events subscribed by the SMF.
   For those scenarios where the PCFs serving the AMF and the SMF are different, the SMF informs the AMF of the NWDAF ID(s) used for UE related Analytics and corresponding Analytics ID(s).
18. [Conditional] SMF to AMF: Nsmf_PDUSession_SMContextStatusNotify (Release)
   If during the procedure, any time after step 5, the PDU Session establishment is not successful, the SMF informs the AMF by invoking Nsmf_PDUSession_SMContextStatusNotify (Release). The SMF also releases any N4 session(s) created, any PDU Session address if allocated (e.g. IP address) and releases the association with PCF, if any. In this case, step 19 is skipped.
19. SMF to UE: In the case of PDU Session Type IPv6 or IPv4v6, the SMF generates an IPv6 Router Advertisement and sends it to the UE. If Control Plane CIoT 5GS Optimisation is enabled for this PDU Session the SMF sends the IPv6 Router Advertisement via the AMF for transmission to the UE using the Mobile Terminated Data Transport in Control Plane CIoT 5Gs Optimisation procedures (see clause 4.24.2), otherwise the SMF sends the IPv6 Router Advertisement via N4 and the UPF.
20. When the trigger for 5GS Bridge/Router information available is armed, then the SMF may initiate the SM Policy Association Modification as described in clause 4.16.5.1.
   If the UE has indicated support of transferring Port Management Information Containers, then SMF informs PCF that 5GS Bridge/Router information is available. SMF provides the 5GS Bridge/Router information (e.g. 5GS user-plane Node ID, port number for the PDU session, MAC address of the DS-TT Ethernet port for Ethernet PDU Session type, UE IP address for IP PDU Session type and UE-DS-TT Residence Time (if available) as provided by the UE) to PCF. In the case of Deterministic Networking, the SMF may also provide the MTU size for IPv4 or the MTU size for IPv6. If the SMF received a Port Management Information Container from either the UE or the UPF, then the SMF provides the Port Management Information Container and port number of the related port to the PCF as described in clause 5.28.3.2 of TS 23.501 [2].
   If the SMF has received User Plane Node Management Information from the UPF, then the SMF provides the User Plane Node Management Information Container to the PCF as part of 5GS Bridge/Router information and as described in clause 5.28.3.2 of TS 23.501 [2].
   To support IEEE TSN, the TSN AF calculates the bridge delay for each port pair, i.e. composed of DS-TT Ethernet port and NW-TT Ethernet port, using the UE-DS-TT Residence Time for all NW-TT Ethernet port(s) serving the 5GS Bridge indicated by the 5GS user-plane Node ID. Additionally, the TSN AF determines the 5GS bridge delay for port pair composed of two DS-TT ports connecting to the same 5GS Bridge as sum of bridge delays related to PDU Sessions of the two DS-TT ports.
21. If the PDU Session establishment failed after step 4, the SMF shall perform the following:
   The SMF unsubscribes to the modifications of Session Management Subscription data for the corresponding (SUPI, DNN, S-NSSAI of the HPLMN), using Nudm_SDM_Unsubscribe (SUPI, Session Management Subscription data, DNN, S-NSSAI of the HPLMN), if the SMF is no more handling a PDU Session of the UE for this (DNN, S-NSSAI of the HPLMN). The UDM may unsubscribe to the modification notification from UDR by Nudr_DM_Unsubscribe (SUPI, Subscription Data, Session Management Subscription data, S-NSSAI of the HPLMN, DNN).

### Next Change

### 4.3.3.2 UE or Network Requested PDU Session Modification (Non-Roaming and Roaming with Local Breakout)

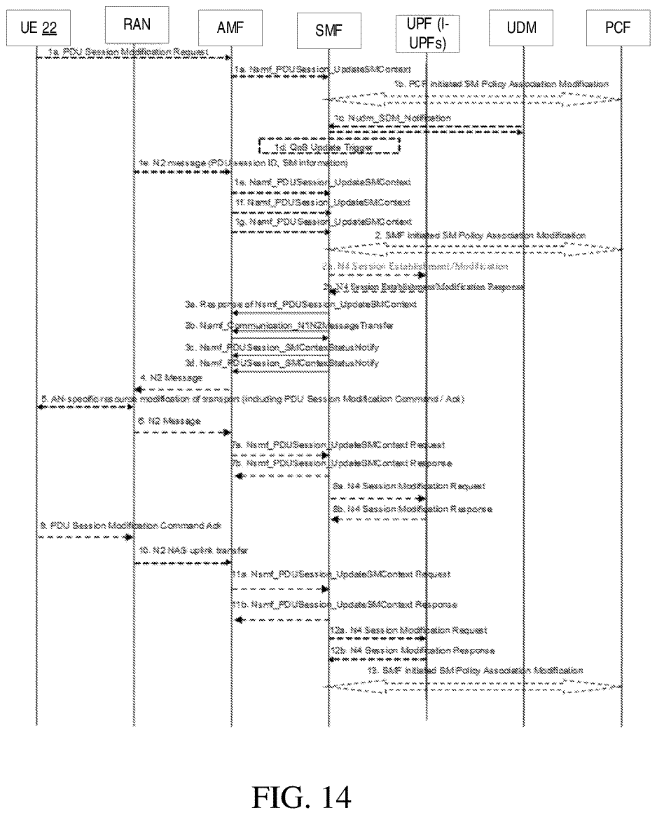

The UE or network requested PDU Session Modification procedure (non-roaming and roaming with local breakout scenario) is depicted in FIG. 14 (also referred to as FIG. 4.3.3.2-1). FIG. 4.3.3.2-1: UE or network requested PDU Session Modification (for non-roaming and roaming with local breakout).
1. The procedure may be triggered by following events:
   1a. (UE initiated modification) The UE initiates the PDU Session Modification procedure by the transmission of an NAS message (N1 SM container (PDU Session Modification Request (PDU session ID, Packet Filters, Operation, Requested QoS, Segregation, 5GSM Core Network Capability, Number Of Packet Filters, [Connection Capabilities], [Always-on PDU Session Requested], [Requested Non-3GPP Delay Budget])), PDU Session ID, UE Integrity Protection Maximum Data Rate, [Port Management Information Container]) message. Depending on the Access Type, if the UE was in CM-IDLE state, this SM-NAS message is preceded by the Service Request procedure. The NAS message is forwarded by the (R)AN to the AMF with an indication of User location Information. The AMF invokes Nsmf_PDUSession_UpdateSMContext (SM Context ID, N1 SM container (PDU Session Modification Request)).
   When the UE requests specific QoS handling for selected SDF(s), the PDU Session Modification Request includes Packet Filters describing the SDF(s), the requested Packet Filter Operation (add, modify, delete) on the indicated Packet Filters, the Requested QoS and optionally a Segregation indication. The Segregation indication is included when the UE recommends to the network to bind the applicable SDF(s) on a distinct and dedicated QoS Flow e.g. even if an existing QoS Flow can support the requested QoS. The network should abide by the UE request, but is allowed to proceed instead with binding the selected SDF(s) on an existing QoS Flow.
NOTE 1: Only one QoS Flow is used for traffic segregation. If UE makes subsequent requests for segregation of additional SDF(s), the additional SDF(s) are multiplexed on the existing QoS Flow that is used for segregation.
   The UE shall not trigger a PDU Session Modification procedure for a PDU Session corresponding to a LADN when the UE is outside the area of availability of the LADN.
   The PS Data Off status, if changed, shall be included in the PCO in the PDU Session Modification Request message.
   For a PDU Session which was established in the EPS, when the UE moves from EPS to 5GS for the first time, the UE includes an Always-on PDU Session Requested indication in the PDU Session Modification Request message if it wants to change the PDU Session to an always-on PDU Session.
   If UE supports to report URSP rule enforcement to network, the UE may provide Connection Capabilities as described in clause 6.6.2.4 of TS 23.503 [20].
   When PCF is deployed, the SMF shall further report the PS Data Off status to PCF if the PS Data Off event trigger is provisioned, the additional behaviour of SMF and PCF for 3GPP PS Data Off is defined in TS 23.503 [20].
   The 5GSM Core Network Capability is provided by the UE and handled by SMF as defined in clause 5.4.4b of TS 23.501 [2].
   The UE Integrity Protection Maximum Data Rate indicates the maximum data rate up to which the UE can support UP integrity protection. It is set as defined in TS 23.501 [2].
   The Number Of Packet Filters indicates the number of supported packet filters for signalled QoS rules as described in clause 5.17.2.2.2 of TS 23.501 [2]. When it moves from EPS to 5GS for the first time, a UE that supports EAS re-discovery as described in clause 6.2.3.3 of TS 23.548 [74], may indicate so in the PCO.
   When it moves from EPS to 5GS for the first time, a UE that hosts the EDC functionality shall indicate in the PCO its capability to support the EDC functionality (see clause 5.2.1 of TS 23.548 [74]).
   Port Management Information Container may be received from DS-TT and includes DS-TT port related management information as defined in clause 5.28.3 of TS 23.501 [2].
   1b. (PCF initiated SM Policy Association Modification) The PCF performs a PCF initiated SM Policy Association Modification procedure as defined in clause 4.16.5.2 to notify SMF about the modification of policies. This may e.g. have been triggered by a policy decision or upon AF requests, e.g. Application Function influence on traffic routing as described in step 5 in clause 4.3.6.2 or AF to provide Port management information Container.
   If QoS Monitoring is requested by the AF, the PCF generates the QoS Monitoring policy for the corresponding service data flow and provides the policy in the PCC rules to the SMF in this step.
   1c. (SMF requested modification) The UDM updates the subscription data of SMF by Nudm_SDM_Notification (SUPI, Session Management Subscription Data). The SMF updates the Session Management Subscription Data and acknowledges the UDM by returning an Ack with (SUPI).
   1d. (SMF requested modification) The SMF may decide to modify PDU Session. This procedure also may be triggered based on locally configured policy or triggered from the (R)AN (see clause 4.2.6 and clause 4.9.1). It may also be triggered if the UP connection is activated (as described in Service Request procedure) and the SMF has marked that the status of one or more QoS Flows are deleted in the 5GC but not synchronized with the UE yet.
   If interworking with TSN deployed in the transport network is supported and either the UPF supports CN-TL or NG-RAN supports AN-TL (see clause 4.4.8 of TS 23.501 [2]), the procedure may be triggered due to reception of Status group from TN CNC.
   The SMF may decide to modify PDU Session to send updated ECS Address Configuration Information to the UE as defined in clause 6.5.2 of TS 23.548 [74]. The SMF may decide to modify PDU Session to send updated DNS server address to the UE as defined in clause 6.2.3.2.3 of TS 23.548 [74].
   The SMF may decide to modify PDU Session to send the EAS rediscovery indication to the UE as defined in clause 6.2.3.3 of TS 23.548 [74].
   If the SMF receives one of the triggers in step 1b~1d, the SMF starts SMF requested PDU Session Modification procedure.
   1e. (AN initiated modification) (R)AN shall indicate to the SMF when the AN resources onto which a QoS Flow is mapped are released irrespective of whether notification control is configured. (R)AN sends the N2 message (PDU Session ID, N2 SM information) to the AMF. The N2 SM information includes the QFI, User location Information and an indication that the QoS Flow is released. The AMF invokes Nsmf_PDUSession_UpdateSMContext (SM Context ID, N2 SM information).
   (AN initiated notification control) If notification control is configured for a GBR QoS Flow, (R)AN sends a N2 message (PDU Session ID, N2 SM information) to SMF when the (R)AN decides the QoS targets of the QoS Flow cannot be fulfilled or can be fulfilled again, respectively. The N2 SM information includes the QFI and an indication that the QoS targets for that QoS Flow cannot be fulfilled or can be fulfilled again, respectively. When QoS targets cannot be fulfilled, the N2 SM information indicates a reference to the Alternative QoS Profile matching the values of the QoS parameters that the NG-RAN is currently fulfilling as specified in clause 5.7.2.4 of TS 23.501 [2]. If the QoS Flow has a TSCAI including Capability for BAT adaptation and without Burst Arrival Time, the N2 SM information can also include a BAT offset as described in clause 5.27.2.5 of TS 23.501 [2]. The AMF invokes Nsmf_PDUSession_UpdateSMContext (SM Context ID, N2 SM information). If the PCF has subscribed to the event, SMF reports this event to the PCF for each PCC Rule for which notification control is set in step 2.
   1f. (AMF initiated modification) If the UE supports CE mode B and use of CE mode changes from restricted to unrestricted or vice versa in the Enhanced Coverage Restriction information in the UE context in the AMF and the UE has already established PDU sessions, then the AMF shall trigger a PDU session modification to the SMFs serving the UE's PDU sessions when the AMF determines that NAS-SM timer shall be updated due to the change of Enhanced Coverage Restriction and include the extended NAS-SM indication only if use of CE mode B is now unrestricted in the Enhanced Coverage Restriction information in the UE context in the AMF.
   If the AMF, based on configuration, is aware that the UE is accessing over a gNB using GEO satellite backhaul and GEO Satellite ID needs to be updated to the SMF, the AMF may, based on configuration, include the latest GEO Satellite ID as described in clause 5.43.2 of TS 23.501 [2].
   1g. (AMF initiated modification) the AMF informs the SMF of updates of the NWDAF ID(s) used for UE related Analytics and corresponding Analytics ID(s). Also, If the PCF request notification of SM Policy Association and there is any PDU Session established to that DNN, S-NSSAI [PCF binding information, notification of SM Policy Association establishment Indication].
   Based on the extended NAS-SM timer indication, the SMF shall use the extended NAS-SM timer setting for the UE as specified in TS 24.501 [25].
2. The SMF may need to report some subscribed event to the PCF by performing an SMF initiated SM Policy Association Modification procedure as defined in clause 4.16.5.1. This step may be skipped if PDU Session Modification procedure is triggered by step 1b or 1d. If dynamic PCC is not deployed, the SMF may apply local policy to decide whether to change the QoS profile.
   Steps 2a to 7 are not invoked when the PDU Session Modification requires only action at a UPF (e.g. gating).
2a. The SMF may update the UPF with N4 Rules related to new or modified QoS Flow(s).
NOTE 2: This allows the UL packets with the QFI of a new or modified QoS Flow to be transferred.
   If the SMF initiated the PDU Session Modification procedure in step 1b due to PCF initiated SM Policy Association Modification that adds one or more PCC Rule(s) with a TSC Assistance Container, and if interworking with TSN deployed in the transport network is supported and the UPF does not support CN-TL, the SMF instructs the UPF to assign a distinct N3 tunnel end point address for the QoS Flow(s) assigned with a TSC Assistance Container.
   If the SMF initiated the PDU Session Modification procedure in step 1d due to reception of Status group from TN CNC, the SMF includes a TL-Container with a set-request to the N4 Session Modification request that is sent to the UPF, as described in clause 5.28a.2 of TS 23.501 [2].
   If redundant transmission has not been activated to the PDU session and the SMF decides to perform redundant transmission for the QoS Flow, the SMF indicates to the UPF to perform packet duplication and elimination for the QoS Flow.
   If redundant transmission has been activated on the PDU Session and the SMF decides to stop redundant transmission, the SMF indicates the UPF to release the CN Tunnel Info which is used as the redundancy tunnel of the PDU Session and also indicates the UPF to stop packet duplication and elimination for the corresponding QoS Flow(s).
NOTE 3: The method to perform elimination and reordering on RAN/UPF based on the packets received from the two GTP-U tunnels is up to RAN/UPF implementation. The two GTP-U tunnels are terminated at the same RAN node and UPF.
   If redundant transmission has not been activated to the PDU Session and the SMF decides to perform redundant transmission for the QoS Flow with two I-UPFs between the PSA UPF and the NG-RAN, the SMF sends a N4 Session Establishment Request message to the I-UPFs including UL CN Tunnel Info of the PSA UPF and a request to allocate CN Tunnel Info.
   SMF may make use of Redundant Transmission Experience analytics provided by NWDAF, when SMF takes a decision whether to perform redundant transmission, or stop redundant transmission if it had been activated, as described in clause 6.13 of TS 23.288 [50].
2b. The UPF(s) respond to the SMF. If redundant transmission has not been activated to the PDU session and the SMF indicated the UPF to perform packet duplication and elimination for the QoS Flow in step 2a, the UPF allocates an additional CN Tunnel Info. The additional CN Tunnel Info is provided to the SMF.
   If redundant transmission has not been activated to the PDU Session and the SMF decides to perform redundant transmission for the QoS Flow with two I-UPFs in step 2a, the UPFs allocate CN Tunnel Info. The CN Tunnel Info of each I-UPF is provided to the SMF.
   If interworking with TSN deployed in the transport network is supported and the UPF supports CN-TL and received a TL-Container with a set-request from the SMF/CUC in step 2a (see clause 4.4.8 of TS 23.501 [2]), the UPF/CN-TL includes a TL-Container with a set-response to the N4 Session Modification response, as described in clause 5.28a.2 of TS 23.501 [2].
3a. For UE or AN initiated modification, the SMF responds to the AMF through Nsmf_PDUSession_UpdateSMContext Response ([N2 SM information (PDU Session ID, QFI(s), QoS Profile(s), [Alternative QoS Profile(s)], Session-AMBR], [CN Tunnel Info(s)]), N1 SM container (PDU Session Modification Command (PDU Session ID, QoS rule(s), QoS rule operation, QoS Flow level QoS parameters if needed for the QoS Flow(s) associated with the QoS rule(s), Session-AMBR, [Always-on PDU Session Granted], [Port Management Information Container], [Non-3GPP QoS Assistance Information Container]))). See clause 5.7 of TS 23.501 [2] for the QoS Profile, Alternative QoS Profile and QoS rule and QoS Flow level QoS parameters. Alternative QoS Profile is only valid for AN initiated modification.
   If the PDU Session Modification was requested by the UE to modify a PDU Session to an always-on PDU Session, the SMF shall include an Always-on PDU Session Granted indication in the PDU Session Modification Command to indicate whether the PDU Session is to be changed to an always-on PDU Session or not via the Always-on PDU Session Granted indication in the PDU Session Modification Command.
   The N2 SM information carries information that the AMF shall provide to the (R)AN. It may include the QoS profiles and the corresponding QFIs to notify the (R)AN that one or more QoS flows were added, or modified. It may include only QFI(s) to notify the (R)AN that one or more QoS flows were removed. The SMF may indicate for each QoS Flow whether redundant transmission shall be performed by a corresponding redundant transmission indicator. If the SMF decides to activate redundant transmission in step 2a, the SMF includes the allocated additional CN Tunnel Info in the N2 SM information. If the SMF decides to perform redundant transmission for new QoS Flow with two I-UPFs in step 2a, the SMF includes the allocated CN Tunnel Info of the two I-UPFs in the N2 SM information. If the PDU Session Modification was triggered by the (R)AN Release in step 1e the N2 SM information carries an acknowledgement of the (R)AN Release. If the PDU Session Modification was requested by the UE for a PDU Session that has no established User Plane resources, the N2 SM information provided to the (R)AN includes information for establishment of User Plane resources.
   If redundant transmission has been activated on the PDU Session and the SMF decides to stop redundant transmission in step 2a, the SMF indicates the (R)AN to release the AN Tunnel and stop packet duplication and elimination associated with the redundancy tunnel of the PDU Session.
   The N1 SM container carries the PDU Session Modification Command that the AMF shall provide to the UE. It may include the QoS rules, QoS Flow level QoS parameters if needed for the QoS Flow(s) associated with the QoS rule(s) and corresponding QoS rule operation and QoS Flow level QoS parameters operation to notify the UE that one or more QoS rules were added, removed or modified. If port number and a Port Management Information Container have been received from PCF in Step 2 and the port number matches the port number assigned for the DS-TT port for this PDU session, then SMF includes the Port Management Information Container in the N1 SM container.
   The SMF may need to send transparently through NG-RAN the PDU Session Modification Command to inform the UE about changes in the QoS parameters (i.e. 5QI, GFBR, MFBR) that the NG-RAN is currently fulfilling after the SMF receives QoS Notification Control as defined in clause 5.7.2.4 of TS 23.501 [2]. When the SMF sends on the PDU Session Modification Command transparently through NG-RAN, the N2 SM information is not included as part of the Namf_Communication_N1N2MessageTransfer.
   If the UE indicated in the PCO that it supports the EDC functionality, the SMF may indicate to the UE either that the use of the EDC functionality is allowed for the PDU Session or that the use of the EDC functionality is required for the PDU Session (see clause 5.2.1 of TS 23.548 [74]).
   SMF may provide the UE with per QoS-flow Non-3GPP QoS Assistance Information in the N1 SM container.
3b. For SMF requested modification, the SMF invokes Namf_Communication_N1N2MessageTransfer ([N2 SM information] (PDU Session ID, QFI(s), QoS Profile(s), [Alternative QoS Profile(s)], Session-AMBR, [CN Tunnel Info(s)], QoS Monitoring indication, QoS Monitoring reporting frequency, [QoS monitoring configuration for congestion information or ECN marking for L4S indicator for QoS Flow]), [TSCAI(s)], TL-Container), N1 SM container (PDU Session Modification Command (PDU Session ID, QoS rule(s), QoS Flow level QoS parameters if needed for the QoS Flow(s) associated with the QoS rule(s), QoS rule operation and QoS Flow level QoS parameters operation, Session-AMBR))).
   If the SMF initiated the PDU Session Modification procedure in step 1b due to PCF initiated SM Policy Association Modification that adds one or more PCC Rule(s) with a TSC Assistance Container and if interworking with TSN deployed in the transport network is supported and the NG-RAN does not support AN-TL, the SMF instructs the NG-RAN to assign a distinct N3 tunnel end point address for the QoS Flow(s) assigned with a TSC Assistance Container.
   The SMF may indicate for each QoS Flow whether redundant transmission shall be performed by a corresponding redundant transmission indicator. If the SMF decides to activate redundant transmission in step 2a, the SMF includes the allocated additional CN Tunnel Info in the N2 SM information. If the SMF decides to perform redundant transmission for new QoS Flow with two I-UPFs in step 2a, the SMF includes the allocated CN Tunnel Info of the two I-UPFs in the N2 SM information.
   If redundant transmission has been activated on the PDU Session and the SMF decides to stop redundant transmission in step 2a, the SMF indicates the (R)AN to release the AN Tunnel and stop packet duplication and elimination associated with the redundancy tunnel of the PDU Session.
   The SMF indicates the request for QoS Monitoring for the QoS Flow according to the information received from the PCF in step 1b, or based on SMF local policy, e.g. when the RAN rejected the creation of a specific QoS Flow. In the case of receiving the QoS Monitoring indication, the RAN enables the RAN part of UL/DL packet delay measurement for the QoS Flow and the QoS Monitoring reporting frequency is used by RAN to determine the packet delay measurement frequency of the RAN part. In the case of receiving QoS monitoring configuration for congestion information, RAN initiates reporting of UL and/or DL QoS Flow congestion information to PSA UPF as defined in 5.45.3. The TSCAI is defined in clause 5.27.2 of TS 23.501 [2].
   If the SMF initiated the PDU Session Modification procedure in step 1d due to reception of Status group from TN CNC, the SMF includes a TL-Container with a set-request to the N2 SM information, as described in clause 5.28a.2 of TS 23.501 [2].
   If the UE is in CM-IDLE state and an ATC is activated, the AMF updates and stores the UE context based on the Namf_Communication_N1N2MessageTransfer and steps 4, 5, 6 and 7 are skipped. When the UE is reachable e.g. when the UE enters CM-CONNECTED state, the AMF forwards the N1 message to synchronize the UE context with the UE.
3c. For SMF requested modification due to updated SMF-Associated parameters from the UDM, the SMF may provide the SMF derived CN assisted RAN parameters tuning to the AMF. The SMF invokes Nsmf_PDUSession_SMContextStatusNotify (SMF derived CN assisted RAN parameters tuning) towards the AMF. The AMF stores the SMF derived CN assisted RAN parameters tuning in the associated PDU Session context for this UE.
3d. For SMF requested modification due to updated NWDAF ID, the SMF informs the AMF of updates of the NWDAF ID(s) used for UE related Analytics and corresponding Analytics ID(s).
4. The AMF may send N2 ([N2 SM information received from SMF], NAS message (PDU Session ID, N1 SM container (PDU Session Modification Command))) Message to the (R)AN.
5. The (R)AN may issue AN specific signalling exchange with the UE that is related with the information received from SMF. For example, in the case of a NG-RAN, an RRC Connection Reconfiguration may take place with the UE modifying the necessary (R)AN resources related to the PDU Session or if only N1 SM container is received in step 4 from AMF, RAN transports only the N1 SM container to the UE.
   The (R)AN may consider the updated CN assisted RAN parameters tuning to reconfigure the AS parameters.
   As part of this, the N1 SM container is provided to the UE. If the N1 SM container includes a Port Management Information Container then the UE provides the container to DS-TT.
   If new DNS server address is provided to the UE in the PCO, the UE can refresh all EAS(s) information (e.g. DNS cache) bound to the PDU Session, based on UE implementation as described in clause 6.2.3.2.3 of TS 23.548 [74].
6. The (R)AN may acknowledge N2 PDU Session Request by sending a N2 PDU Session Ack (N2 SM information (List of accepted/rejected QFI(s), AN Tunnel Info, PDU Session ID, Secondary RAT usage data, TL-Container, BAT offset, Periodicity, [established QoS Flows status (active/not active) for QoS monitoring configuration for congestion information/ECN marking for L4S]), User location Information) Message to the AMF. In the case of Dual Connectivity, if one or more QFIs were added to the PDU Session, the Master RAN node may assign one or more of these QFIs to a NG-RAN node which was not involved in the PDU Session earlier. In this case the AN Tunnel Info includes a new N3 tunnel endpoint for QFIs assigned to the new NG-RAN node. Correspondingly, if one or more QFIs were removed from the PDU Session, a (R)AN node may no longer be involved in the PDU Session anymore and the corresponding tunnel endpoint is removed from the AN Tunnel Info. The NG-RAN may reject QFI(s) if it cannot fulfil the User Plane Security Enforcement information for a corresponding QoS Profile, e.g., due to the UE Integrity Protection Maximum Data Rate being exceeded. When receiving the request for QoS Monitoring, the (R)AN may indicate its rejection to perform QoS Monitoring, e.g. due to the (R)AN load condition. The (R)AN may reject the addition or modification of a QoS Flow, e.g. due to handling of the UE-Slice-MBR as described in clause 5.7.1.10 of TS 23.501 [2]. If the (R)AN rejects the addition or modification of a QoS Flow, the SMF is responsible of updating the QoS rules and QoS Flow level QoS parameters associated to that QoS Flow in the UE accordingly.
   If the PLMN has configured secondary RAT usage reporting, the NG-RAN node may provide RAN Usage Data Report. The User Location Information shall include the serving cell's ID and, if Dual Connectivity is activated for the UE, the PSCell ID.
   If the redundant transmission has not been activated to the PDU session and the SMF indicates to the RAN that one of the QoS Flow shall perform redundant transmission, the RAN includes an additional AN tunnel info in N2 SM information.
   If interworking with TSN deployed in the transport network is supported and the NG-RAN supports AN-TL and received a TL-Container with a set-request from the SM/CUC in step 3b (see clause 4.4.8 of TS 23.501 [2]), the NG-RAN/AN-TL includes a TL-Container with a set-response to the N2 SM information, as described in clause 5.28a.2 of TS 23.501 [2].
   If the NG-RAN has determined a BAT offset and optionally a periodicity as described in clause 5.27.2.5 of TS 23.501 [2], the NG-RAN provides the BAT offset and optionally the periodicity in the N2 SM information.
7. The AMF forwards the N2 SM information and the User location Information received from the AN to the SMF via Nsmf_PDUSession_UpdateSMContext service operation. The SMF replies with a Nsmf_PDUSession_UpdateSMContext Response.
   If the N2 SM information indicates failure of whole N2 SM request (i.e. no part of the N2 SM request is successful in (R)AN), the SMF assumes that the NAS PDU, if provided in step 3, was not forwarded by NG-RAN to UE, as described in TS 38.413 [10]. In this case, if the PDU Session modification is UE triggered the SMF shall reject the PDU session modification by including a N1 SM container with a PDU Session Modification Reject message (see clause 8.3.3 of TS 24.501 [25]) in the Nsmf_PDUSession_UpdateSMContext Response in step 7b. Step 8 is skipped in this case.
   Otherwise, the SMF assumes that the NAS PDU was sent to UE successfully. If the (R)AN rejects QFI(s), the SMF is responsible of updating the QoS rules and QoS Flow level QoS parameters if needed for the QoS Flow(s) associated with the QoS rule(s) in the UE accordingly, i.e. the SMF shall trigger a separate NAS PDU Session Modification procedure after step 11 to align the SM context of this PDU Session in UE.
8. The SMF may update N4 session of the UPF(s) that are involved by the PDU Session Modification by sending N4 Session Modification Request message to the UPF (see NOTE 3).
   The SMF may update the UPF with N4 Rules related to new, modified or removed QoS Flow(s), unless it was done already in step 2a.
NOTE 4: This allows the DL packets of the new or modified QoS Flow to be transferred.
   If an additional AN Tunnel Info is returned by RAN in step 6, the SMF informs the UPF about this AN Tunnel Info for redundant transmission. In the case of redundant transmission with two I-UPFs, the SMF provides AN Tunnel Info to two I-UPFs. If CN Tunnel Info of two I-UPFs is allocated by the UPFs in step 2b, the SMF also provides the DL CN Tunnel Info of two I-UPFs to the UPF (PSA). If the QoS Monitoring is enabled for the QoS Flow, the SMF provides the N4 rules containing the QoS Monitoring policy generated according to the information received in step 1b to the UPF via the N4 Session Modification Request message. If port number and a Port Management Information Container have been received from PCF in Step 2 and the port number matches the port number of the NW-TT port for this PDU session, then SMF includes the Port Management Information Container in the N4 Session Modification Request. If the N4 Session Modification Request includes a Port Management Information Container, then UPF also includes a Port Management Information Container in the N4 Session Modification Response.
9. The UE acknowledges the PDU Session Modification Command by sending a NAS message (PDU Session ID, N1 SM container (PDU Session Modification Command Ack, [Port Management Information Container])) message.
10. The (R)AN forwards the NAS message to the AMF.
11. The AMF forwards the N1 SM container (PDU Session Modification Command Ack) and User Location Information received from the AN to the SMF via Nsmf_PDUSession_UpdateSMContext service operation. The SMF replies with a Nsmf_PDUSession_UpdateSMContext Response.
   If the SMF initiated modification is to delete QoS Flows (e.g. triggered by PCF) which do not include QoS Flow associated with the default QoS rule and the SMF does not receive response from the UE, the SMF marks that the status of those QoS Flows is to be synchronized with the UE.
   If interworking with TSN deployed in the transport network is supported, for any QoS Flow including a TSC Assistance Container, the SMF/CUC derives the merged stream requirements as described in Annex M of TS 23.501 [2]. If AN-TL and CN-TL are supported, the SMF/CUC uses the get-responses stored during the PDU Session Establishment procedure to derive the merged stream requirements. The SMF/CUC interacts with the CNC deployed in the transport network and provides the merged stream requirements in the Talker and Listener groups to the TN CNC. The TN CNC uses the merged stream requirements as input to select respective path(s) and calculate schedules in TN.
   Based on the results, the TN CNC provides a Status group that contains the merged end station communication-configuration back to the SMF/CUC.
12. The SMF may update N4 session of the UPF(s) that are involved by the PDU Session Modification by sending N4 Session Modification Request (N4 Session ID) message to the UPF. For a PDU Session of Ethernet PDU Session Type, the SMF may notify the UPF to add or remove Ethernet Packet Filter Set(s) and forwarding rule(s).
NOTE 5: The UPFs that are impacted in the PDU Session Modification procedure depends on the modified QoS parameters and on the deployment. For example in the case of the session AMBR of a PDU Session with an UL CL changes, only the UL CL is involved. This note also applies to the step 8.
13. If the SMF interacted with the PCF in step 1b or 2, the SMF notifies the PCF whether the PCC decision could be enforced or not by performing an SMF initiated SM Policy Association Modification procedure as defined in clause 4.16.5.1. If the trigger for 5GS Bridge/Router information available is armed and the SMF received a Port Management Information Container from either UE or UPF, then SMF provides the Port Management Information Container and the port number of the related port to the PCF in this step, as described in clause 5.28.3.2 of TS 23.501 [2]. If the trigger for 5GS Bridge/Router information available is armed and the SMF received the User Plane node Management Information Container from UPF, then the SMF provides the User Plane node Management Information Container to the PCF as described in clause 5.28.3.2 of TS 23.501 [2]. If trigger for Notification on BAT offset is armed and the SMF received BAT offset and/or Periodicity from the RAN, then the SMF provides the BAT offset and/or Periodicity to the PCF as described in clause 5.27.2.5 of TS 23.501 [2].
   SMF notifies any entity that has subscribed to User Location Information related with PDU Session change.
   If step 1b is triggered to perform Application Function influence on traffic routing by step 5 in clause 4.3.6.2, the SMF may reconfigure the User Plane of the PDU Session as described in step 6 in clause 4.3.6.2.
   If interworking with TSN deployed in the transport network is supported and if the Status group from TN CNC to SMF/CUC in step 11 includes InterfaceConfiguration, and if the AN-TL/CN-TL are supported, the SMF/CUC initiates a PDU Session Modification procedure as in step 1d.

### Next Change

### 4.9.1.2.2 Xn Based Inter NG-RAN Handover without User Plane Function Re-Allocation

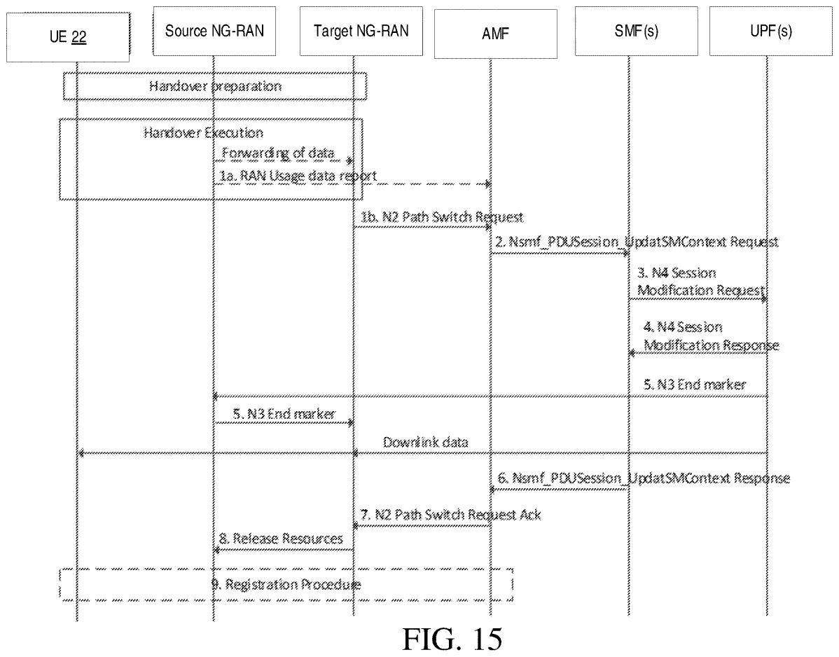

This procedure is used to hand over a UE from a source NG-RAN to target NG-RAN using Xn when the AMF is unchanged and the SMF decides to keep the existing UPF. The UPF referred in this clause 4.9.1.2.2 is the UPF which terminates N3 interface in the 5GC for non-roaming or local breakout roaming scenario, V-UPF which terminates N3 interface in 5GC for home routed roaming scenario. The SMF referred in this clause 4.9.1.2.2 is the V-SMF for home routed roaming scenario. The presence of IP connectivity between the Source UPF and Target NG-RAN is assumed.
The call flow is shown in FIG. 15 (also referred to as FIG. 4.9.1.2.2-1). FIG. 4.9.1.2.2-1: Xn based inter NG-RAN handover without UPF re-allocation
1a. If the PLMN has configured secondary RAT usage reporting, the source NG-RAN node during the handover execution phase may provide RAN usage data Report (N2 SM Information (Secondary RAT usage data), Handover Flag, Source to Target transparent container) to the AMF. The source NG-RAN node shall provide this only when the Target NG-RAN has confirmed handover over Xn interface. The Handover Flag indicates to the AMF that it should buffer the N2 SM Information containing the usage data report before forwarding it.
   If the source NG RAN and target NG RAN support RACS as defined in TS 23.501 [2], the source NG-RAN provides the UE's UE Radio Capability ID to the target NG-RAN. If the source NG-RAN has knowledge that the target NG-RAN might not have a local copy of the Radio Capability corresponding to the UE Radio Capability ID (i.e. because the source NG-RAN had itself to retrieve the UE's Radio Capability from the AMF) then the source NG-RAN may also send some or all of the UE's Radio Capability to the target NG-RAN (the size limit based on local configuration) in Xn signalling as defined in TS 38.423. In the case of inter-PLMN handover, when the source and target NG-RAN support RACS as defined in TS 23.501 [2] and the source NG-RAN determines based on local configuration that the target PLMN does not support the UE Radio Capability ID assigned by the source PLMN, then the source NG-RAN shall provide the UE radio access capabilities to the target NG-RAN and shall not send the UE Radio Capability ID. If, as permitted in TS 38.423 [72], the target NG-RAN during the handover preparation received the UE radio access capabilities but did not receive the UE Radio Capability ID, NG-RAN shall proceed with handover using the received UE radio access capabilities. If the target NG-RAN received both the UE radio access capabilities and the UE Radio Capability ID, then the target NG-RAN shall use any locally stored UE radio access capability information corresponding to the UE Radio Capability ID. If none are stored locally, the target NG-RAN may request the full UE radio access capability information from the core network. If the full UE radio access capability information is not promptly received from the core network, or the target NG-RAN chooses not to request them, then the target NG-RAN shall proceed with the UE radio access capabilities sent by the source NG-RAN. The target NG-RAN shall not use the UE radio access capability information received from the source NG-RAN for any other UE with the same the UE Radio Capability ID.
1b. Target NG-RAN to AMF: N2 Path Switch Request (List of PDU Sessions To Be Switched with N2 SM Information, List of PDU Sessions that failed to be established with the failure cause given in the N2 SM information element, UE Location Information, [established QoS Flows status (active/not active) for QoS monitoring configuration for congestion information/ECN marking for L4S]) The Target NG-RAN sends an N2 Path Switch Request message to an AMF to inform that the UE has moved to a new target cell and provides a List Of PDU Sessions To Be Switched. AN Tunnel Info for each PDU Session to be switched is included in the N2 SM Information.
   If redundant transmission is performed for one or more QoS Flows in the PDU Session, two AN Tunnel Info are provided by the Target NG-RAN and the Target NG-RAN indicates to the SMF one of the AN Tunnel Info is used as the redundancy tunnel of the PDU Session as described in clause 5.33.2.2 of TS 23.501 [2]. If only one AN Tunnel Info is provided by the Target NG-RAN for the PDU session, the SMF may release these QoS Flows by triggering PDU Session Modification procedure as specified in clause 4.3.3 after the handover procedure. The serving PLMN ID is included in the message. The target NG-RAN shall include the PDU Session in the PDU Sessions Rejected list:
      If none of the QoS Flows of a PDU Session are accepted by the Target NG-RAN; or
      If the corresponding network slice is not supported in the Target NG-RAN; or
      When the NG-RAN cannot set up user plane resources fulfilling the User Plane Security Enforcement with a value Required, the NG-RAN rejects the establishment of user plane resources for the PDU Session.
   If the NG-RAN cannot set up user plane resources fulfilling the User Plane Security Enforcement with a value Preferred, the NG-RAN establishes the user plane resources for the PDU session and shall include the PDU Session in the PDU Sessions Modified list.
   PDU Sessions Rejected contains an indication of whether the PDU session was rejected because User Plane Security Enforcement is not supported in the Target NG-RAN. Depending on the type of target cell, the Target NG-RAN includes appropriate information in this message.
   For the PDU Sessions to be switched to the Target NG-RAN, the N2 Path Switch Request message shall include the list of accepted QoS Flows. For each QoS Flow accepted with an Alternative QoS Profile as specified in TS 23.501 [2], the N2 SM Information shall include a reference to the fulfilled Alternative QoS Profile.
2. AMF to SMF: Nsmf_PDUSession_UpdateSMContext Request (N2 SM information received from T-RAN in step 1b and N2 SM Information from source NG-RAN (Secondary RAT usage data), UE Location Information, UE presence in LADN service area). The N2 SM Information here from source NG-RAN is the one buffered at step 1a when applicable.
   The AMF sends N2 SM information by invoking the Nsmf_PDUSession_UpdateSMContext request service operation for each PDU Session in the lists of PDU Sessions received in the N2 Path Switch Request. The Nsmf_PDUSession_UpdateSMContext Request contains either an indication that the PDU Session Is To Be Switched (together with information on the N3 addressing to use and on the transferred QoS flows) or an indication that the PDU Session is to be Rejected (together with a rejection cause).
   For a PDU Sessions to be switched to the Target NG-RAN, upon receipt of the Nsmf_PDUSession_UpdateSMContext request, the SMF determines whether the existing UPF can continue to serve the UE. If the existing UPF cannot continue to serve the UE, steps 3-11 of clause 4.9.1.2.3 or 4.9.1.2.4 are performed depending on whether the existing UPF is a PDU Session Anchor. Otherwise, the following steps 3 to 6 are performed if the existing UPFs can continue to serve the PDU Session.
   In the case that the AMF determines that the PDU Session is related to a LADN, then the AMF provides the “UE presence in LADN service area” to the SMF. If the AMF does not provide the “UE presence in LADN service area” indication and the SMF determines that the DNN corresponds to a LADN, then the SMF considers that the UE is OUT of the LADN service area. The SMF takes actions for the LADN PDU Session as defined in clause 5.6.5 of TS 23.501 [2] based on the “UE presence in LADN service area” indication.
   If a PDU Session is rejected by the Target NG-RAN with an indication that the PDU session was rejected because User Plane Security Enforcement is not supported in the Target NG-RAN and the User Plane Enforcement Policy indicates “Required” as described in clause 5.10.3 of TS 23.501 [2], the SMF triggers the release of this PDU Session. In all other cases of PDU Session rejection, the SMF can decide whether to release the PDU Session or to deactivate the UP connection of this PDU Session.
   If some of the QoS Flows of a PDU Session are not accepted by the Target NG-RAN, the SMF shall initiate the PDU Session Modification procedure to remove the non-accepted QoS Flows from the PDU Session(s) after the handover procedure is completed.
   For the PDU Session(s) that do not have active N3 UP connections before handover procedure, the SMF(s) keep the inactive status after handover procedure. If the UE moves into a non-Allowed Area, the AMF also notifies via Namf_EventExposure_Notify to each NF Consumer (e.g. SMFs of the established PDU Sessions) which has subscribed for UE reachability event, that the UE is only reachable for regulatory prioritized services. The SMF then deactivates the PDU session if this PDU Session is not for emergency service.
3. SMF to UPF: N4 Session Modification Request (AN Tunnel Info)
   For PDU Sessions that are modified by the Target NG-RAN, the SMF sends an N4 Session Modification Request message to the UPF. The SMF may notify the UPF that originated the Data Notification to discard downlink data for the PDU Sessions and/or to not provide further Data Notification messages.
   Depending on the network deployment, the CN Tunnel Info of UPF used for connection to Target NG-RAN and connection to Source NG-RAN may be different, e.g. due to Source and Target NG-RAN are in different IP domains. In this case the SMF may ask the UPF to allocate new CN Tunnel Info, providing the target Network Instance.
4. UPF to SMF: N4 Session Modification Response (CN Tunnel Info) For the PDU Sessions that are switched, the UPF returns an N4 Session Modification Response message to the SMF after requested PDU Sessions are switched. Tunnel identifiers for UL traffic are included only for PDU Sessions whose user plane resources are not being released and was requested by the SMF. If redundant transmission is performed for one or more QoS Flows of a PDU Session and different CN Tunnel Info were requested by the SMF, the UPF allocates two different CN Tunnel Info and indicates the SMF that one CN Tunnel Info is used as the redundancy tunnel of the PDU session as described in clause 5.33.2.2 of TS 23.501 [2]. For the PDU Sessions that are deactivated, the UPF returns an N4 Session Modification Response message to the SMF after the N3 (R)AN tunnel information is released.
5. In order to assist the reordering function in the Target NG-RAN, the UPF (as specified in clause 5.8.2.9 of TS 23.501 [2]) sends one or more “end marker” packets for each N3 tunnel on the old path immediately after switching the path. The UPF starts sending downlink packets to the Target NG-RAN.
6. SMF to AMF: Nsmf_PDUSession_UpdateSMContext Response (N2 SM information)
   The SMF sends an Nsmf_PDUSession_UpdateSMContext response (N2 SM Information (CN Tunnel Info, updated CN PDB for the accepted QoS Flows, Updated TSCAIs for the accepted QoS Flows)) to the AMF for PDU Sessions which have been switched successfully. The CN Tunnel Info of UPF send to AMF is used to setup N3 tunnel. If redundant transmission is performed for one or more QoS Flows of a PDU Session, two CN Tunnel Info are sent and the SMF indicates to the Target NG-RAN one of the CN Tunnel Info is used as the redundancy tunnel of the PDU Session as described in clause 5.33.2.2 of TS 23.501 [2]. The SMF sends an Nsmf_PDUSession_UpdateSMContext response without including the CN Tunnel Info to the AMF for the PDU Sessions for which user plane resources are deactivated or released and then the SMF releases the PDU Session(s) which is to be released using a separate procedure as defined in clause 4.3.4. For each accepted GBR QoS Flow of Delay-critical resource type, the dynamic CN PDB and TSCAI may be updated and sent to the Target NG-RAN by the SMF. The SMF may update the CN PDB and TSCAI in the response or using a separate PDU Session Modification procedure, based on local configuration.
   If the Source NG-RAN does not support Alternative QoS Profiles (see TS 23.501 [2]) and the Target NG-RAN supports them, the SMF sends the Alternative QoS Profiles (see TS 23.501 [2]) to the Target NG-RAN on a per QoS Flow basis, if available.
NOTE: Step 6 can occur any time after receipt of N4 Session Modification Response at the SMF.
7. AMF to NG-RAN: N2 Path Switch Request Ack (N2 SM Information, Failed PDU Sessions, UE Radio Capability ID).
   Once the Nsmf_PDUSession_UpdateSMContext response is received from all the SMFs, the AMF aggregates received CN Tunnel Info and sends this aggregated information as a part of N2 SM Information along with the Failed PDU Sessions in N2 Path Switch Request Ack to the Target NG-RAN. If none of the requested PDU Sessions have been switched successfully, the AMF shall send an N2 Path Switch Request Failure message to the Target NG-RAN.
   If the UE Radio Capability ID is included in the N2 Path Switch Request Ack message, when there is no corresponding UE radio capabilities set for UE Radio Capability ID at the target NR-RAN, the target NG-RAN shall request the AMF to provide the UE radio capabilities set corresponding to UE Radio Capability ID to the target NG-RAN.
8. By sending a Release Resources message to the Source NG-RAN, the Target NG-RAN confirms success of the handover. It then triggers the release of resources with the Source NG-RAN.
9. [Conditional] The UE may initiate Mobility Registration Update procedure if one of the triggers of registration procedure applies as described in clause 4.2.2.2.2. In this case, only steps 1, 2, 3, 17 and 21 in clause 4.2.2.2.2 are performed. For the mobility related events as described in clause 4.15.4, the AMF invokes the Namf_EventExposure_Notify service operation.
   Upon reception of the Namf_EventExposure_Notify with an indication that UE is reachable only for regulatory prioritized service, the SMF deactivates the PDU Session if the service of the PDU Session is not regulatory prioritized. For home routed roaming case, the V-SMF triggers the deactivation of the PDU Session, in addition, the H-SMF refrains from sending downlink signalling if the signalling is not related to regulatory prioritized service upon receiving the notification.

### Next Change

### 4.9.1.3 Inter NG-RAN Node N2 Based Handover

### 4.9.1.3.1 General

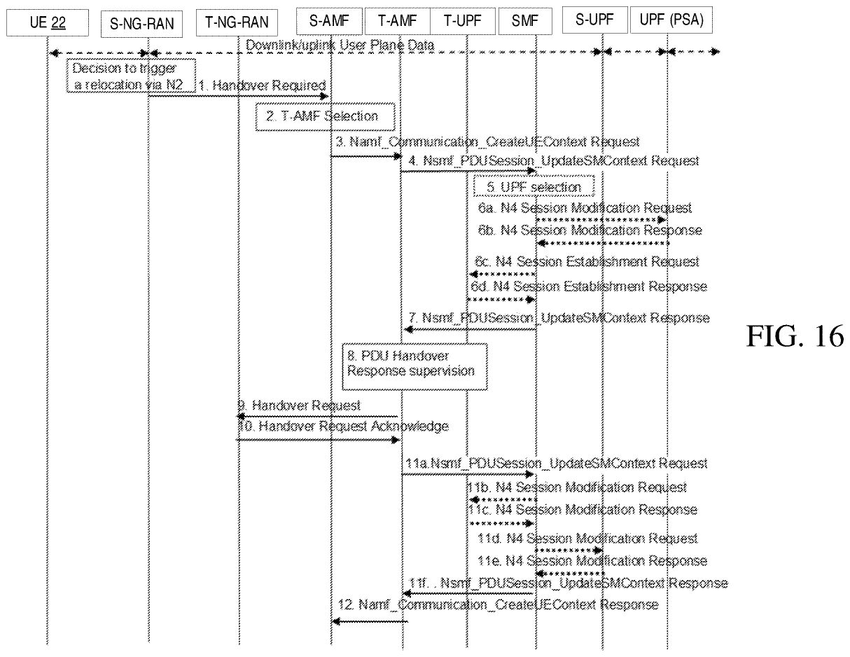

Clause 4.9.1.3 includes details regarding the inter NG-RAN node N2 based handover without Xn interface.
The source NG-RAN decides to initiate an N2-based handover to the target NG-RAN. This can be triggered, for example, due to new radio conditions or load balancing, if there is no Xn connectivity to the target NG-RAN, an error indication from the target NG-RAN after an unsuccessful Xn-based handover (i.e. no IP connectivity between T-RAN and S-UPF), or based on dynamic information learnt by the S-RAN.
The availability of a direct forwarding path is determined in the source NG-RAN and indicated to the SMFs. If IP connectivity is available between the source and target NG-RAN and security association(s) is in place between them, a direct forwarding path is available.
If a direct forwarding path is not available, indirect forwarding may be used. The SMFs use the indication from the source NG-RAN to determine whether to apply indirect forwarding.
If both source NG-RAN and source AMF support DAPS the source NG-RAN may decide that some of the DRBs are subject for DAPS handover as defined in TS 38.300 [9]; in this case, the source NG-RAN provides the DAPS information indicating the request concerns a DAPS handover for the DRB as part of the Source to Target (NG-RAN) Transparent Container. If the target NG-RAN accepts that the request concerns DAPS handover and both Target NG-RAN and Target AMF support DAPS, the DAPS handover will be performed and target NG-RAN provides DAPS response information as part of the Target to Source (NG-RAN) Transparent Container.
In the case of handover to a shared network, the source NG-RAN determines a PLMN (or PLMN ID and NID, see clause 5.30 of TS 23.501 [2]) to be used in the target network as specified by TS 23.501 [2]. The source NG-RAN shall indicate the selected PLMN ID to be used in the target network to the AMF as part of the Tracking Area sent, or the selected SNPN ID to be used in the target network to the AMF, in the HO Required message. If the AMF generates the N2 downlink signalling during the ongoing handover and receives a rejection to a N2 interface procedure (e.g. DL NAS message transfer; Location reporting control; etc.) from the NG-RAN with an indication that an Inter NG-RAN node handover procedure is in progress, the AMF may reattempt the same N2 interface procedure either when the handover is complete or the handover is deemed to have failed if the AMF is still the serving AMF, when possible. If the Inter NG-RAN node handover changes the serving AMF, the source AMF shall terminate any other ongoing N2 interface procedures except the handover procedure.
In order to minimize the number of procedures rejected by NG-RAN, the AMF should pause non-handover related N2 interface procedures (e.g. DL NAS message transfer, Location Report Control, etc.) while a handover is ongoing (i.e. from the time that a Handover Required has been received until either the Handover procedure has succeeded (Handover Notify) or failed (Handover Failure)) and continue them once the Handover procedure has completed if the AMF is still the serving AMF.
If during the handover procedure the AMF detects that the AMF needs be changed, the AMF shall reject any SMF initiated N2 request received since handover procedure started and shall include an indication that the request has been temporarily rejected due to handover procedure in progress.
Upon reception for an SMF initiated N1 and/or N2 request(s) with an indication either from the NG-RAN (via N2 SM Info) or AMF that the request has been temporarily rejected due to handover procedure in progress, the SMF starts a locally configured guard timer. The SMF should hold any signalling messages targeted towards AMF for a given UE during the handover preparation phase unless it detects that the handover execution is completed or handover has failed/cancelled. The SMF may re-attempt, up to a pre-configured number of times, when either it detects that the handover is completed or has failed using message reception or at expiry of the guard timer.
In the case of home routed roaming scenario, the SMF in the Inter NG-RAN node N2 based handover procedure (FIG. 4.9.1.3.2-1 and FIG. 4.9.1.3.3-1) interacting with the S-UPF, T-UPF, S-AMF and T-AMF is the V-SMF and the SMF (FIG. 16 (also referred to as FIG. 4.9.1.3.3-1)) interacting with the UPF (PSA) is the H-SMF. FIG. 4.9.1.3.2-1: Inter NG-RAN node N2 based handover, Preparation phase
1. S-RAN to S-AMF: Handover Required (Target ID, Source to Target transparent container, SM N2 info list, PDU Session IDs, intra system handover indication).
NOTE 1: When applicable the message includes the selected NID, see TS 38.413 for the IE that includes the selected NID. The T-AMF, ensures that the selected NID is forwarded to SMF.
   Source to Target transparent container includes NG-RAN information created by S-RAN to be used by T-RAN and is transparent to 5GC. It also contains for each PDU session the corresponding QoS flows/DRBs information subject to data forwarding. It may also contain DAPS Information if DAPS handover is supported by S-RAN and S-AMF and DAPS handover is requested for one or more DRBs as described in TS 38.300 [9].
   All PDU Sessions handled by S-RAN (i.e. all existing PDU Sessions with active UP connections) shall be included in the Handover Required message, indicating which of those PDU Session(s) are requested by S-RAN to handover. The SM N2 info includes Direct Forwarding Path Availability if direct data forwarding is available.
   Direct Forwarding Path Availability indicates whether direct forwarding is available from the S-RAN to the T-RAN. This indication from S-RAN can be based on e.g. the presence of IP connectivity and security association(s) between the S-RAN and the T-RAN.
   If the source NG RAN and target NG RAN support RACS as defined in TS 23.501 [2], the Source to Target transparent container need not carry the UE radio access capabilities (instead the UE Radio Capability ID is supplied from the CN to the T-RAN). However, if the source NG-RAN has knowledge that the target NG-RAN might not have a local copy of the Radio Capability corresponding to the UE Radio Capability ID (i.e. because the source NG-RAN had itself to retrieve the UE's Radio Capability from the AMF) then the source NG-RAN may also send some (or all) of the UE's Radio Capability to the target NG-RAN (the size limit based on local configuration). In the case of inter-PLMN handover, when the source and target NG-RAN support RACS as defined in TS 23.501 [2] and the source NG-RAN determines based on local configuration that the target PLMN does not support the UE Radio Capability ID assigned by the source PLMN, then the source NG-RAN includes the UE radio access capabilities in the Source to Target transparent container.
2. T-AMF Selection: When the S-AMF can't serve the UE anymore, the S-AMF selects the T-AMF as described in clause 6.3.5 on “AMF Selection Function” in TS 23.501 [2].
3. [Conditional] S-AMF to T-AMF: Namf_Communication_CreateUEContext Request (N2 Information (Target ID, Source to Target transparent container, SM N2 information list, PDU Session IDs), UE context information (SUPI, Service area restriction, Allowed NSSAI for each Access Type if available, Tracing Requirements, LTE M Indication, the list of PDU Session IDs along with the corresponding SMF information and the corresponding S-NSSAI(s), PCF ID(s), DNN, UE Radio Capability ID and UE Radio Capability Information, N2 Notify URI). If the subscription information includes Tracing Requirements, the old AMF provides the target AMF with Tracing Requirements.
   If the old AMF was a consumer of UE related NWDAF services, the old AMF includes information about active analytics subscriptions, i.e. the Subscription Correlation ID(s), NWDAF identifier(s) (i.e. Instance ID or Set ID), Analytics ID(s) and associated Analytics specific data in the Namf_Communication_UEContextTransfer request. Usage of the analytics information by the new AMF is specified in TS 23.288 [50].
   In inter PLMN handover case, UE context information includes HPLMN S-NSSAIs corresponding to the Allowed NSSAI for each Access Type, without Allowed NSSAI of source PLMN. The target AMF may determine the Allowed NSSAI based on the HPLMN S-NSSAIs received in step 3, or else the target AMF queries the NSSF by invoking Nnssf_NSSelection_Get service operation with the HPLMN S-NSSAIs and PLMN ID of SUPI. Based on the query result returned from the NSSF, the target AMF determines whether the AMF re-allocation need be triggered and if needed reselects another target AMF. In this case the target AMF selected by the S-AMF is the Initial AMF. And another reselected target AMF is the final target AMF (i.e. T-AMF). The S-AMF initiates Handover resource allocation procedure by invoking the Namf_Communication_CreateUEContext service operation towards the target AMF. When the S-AMF can still serve the UE, this step and step 12 are not needed.
   If target AMF re-allocation is needed, e.g. due to the inter PLMN handover, the initial AMF invokes Namf_Communication_CreateUEContext request (SUPI, Target 5GAN Node ID, Source to Target Transparent Container, 5GS MM Context, PDU Session ID and its associated S-NSSAI of the VPLMN value for each PDU Session, the corresponding S-NSSAI of HPLMN value for home routed PDU Session(s), Allowed NSSAI, N2 Notify URI) to the selected final target AMF. The N2 Notify URI is the N2 Notify URI of the source AMF, which is used by the T-AMF to send N2 handover notify to the S-AMF. If the information about active analytics subscriptions are received from S-AMF, it also includes them in the Namf_Communication_CreateUEContext request.
   If Service area restrictions are available in the S-AMF, they may be forwarded to the T-AMF as described in clause 5.3.4.1.2 in TS 23.501 [2].
   If both Home and Visited PCF ID(s) are provided by the S-AMF, the T-AMF contacts the (V-)PCF identified by the (V-)PCF ID. If the (V-)PCF identified by the (V-)PCF ID is not used or there are no PCF ID(s) received from the S-AMF, the T-AMF may select the PCF(s) as described in clause 6.3.7.1 of TS 23.501 [2] and according to the V-NRF to H-NRF interaction described in clause 4.3.2.2.3.3. The T-AMF informs the S-AMF that the PCF ID is not used, as defined in step 12 and then the S-AMF terminates the AM Policy Association with the PCF identified by the PCF ID.
4. [Conditional] T-AMF to SMF: Nsmf_PDUSession_UpdateSMContext (PDU Session ID, Target ID, T-AMF ID, N2 SM Information).
   For each PDU Session indicated by S-RAN, the AMF invokes the Nsmf_PDUSession_UpdateSMContext Request to the associated SMF. However, if the S-NSSAI associated with PDU Session is not available in the T-AMF, the T-AMF does not invoke Nsmf_PDUSession_UpdateSMContext for this PDU Session. PDU Session ID indicates a PDU Session candidate for N2 Handover. Target ID corresponds to Target ID provided by S-RAN in step 1. SM N2 Info includes the Direct Forwarding Path Availability if the direct data forwarding is available between the S-RAN and the T-RAN and has been inserted by the S-RAN.
   If the (T-)AMF detects that the UE moves into a non-allowed area based on Service area restrictions, the (T-)AMF notifies each NF consumer which has subscribed for UE reachability event (e.g. SMFs corresponding to the list of PDU Sessions received in UE Context from (S-)AMF via Namf_EventExposure_Notify that the UE is only reachable for regulatory prioritized services.
5. [Conditional] Based on the Target ID, SMF checks if N2 Handover for the indicated PDU Session can be accepted. The SMF checks also the UPF Selection Criteria according to clause 6.3.3 of TS 23.501 [2]. If UE has moved out of the service area of the UPF connecting to NG-RAN, SMF selects a new intermediate UPF. If redundant transmission is performed for one or more QoS Flows of the PDU Session, the SMF selects two new Intermediate UPFs to support the redundant transmission based on two N3 and N9 tunnels between the T-RAN and the UPF (PSA) as described in clause 5.33.2.2 of TS 23.501 [2]. In this case, step 6c and 6d are performed between SMF and each T-UPF.
   In the case that the SMF fails to find a suitable I-UPF, the SMF decides to (based on local policies) either:
      trigger re-establishment of PDU Session. After handover procedure, SMF sends N1 message to the UE via the AMF by invoking
   Namf_Communication_N1N2MessageTransfer containing the cause indicating PDU Session re-establishment is required for the UE; or
      keep the PDU Session, but reject the activation request of User Plane connection for the PDU Session and inform the AMF about it; or
      release the PDU Session after handover procedure.
6a. [Conditional] SMF to UPF (PSA): N4 Session Modification Request.
   If the SMF selects a new UPF to act as intermediate UPF for the PDU Session and the different CN Tunnel Info need be used, the SMF sends N4 Session Modification Request message to UPF (PSA). The SMF provides the CN Tunnel Info (on N9) if the CN Tunnel Info is allocated by the SMF and UL Packet detection rules associate the CN Tunnel Info (on N9) to be installed on the UPF (PSA).
   If redundant transmission is performed for one or more QoS Flows of the PDU Session and the different CN Tunnel Info need be used, the SMF provides two CN Tunnel Info (on N9) to the UPF (PSA) if the CN Tunnel Info is allocated by the SMF and indicates to the UPF (PSA) one of the CN Tunnel Info is used as redundancy tunnel of the PDU Session.
6b. [Conditional] UPF (PSA) to SMF: N4 Session Modification Response.
   The UPF (PSA) sends an N4 Session Modification Response message to the SMF. If the UPF (PSA) allocates CN Tunnel Info (on N9) of UPF (PSA), it provides CN Tunnel Info (on N9) to the SMF. If redundant transmission is performed for one or more QoS Flows of the PDU Session, the UPF (PSA) provides two CN Tunnel Info (on N9) of UPF (PSA) to the SMF and indicates the SMF that one CN Tunnel Info is used as redundancy tunnel of the PDU Session as described in in clause 5.33.2.2 of TS 23.501 [2]. The UPF (PSA) associate the CN Tunnel Info (on N9) with UL Packet detection rules provided by the SMF.
6c. [Conditional] SMF to T-UPF (intermediate): N4 Session Establishment Request. If the SMF selects a new intermediate UPF, i.e. the target UPF (T-UPF), for the PDU Session and if CN Tunnel Info is allocated by the T-UPF, an N4 Session Establishment Request message is sent to the T-UPF, providing Packet detection, enforcement and reporting rules to be installed on the T-UPF. The CN Tunnel Info (on N9) of UPF (PSA) for this PDU Session, which is used to setup N9 tunnel, is also provided to the T-UPF.
6d. T-UPF (intermediate) to SMF: N4 Session Establishment Response.
   The T-UPF sends an N4 Session Establishment Response message to the SMF with DL CN Tunnel Info and UL CN Tunnel Info (i.e. N3 tunnel info). The SMF starts a timer to release the resource of S-UPF, which is to be used in step 13a of the Execution Phase.
7. SMF to T-AMF: Nsmf_PDUSession_UpdateSMContext Response (PDU Session ID, N2 SM Information, Reason for non-acceptance).
   If N2 handover for the PDU Session is accepted, the SMF includes in the Nsmf_PDUSession_UpdateSMContext response the N2 SM Information containing the N3 UP address and the UL CN Tunnel ID of the UPF, the QoS parameters, TSCAI and the User Plane Security Enforcement information for the Target NG-RAN. If redundant transmission is performed for one or more QoS Flows of the PDU Session, two UL CN Tunnel Info are included in the N2 SM Information. If the N2 SM information received at step 4 does not include the Direct Forwarding Path Availability and the SMF knows that there is no indirect data forwarding connectivity between source and target, the N2 SM Information includes a Data forwarding not possible indication. If the SMF indicated that Direct Forwarding is available in step 4, the SMF should further include a “Direct Forwarding Path Availability” indication in the N2 SM information container. The SMF sends the Alternative QoS Profiles, Qos monitoring configuration for congestion information or ECN marking for L4S indicator for QoS Flow (see TS 23.501 [2]) to the Target NG-RAN on a per QoS Flow basis, if available.
   If N2 handover for the PDU Session is not accepted as described in step 5, the SMF does not include an N2 SM Information regarding the PDU Session to avoid establishment of radio resources at the target NG-RAN. Instead of that, the SMF provides a reason for non-acceptance. If the SMF has received notification from (T-)AMF that the UE is only reachable for regulatory prioritized services, the SMF does not include any N2 SM info regarding the PDU Session for non-regulatory prioritized services to avoid establishment of radio resources at the target NG-RAN. If the SMF receives notification from (T-)AMF that UE is only reachable for regulatory prioritized service after this step via Namf_EventExposure_Notify, the SMF deactivates the PDU Session after handover procedure finish if the PDU Session is not for regulatory prioritized services.
8. AMF supervises the Nsmf_PDUSession_UpdateSMContext Response messages from the involved SMFs. The lowest value of the Max delay indications for the PDU Sessions that are candidates for handover gives the maximum time AMF may wait for Nsmf_PDUSession_UpdateSMContext Response messages before continuing with the N2 Handover procedure. At expiry of the maximum wait time or when all Nsmf_PDUSession_UpdateSMContext Response messages are received, AMF continues with the N2 Handover procedure (Handover Request message in step 9).
NOTE 2: The delay value for each PDU Session is locally configured in the AMF and implementation specific.
9. T-AMF to T-RAN: Handover Request (Source to Target transparent container, N2 MM Information, N2 SM Information list, Tracing Requirements, UE Radio Capability ID). If the subscription information includes Tracing Requirements, the target AMF provides the target RAN with Tracing Requirements in the Handover Request.
   T-AMF determines T-RAN based on Target ID. T-AMF may allocate a 5G-GUTI valid for the UE in the AMF and target TAI.
   Source to Target transparent container is forwarded as received from S-RAN. N2 MM Information includes e.g. security information and Mobility Restriction List if available in the T-AMF.
   N2 SM Information list includes N2 SM Information received from SMFs for the T-RAN in the Nsmf_PDUSession_UpdateSMContext Response messages received within allowed max delay supervised by the T-AMF mentioned in step 8. T-AMF provides the UE Radio Capability ID to T-RAN if RACS is supported. If the UE Radio Capability ID is included in the Handover Request message and no UE radio access capabilities are provided in the Source to Target transparent container, when there is no corresponding UE radio capabilities set for UE Radio Capability ID at T-RAN, T-RAN shall request the T-AMF to provide the UE radio capabilities set corresponding to UE Radio Capability ID to the T-RAN. If the Source to Target transparent container contains the UE radio access capabilities and the T-RAN did not receive the UE Radio Capability ID from the T-AMF, NG-RAN shall proceed with handover using the received UE radio access capabilities. If the T-RAN received both the UE radio access capabilities and the UE Radio Capability ID, then the T-RAN shall use any locally stored UE radio access capability information corresponding to the UE Radio Capability ID. If none are stored locally, the T-RAN may request the full UE radio access capability information from the core network. If the full UE radio access capability information is not promptly received from the core network, or the T-RAN chooses not to request them, then the T-RAN shall proceed with the UE radio access capabilities sent by the source RAN node. The T-RAN shall not use the UE radio access capability information received from the source RAN node for any other UE with the same the UE Radio Capability ID.
10. T-RAN to T-AMF: Handover Request Acknowledge (Target to Source transparent container, List of PDU Sessions to Hand-over with N2 SM information, List of PDU Sessions that failed to be established with the failure cause given in the N2 SM information element).
   Target to Source transparent container includes a UE container with an access stratum part and a NAS part. The UE container is sent transparently via T-AMF, S-AMF and S-RAN to the UE. If DAPS handover is supported by the T-RAN and T-AMF and the DAPS Information for one or more DRBs had been received in the Source to Target Transparent Container, the T-RAN includes the DAPS Response information in the Target to Source Transparent Container as described in TS 38.300 [9].
   T-RAN creates List Of PDU Sessions failed to be setup and reason for failure (e.g. T-RAN decision, S-NSSAI is not available, unable to fulfil User Plane Security Enforcement) based on T-RAN determination. The information is provided to the S-RAN.
   The N2 SM information in the List Of PDU Sessions to Hand-over, contains per each PDU Session ID T-RAN N3 addressing information i.e. N3 UP address and Tunnel ID of T-RAN for the PDU Session.
   If redundant transmission is performed for one or more QoS Flows of the PDU Session, the T-RAN provides two AN Tunnel Info for the PDU Session in the N2 SM information. The T-RAN indicates to the SMF one of the AN Tunnel Info is used as the redundancy tunnel of the PDU session as described in clause 5.33.2.2 of TS 23.501 [2]. If only one AN Tunnel Info is provided by the Target NG-RAN for the PDU session, the SMF may release these QoS Flows by triggering PDU Session Modification procedure as specified in clause 4.3.3 after the handover procedure. The N2 SM information may also include:
      an Indication whether UP integrity protection is performed or not on the PDU Session based on User Plane Security Enforcement information received in N2 SM information in step 9.
      if the PDU Session has at least one QoS Flow subject for data forwarding, N3 UP address and Tunnel ID of T-RAN for receiving forwarded data. The T-RAN provides data forwarding addresses for each data forwarding tunnel which it decided to setup.
      For each QoS Flow accepted with an Alternative QoS Profile (see TS 23.501 [2]), the Target NG-RAN shall include a reference to the fulfilled Alternative QoS Profile.
      For each accepted QoS Flow, QoS Flows status (active/not active) for QoS monitoring configuration for congestion information/ECN marking for L4S.
11a. AMF to SMF: Nsmf_PDUSession_UpdateSMContext Request (PDU Session ID, N2 SM response received from T-RAN in step 10).
   For each N2 SM response received from the T-RAN (N2 SM information included in Handover Request Acknowledge), AMF sends the received N2 SM response to the SMF indicated by the respective PDU Session ID.
   If no new T-UPF is selected, SMF stores the N3 tunnel info of T-RAN from the N2 SM response if N2 handover is accepted by T-RAN.
   The SMF/UPF allocates the N3 UP address and Tunnel IDs for indirect data forwarding corresponding to the data forwarding tunnel endpoints established by T-RAN.
   If a PDU Session is indicated as a rejected PDU Session by the Target NG-RAN with an indication that the PDU session was rejected because User Plane Security Enforcement is not supported in the Target NG-RAN and the User Plane Enforcement Policy indicates “Required” as described in clause 5.10.3 of TS 23.501 [2], the SMF triggers the release of this PDU Session. In all other cases of PDU Session rejection, the SMF can decide whether to release the PDU Session (possibly triggering the re-establishment of the PDU Session as described in step 5) or to deactivate the UP connection of this PDU Session.
   If some of the QoS Flows of a PDU Session are not accepted by the Target NG-RAN, the SMF shall initiate the PDU Session Modification procedure to remove the non-accepted QoS Flows from the PDU Session(s) after the handover procedure is completed.
11b. [Conditional] SMF to T-UPF: N4 Session Modification Request (T-RAN SM N3 forwarding Information list, indication to allocate DL forwarding tunnel(s) for indirect forwarding)
   If the SMF selected a T-UPF in step 6a, the SMF updates the T-UPF by providing the T-RAN SM N3 forwarding information list by sending a N4 Session Modification Request to the T-UPF.
   If indirect forwarding applies based on indication from the S-RAN and the UPF is re-allocated and if the SMF decides to setup the indirect forwarding tunnel on the same T-UPF, the SMF also requests in the N4 Session Modification Request message to the T-UPF, to allocate DL forwarding tunnel(s) for indirect forwarding.
   Indirect forwarding may be performed via a UPF which is different from the T-UPF, in which case the SMF selects a T-UPF for indirect forwarding.
11c. [Conditional] T-UPF to SMF: N4 Session Modification Response (T-UPF SM N3 forwarding Information list).
   The T-UPF allocates Tunnel Info and returns an N4 Session Modification Response message to the SMF.
   The T-UPF SM N3 forwarding info list includes T-UPF N3 address, T-UPF N3 Tunnel identifiers for forwarding data
11d. [Conditional] SMF to S-UPF: N4 Session Modification Request (T-RAN SM N3 forwarding Information list or T-UPF SM N3 forwarding Information list, indication to allocate DL forwarding tunnel(s) for indirect forwarding).
   If the UPF is re-allocated, this message includes the T-UPF SM N3 forwarding info list. If the UPF is not re-allocated, this message includes the T-RAN SM N3 forwarding info list.
   If indirect forwarding applies based on indication from NG-RAN and UPF allocates tunnel identities, the SMF indicates in the N4 Session Modification Request message to the S-UPF to allocate DL forwarding tunnel(s) for indirect forwarding.
   Indirect forwarding may be performed via a UPF which is different from the S-UPF.
11e. [Conditional] S-UPF to SMF: N4 Session Modification Response (S-UPF SM N3 forwarding Information list).
   The S-UPF allocates Tunnel Info and returns an N4 Session establishment Response message to the SMF.
   The S-UPF SM N3 forwarding Information list includes S-UPF N3 address, S-UPF N3 Tunnel identifiers for DL data forwarding.
11f. SMF to T-AMF: Nsmf_PDUSession_UpdateSMContext Response (N2 SM Information).
   The SMF sends an Nsmf_PDUSession_UpdateSMContext Response message per PDU Session to T-AMF.
   The SMF creates an N2 SM information containing the DL forwarding Tunnel Info to be sent to the S-RAN by the AMF. The SMF includes this information in the Nsmf_PDUSession_UpdateSMContext response. The DL forwarding Tunnel Info can be one of the following information:
      If direct forwarding applies, then the SMF includes the T-RAN N3 forwarding information the SMF received in step 11a.
      If the indirect forwarding tunnel is setup in step 11b or 11d, then the SMF includes the T-UPF or S-UPF DL forwarding information containing the N3 UP address and the DL Tunnel ID of the UPF.
12. [Conditional] T-AMF to S-AMF: Namf_Communication_CreateUEContext Response (N2 information necessary for S-AMF to send Handover Command to S-RAN including Target to Source transparent container, PDU Sessions failed to be setup list, N2 SM information (N3 DL forwarding Information, PCF ID), [Target AMF ID]). T-AMF supervises the Nsmf_PDUSession_UpdateSMContext Response message from the involved SMFs. At expiry of the maximum wait time or when all Nsmf_PDUSession_UpdateSMContext Response messages are received, T-AMF sends the Namf_Communication_CreateUEContext Response to the S-AMF.
   The PDU Sessions failed to be setup list includes the List Of PDU Sessions failed to be setup received from target RAN in step 10 and the Non-accepted PDU session List generated by the T-AMF.
   Non-accepted PDU Session List includes following PDU Session(s) with proper cause value:
      Non-accepted PDU Session(s) by the SMF(s);
      Non-accepted PDU Session(s) by the AMF due to no response from the SMF within maximum wait time; and
      Non-accepted PDU Session(s) by the AMF due to non-available S-NSSAI in the T-AMF, which is decided at step 4.
   The Target to Source transport container is received from the T-RAN. The N2 SM Information is received from the SMF in step 11f.
   If target AMF re-allocation is executed in step 3, the selected final target AMF, i.e. T-AMF, invoke Namf_Communication_CreateUEContext Response (Cause, N2 information necessary for S-AMF to send Handover Command to S-RAN including Target to Source transparent container, N2 SM information (PDU Sessions failed to setup list, N3 DL forwarding Information), PCF ID, PCF reselected indication, target AMF ID) to the initial AMF. The cause indicates whether the Relocate UE Context (hand-Over) succeeded or failed. If the target NG RAN has rejected the Handover Request in step 10, the cause indicates a failure due to RAN rejection. The target AMF ID is used for S-AMF to transfer RAN Status to T-AMF directly. Based on the receiving Namf_Communication_CreateUEContext Response, the initial AMF invokes Namf_Communication_CreateUEContext Response towards S-AMF.

### 4.9.1.3.3 Execution Phase

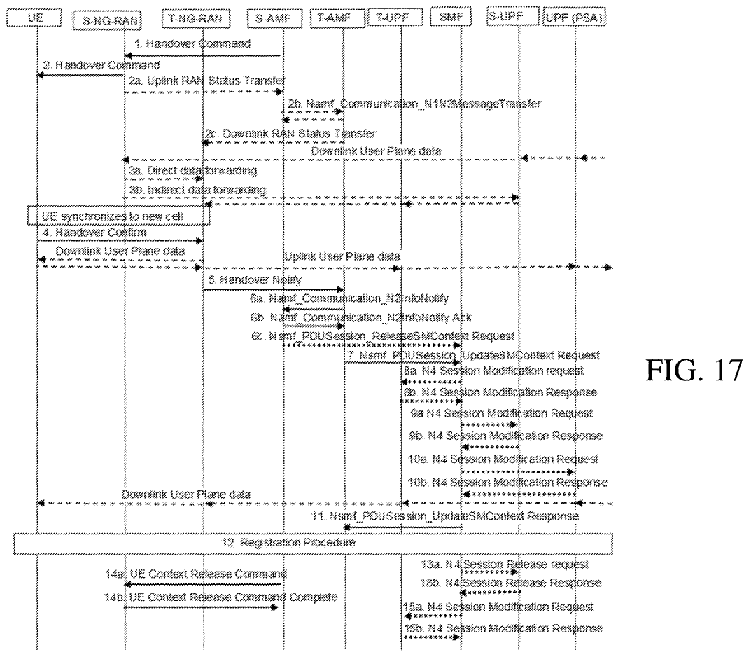

FIG. 17 (also referred to as FIG. 4.9.1.3.3-1): inter NG-RAN node N2 based handover, execution phase
NOTE 1: Registration of serving AMF with the UDM is not shown in the figure for brevity.
1. S-AMF to S-RAN: Handover Command (Target to Source transparent container, List Of PDU Sessions to be handed-over with N2 SM information containing information received from T-RAN during the handover preparation phase, List Of PDU Sessions failed to be setup).
   Target to Source transparent container is forwarded as received from S-AMF. If DAPS Response information for one or more DRBs is received by S-RAN and indicates that DAPS handover is accepted, the execution phase for DAPS handover procedure as described in clause 4.9.1.3.3a is performed.
   The SM forwarding info list includes T-RAN SM N3 forwarding info list for direct forwarding or S-UPF SM N3 forwarding info list for indirect data forwarding S-RAN uses the PDU Sessions failed to be setup list and the indicated reason for failure to decide whether to proceed with the N2 Handover procedure.
   If the S-RAN supports and receives a reference to an Alternative QoS Profile for an accepted QoS Flow, it shall take it into account for deciding whether or not to proceed with the N2 Handover procedure (see TS 23.501 [2]).
2. S-RAN to UE: Handover Command (UE container).
   UE container is a UE part of the Target to Source transparent container which is sent transparently from T-RAN via AMF to S-RAN and is provided to the UE by the S-RAN.
2a0. If the PLMN has configured secondary RAT usage reporting and the source NG-RAN has Secondary RAT usage data to report, the source NG-RAN node may provide RAN usage data report message (N2 SM Information (Secondary RAT usage data), Handover Flag) as in clause 4.21 to the AMF. The Handover Flag indicates to the AMF that it should buffer the N2 SM Information containing the usage data report before forwarding it.
NOTE 2: This step is not shown in this figure but the secondary RAT usage data reporting procedure is shown in FIGS. 4.21-1 in clause 4.21.
2a.-2c. The S-RAN sends the Uplink RAN Status Transfer message to the S-AMF, as specified in TS 36.300 and TS 38.300 [9]. The S-RAN may omit sending this message if none of the radio bearers of the UE shall be treated with PDCP status preservation.
   If there is an AMF relocation, the S-AMF sends this information to the T-AMF via the Namf_Communication_N1N2MessageTransfer service operation and the T-AMF acknowledges. The S-AMF or, if the AMF is relocated, the T-AMF, sends the information to the T-RAN via the Downlink RAN Status Transfer message, as specified in TS 36.300 and TS 38.300 [9].
   For Inter PLMN handover, if the target AMF has been relocated in Preparation phase, e.g. due to the inter PLMN handover, the S-AMF send this information to the indicated T-AMF, which is derived from the target AMF ID received in step 12 of clause 4.9.1.3.2.
3. Uplink packets are sent from T-RAN to T-UPF and UPF (PSA). Downlink packets are sent from UPF (PSA) to S-RAN via S-UPF. The S-RAN should start forwarding of downlink data from the S-RAN towards the T-RAN for QoS Flows or DRBs subject to data forwarding. This may be either direct (step 3a) or indirect forwarding (step 3b).
4. UE to T-RAN: Handover Confirm.
   After the UE has successfully synchronized to the target cell, it sends a Handover Confirm message to the T-RAN. Handover is by this message considered as successful by the UE.
5. T-RAN to T-AMF: Handover Notify.
   Handover is by this message considered as successful in T-RAN.
6a. [Conditional] T-AMF to S-AMF: Namf_Communication_N2InfoNotify.
   The T-AMF notifies to the S-AMF about the N2 handover notify received from the T-RAN by invoking the Namf_Communication_N2InfoNotify.
   A timer in S-AMF is started to supervise when resources in S-RAN shall be release.
6b. [Conditional] S-AMF to T-AMF: Namf_Communication_N2InfoNotify ACK (N2 SM Information (Secondary RAT usage data)).
   The S-AMF acknowledges by sending the Namf_Communication_N2InfoNotify ACK to the T-AMF. The N2 SM Information here is the one buffered at step 2a0 when applicable.
6c. [Conditional] S-AMF to SMF: Nsmf_PDUSession_ReleaseSMContext Request (SM Context ID, N2 SM Information (Secondary RAT Usage Data)).
   If the PDU Session(s) is not accepted by the T-AMF (e.g. S-NSSAI associated with the PDU Session is not available in the T-AMF), S-AMF triggers PDU Session Release procedure as specified in clause 4.3.4.2 after the S-AMF is notified for the reception of N2 Handover Notify in step 6a.
7. T-AMF to SMF: Nsmf_PDUSession_UpdateSMContext Request (Handover Complete indication for PDU Session ID, UE presence in LADN service area, N2 SM Information (Secondary RAT usage data)). The N2 SM Information here is the one received at step 6b when applicable.
   Handover Complete indication is sent per each PDU Session to the corresponding SMF to indicate the success of the N2 Handover.
   When an Nsmf_PDUSession_UpdateSMContext Response message arrived too late during the handover preparation phase (see step 8 of clause 4.9.1.3.2), or the PDU Session with SMF involvement is not accepted by T-RAN, Nsmf_PDUSession_UpdateSMContext Request (SM Context ID, Operation Type) is sent to the corresponding SMF allowing the SMF to deallocate a possibly allocated N3 UP address and Tunnel ID of the selected UPF. A PDU Session handled by that SMF is considered deactivated and handover attempt is terminated for that PDU Session. In the case that the AMF determines that the PDU Session is related to a LADN then the AMF provides the “UE presence in LADN service area”. If the AMF does not provide the “UE presence in LADN service area” indication and the SMF determines that the DNN corresponds to a LADN, then the SMF considers that the UE is OUT of the LADN service area.
   The SMF takes actions for the LADN PDU Session as defined in clause 5.6.5 of TS 23.501 [2] based on the “UE presence in LADN service area” indication.
   For each QoS Flow for which the SMF has received a reference to the fulfilled Alternative QoS Profile in step 10 of clause 4.9.1.3.2, the SMF notifies the PCF and the UE as described in TS 23.501 [2].
8a. [Conditional] SMF to T-UPF (intermediate): N4 Session Modification Request.
   If new T-UPF is inserted or an existing intermediate S-UPF is re-allocated, the SMF shall send N4 Session Modification Request indicating DL AN Tunnel Info of T-RAN to the T-UPF.
8b. [Conditional] T-UPF to SMF: N4 Session Modification Response.
   The T-UPF acknowledges by sending N4 Session Modification Response message to SMF.
9a. [Conditional] SMF to S-UPF (intermediate): N4 Session Modification Request.
   If UPF is not re-allocated, the SMF shall send N4 Session Modification Request indicating DL AN Tunnel Info of T-RAN to the S-UPF.
9b. [Conditional] S-UPF to SMF: N4 Session Modification Response.
   The S-UPF acknowledges by sending N4 Session Modification Response message to SMF.
10a. [Conditional] SMF to UPF (PSA): N4 Session Modification Request.
   For non-roaming or local breakout roaming scenario, the SMF sends N4 Session Modification Request message to PDU Session Anchor UPF, UPF (PSA), providing N3 AN Tunnel Info of T-RAN or the DL CN Tunnel Info of T-UPF if a new T-UPF is inserted or an existing intermediate S-UPF is re-allocated. If redundant transmission is performed for one or more QoS Flows of the PDU Session, two N3 AN Tunnel Info of T-RAN or two DL CN Tunnel Info of two T-UPFs are provided and the SMF indicates to the UPF (PSA) one of the AN/CN Tunnel Info is used as redundancy tunnel of the PDU Session. If the existing intermediate S-UPF terminating N9 toward the H-UPF (PDU Session Anchor) is re-allocated for the home routed roaming scenario, the V-SMF invokes an Nsmf_PDUSession_Update Request (DL CN Tunnel Info) service operation toward the H-SMF.
   In the case of the S-UPF acts as a UL CL or BP, the SMF indicates only one of the PDU Session Anchors to send the “end marker” packets. To ensure the “end marker” is the last user plane packet on the old path, the SMF should modify the path on other PDU Session Anchors before it indicates the PDU Session Anchor to send the “end marker” packets.
   If T-UPF is not inserted or an existing intermediate S-UPF is not re-allocated, step 10a and step 10b are skipped.
10b. [Conditional] UPF (PSA) to SMF: N4 Session Modification Response.
   The UPF (PSA) sends N4 Session Modification Response message to SMF. In order to assist the reordering function in the T-RAN, the UPF (PSA) sends one or more “end marker” packets for each N3 tunnel on the old path immediately after switching the path, the source NG-RAN shall forward the “end marker” packets to the target NG-RAN. At this point, UPF (PSA) starts sending downlink packets to the T-RAN, via T-UPF if a new T-UPF is inserted or an existing intermediate S-UPF is re-allocated. In the case of home routed roaming scenario, the H-SMF responds with the Nsmf_PDUSession_Update Response service operation to V-SMF once the H-UPF (PDU Session Anchor) is updated with the UL Tunnel Info of the T-UPF.
   When there are multiple UPFs (PSA), step 10a and step 10b are performed for each UPFs (PSA).
11. SMF to T-AMF: Nsmf_PDUSession_UpdateSMContext Response (PDU Session ID). SMF confirms reception of Handover Complete.
   If indirect data forwarding applies, the SMF starts an indirect data forwarding timer, to be used to release the resource of indirect data forwarding tunnel.
12. The UE initiates Mobility Registration Update procedure as described in clause 4.2.2.2.2.
   The target AMF knows that it is a Handover procedure and therefore the target AMF performs only a subset of the Registration procedure, specifically the steps 4, 5 and 10 in the Registration procedure for the context transfer between source AMF and target AMF are skipped.
   The target AMF, based on the S-NSSAIs subject to Network Slice-Specific Authentication and Authorization status information from source AMF in step 3 of clause 4.9.1.3.2, may decide to skip step 25 in the Registration procedure (i.e. NSSAA procedure) or whether to perform it if the status is pending.
13a. [Conditional] SMF to S-UPF (intermediate): N4 Session Release Request.
   If there is a source intermediate UPF, the SMF initiates resource release, after timer in step 6 or indirect data forwarding timer expires, by sending an N4 Session Release Request (Release Cause) to source UPF. This message is also used to release the indirect data forwarding resource in S-UPF.
13b. S-UPF to SMF: N4 Session Release Response.
   The S-UPF acknowledges with an N4 Session Release Response message to confirm the release of resources.
   In the case of indirect data forwarding, the resource of indirect data forwarding is also released.
14a. AMF to S-RAN: UE Context Release Command ( ).
   After the timer in step 6a expires, the AMF sends UE Context Release Command.
14b. S-RAN to AMF: UE Context Release Complete ( ).
   The source NG-RAN releases its resources related to the UE and responds with a UE Context Release Complete ( ) message.
15a. [Conditional] SMF to T-UPF: N4 Session Modification Request.
   If indirect forwarding applies and UPF is re-allocated, after timer of indirect data forwarding expires, the SMF sends N4 Session Modification Request to T-UPF to release the indirect data forwarding resource.
15b. [Conditional] T-UPF to SMF: N4 Session Modification Response.
   The T-UPF acknowledges with an N4 Session Modification Response message to confirm the release of indirect data forwarding resources.
If the AMF is subscribed to Mobility Event by other NFs, the AMF notifies the event to the corresponding NFs by invoking the Namf_EventExposure_Notify service operation as described in clause 4.15.4.2.
Upon reception of the Namf_EventExposure_Notify with an indication that UE is reachable only for regulatory prioritized service, the SMF deactivates the PDU Session if the service of the PDU Session is not regulatory prioritized. For home routed roaming case, the V-SMF triggers the deactivation of the PDU Session, in addition, the H-SMF refrains from sending downlink signalling if the signalling is not related to regulatory prioritized service upon receiving the notification.

### Next Change

### 5.2.5.3.2 Npcf_PolicyAuthorization_Create Service Operation

Service operation name: Npcf_PolicyAuthorization_Create
Description: Authorize the request and optionally determines and installs SM Policy Control Data according to the information provided by the NF Consumer or provides Port Management Information Container for ports on DS-TT or NW-TT, or User plane node Management Information Container.
Inputs, Required: UE (IP or MAC) address, identification of the application session context.
Inputs, Optional: GPSI(s) or SUPI(s) if available, Internal Group Identifier, DNN if available, S-NSSAI if available, Media type, Media format, bandwidth requirements, sponsored data connectivity information if applicable, flow description information as described in clause 6.1.3.6 of TS 23.503 [20], AF Application Identifier, AF Communication Service Identifier, AF Record Identifier, Flow status, Priority indicator, emergency indicator, ASP Identifier, resource allocation outcome, AF Application Event Identifier, a list of DNAI(s) and corresponding routing profile ID(s) or N6 traffic routing information, AF Transaction Id, Early and/or late notifications about UP path management events, temporal validity condition, spatial validity condition, Information for EAS IP Replacement in 5GC, Indication for EAS Relocation, AF indication for simultaneous connectivity over source and target PSA at edge relocation, EAS Correlation indication, Common EAS IP address, Traffic Correlation ID, FQDN(s) as described in clause 5.6.7 in 23.501 [2], Background Data Transfer Reference ID, priority sharing indicator as described in clause 6.1.3.15 in TS 23.503 [20], pre-emption control information as described in clause 6.1.3.15 in TS 23.503 [20], Port Management Information Container and related port number, User plane node Management Information Container, TSN AF parameters provided by the TSN AF to the PCF as described in clause 6.1.3.23 of TS 23.503 [20], TSCTSF parameters provided by the TSCTSF to the PCF as described in clause 6.1.3.23a and clause 6.1.3.23b of TS 23.503 [20], QoS parameter(s) to be measured, Reporting frequency, Target of reporting and optional an indication of local event notification as described in clause 6.1.3.21 of TS 23.503 [20], QoS Reference or individual QoS parameters as described in clause 6.1.3.22 of TS 23.503 [20], RT Latency Indication as described in clause 6.1.3.22 of TS 23.503 [20], ECN marking for L4S support indication as described in clause 6.1.3.22 of TS 23.503 [20], Alternative Service Requirements (containing one or more QoS Reference parameters or Requested Alternative QoS Parameter Sets in a prioritized order), TSC Assistance Container, MPS for Data Transport Service indicator as described in clause 6.1.3.11 of TS 23.503 [20], SFC Policy Identifier(s), Metadata.
   NOTE: When only one DNAI and corresponding routing profile ID(s) and the Indication for EAS Relocation are available, the presented DNAI is the target DNAI as defined in clause 6.3.7 of TS 23.548 [74].
Outputs, Required: Success or Failure (reason for failure, e.g. as defined in clauses 6.1.3.16 and clause 6.1.3.10 of TS 23.503 [20]).
Outputs, Optional: The service information that can be accepted by the PCF.

### Next Change

### 5.2.6.9.2 Nnef_AFsessionWithQoS_Create Service Operation

Service operation name: Nnef_AFsessionWithQoS Create
Description: The consumer requests the network to provide a specific QoS for an AF session.
Inputs, Required: AF Identifier, UE address (i.e. IP address or MAC address), Flow description information as described in clause 6.1.3.6 of TS 23.503 or External Application Identifier, QoS Reference or individual QoS parameters as described in clause 6.1.3.22 of TS 23.503 [20].
Inputs, Optional: Multi-Model Service ID, Multi-modal Service Requirements, time period, traffic volume, Alternative Service Requirements (containing one or more QoS Reference parameters or Requested Alternative QoS Parameter Sets in a prioritized order), QoS parameter(s) to be measured as defined in clause 5.45 of TS 23.501 [2], Reporting frequency, Target of reporting and optional an indication of local event notification as described in clause 6.1.3.21 of TS 23.503 [20], DNN if available, S-NSSAI if available, flow direction, Burst Arrival Time at UE (uplink) or UPF (downlink), Periodicity, Time domain, Survival Time, BAT Window or Capability for BAT adaptation, Periodicity Range, RT Latency Indication as described in clause 6.1.3.22 of TS 23.503 [20], ECN marking for L4S support indication as described in clause 6.1.3.22 of TS 23.503 [20], PDU Set QoS Parameters as described in clause 5.7.7 of TS 23.501 [2], Protocol Description (Indicates RTP/SRTP header type used by the flow).
Outputs, Required: Transaction Reference ID, result.
Output (optional): None.

### End of Changes for First CR

### Second Change Request (CR)

Editor's Note: During UE mobility, e.g., NG-RAN handover or local PSA UPF relocation, whether there are other impacts for ECN marking for L4S is FFS.

Provides explanation for UE mobility and non-homogeneous L4S support scenario. Revision (SA2 #157): If enabled by the QoS Monitoring policy information from PCF, SMF may activate QoS Monitoring of congestion information (see clause 5.45) if ECN marking for L4S is not supported e.g. due to inter-NG-RAN handover or PSA UPF relocation.

### Start of Change

### 5.37.3.1 General

L4S (Low Latency, Low Loss and Scalable Throughput) is described in IETF RFC 9330 [159], IETF RFC 9331 and IETF RFC 9332 [161]. It exposes congestion information by marking ECN bits in the IP header of the user IP packets between the UE and the application server to trigger application layer rate adaptation.
In 5G System, ECN marking for L4S may be supported. ECN marking for L4S is enabled on a per QoS Flow basis in the uplink and/or downlink direction and may be used for GBR and non-GBR QoS Flows. ECN marking for the L4S in the IP header is supported in either the NG-RAN (see clause 5.37.3.2 and TS 38.300 [27]), or in the PSA UPF (see clause 5.37.3.3).
   NOTE 1: Whether NG-RAN or PSA UPF based ECN marking for L4S is used is decided by SMF based on operator's network configuration and policies.
In the case of ECN marking for L4S by UPF, the NG-RAN is instructed to perform congestion information monitoring.
   NOTE 2: As for any QoS flow, QoS rules in the UE and PDRs in the PSA UPF control which packets are bound to the L4S enabled QoS flow. The Packet Filter Set in the QoS rule or PDR can use packet filter(s) in clause 5.7.6.2 (e.g. ECT(1) and/or IP 5 tuple) to steer traffic to an L4S enabled QoS Flow.
   NOTE 3: A QoS flow may be enabled with ECN marking for L4S requirement e.g. statically when a PDU session is established based on configuration in SMF or PCF, or dynamically based on detection of the L4S traffic e.g. via ECT(1) and/or IP 5 tuple in the IP header whereby SMF or PCF triggers a setup of a QoS Flow enabled for L4S, or by requests by an AF.
   NOTE 4: To support this functionality, the UE needs to support L4S feedback as described in IETF RFC 9330 [159], which is not in the scope of 3GPP.
When serving PSA UPF or NG-RAN is changed e.g., due to inter-NG-RAN handover or PSA UPF relocation, target NG-RAN and PSA UPF should keep contributing to ECN marking for L4S as the current congestion exposure method decided by SMF for the QoS Flow. However, if not available (e.g., ECN marking for L4S is not used anymore in 5GS supported), it should be notified to AF should be notified. In addition, if enabled by the QoS Monitoring policy information from PCF, SMF may activate QoS Monitoring of congestion information (see clause 5.45).

### Next Change

### 5.37.3.2 Support of ECN Marking for L4S in NG-RAN

ECN marking for L4S may be supported in NG-RAN as specified in TS 38.300 [27].
To enable support of ECN marking for L4S in NG-RAN, dedicated QoS Flow(s) are used for carrying L4S enabled IP traffic. The SMF may be configured to, based on PCC Rule provide an indication for ECN marking for L4S to NG-RAN for a corresponding QoS Flow(s), but in the absence of such configuration the use of L4S on a QoS flow is controlled by a coordinated configuration in NG-RAN and 5GC.
In case of inter NG-RAN UE mobility, if the ECN marking for L4S has been enabled on source NG-RAN, but the target NG-RAN does not support ECN marking for L4S, then the SMF may, if supported, enable ECN marking for L4S in PSA UPF as defined in 5.37.3.3. The criteria based on which NG-RAN decides to mark ECN bits for L4S is NG-RAN implementation specific.

### Next Change

### 5.37.3.3 Support of ECN Marking for L4S in PSA UPF

To enable ECN marking for L4S by a PSA UPF, a QoS Flow level ECN marking for L4S indicator may be sent by SMF to PSA UPF over N4. SMF also indicates to NG-RAN to report the congestion information (i.e. a percentage of packets that UPF uses for ECN marking for L4S) of the QoS Flow on UL and/or DL directions via GTP-U header extension to PSA UPF. If there is no UL packet when report for DL and/or UL needs to be provided, NG-RAN may generate an UL Dummy GTP-U Packet for such a reporting. Upon successful activation of congestion information reporting for UL and/or DL, PSA UPF uses information sent by NG-RAN in GTP-U header extension (see TS 38.415 and TS 38.300 [27]) to perform ECN bits marking for L4S for the corresponding direction. The criteria based on which NG-RAN decides to provide the congestion information is up to NG-RAN implementation.
In case of PSA UPF relocation, if the ECN marking for L4S has been enabled on source PSA UPF SMF should select a target PSA UPF supporting ECN marking for L4S. If the target PSA UPF does not support ECN marking for L4S, then SMF may, if supported, switch to ECN marking for L4S in target NG-RAN by following 5.37.3.2

### Next Change

### 5.45.3 Congestion Information Monitoring

When the authorized QoS Monitoring policy in the PCC rule to the SMF requests UL and/or DL congestion information monitoring and the PCC rule has enabled ECN marking for L4S (as in clause 6.1.3.21 of TS 23.503 [45]), SMF attempts to activate ECN marking for L4S for the QoS Flow as described in 5.37.3 first, and only when not supported, SMF activates congestion information monitoring as described above.
Only one of ECN marking for L4S (in the case of ECN marking for L4S in RAN as described in clause 5.37.3) and QoS monitoring of congestion information (in the case of ECN marking for L4S by PSA UPF as described in clause 5.37.3 or QoS monitoring for congestion information as described in this clause) can be requested to NG-RAN for a QoS Flow.
The NG-RAN may be required to provide the UL and/or DL QoS Flow congestion information (i.e. a percentage of congestion level for exposure). The UPF may be required to monitor the UL and/or DL QoS Flow congestion information reported from the NG-RAN.
QoS monitoring request to the NG-RAN and NG-RAN reporting for UL and/or DL QoS Flow congestion information to PSA UPF is as defined in 5.37.3. The PSA UPF reports the received UL and/or DL QoS Flow congestion information to the target NF as instructed by the QoS Monitoring request from the SMF.
Estimated bandwidth for 5QI may be exposed by NWDAF (according to information described in clause 6.9.2 of TS 23.288 [86]) to AF.

### Next Change

### 6.3.3.3 Selection of an UPF for a Particular PDU Session

If there is an existing PDU Session, and the SMF receives another PDU Session request to the same DNN and S-NSSAI, and if the SMF determines that interworking with EPC is supported for this PDU Session as specified in clause 4.11.5 of TS 23.502 [3], the SMF should select the same UPF, otherwise, if the SMF determines that interworking with EPC is not supported for the new PDU Session, a different UPF may be selected.
For the same DNN and S-NSSAI if different UPF are selected at 5GC, when the UE is moved to EPC network, there is no requirement to enforce APN-AMBR. Whether and how to apply APN-AMBR for the PDN Connection associated with this DNN/APN is implementation dependent, e.g. possibly only AMBR enforcement per PDU Session applies.
The following parameter(s) and information may be considered by the SMF for UPF selection and re-selection:
   UPF's dynamic load.
   Analytics (i.e. statistics or predictions) for UPF load, Service Experience analytics and/or DN Performance analytics per UP path (including UPF and/or DNAI and/or AS instance) and UE related analytics (UE mobility, UE communication, and expected UE behavioural parameters) as received from NWDAF (see TS 23.288 [86]), if NWDAF is deployed.
   UPF's relative static capacity among UPFs supporting the same DNN.
   UPF location available at the SMF.
   UE location information.
   Capability of the UPF and the functionality required for the particular UE session: An appropriate UPF can be selected by matching the functionality and features required for an UE.
   Data Network Name (DNN).
   PDU Session Type (i.e. IPv4, IPv6, IPv4v6, Ethernet Type or Unstructured Type) and if applicable, the static IP address/prefix.
   SSC mode selected for the PDU Session.
   UE subscription profile in UDM.
   DNAI as included in the PCC Rules and described in clause 5.6.7.
   Local operator policies.
   S-NSSAI.
   Access technology being used by the UE.
   Information related to user plane topology and user plane terminations, that may be deduced from:
   5G-AN-provided identities (e.g. CellID, TAI), available UPF(s) and DNAI(s);
   Identifiers (i.e. a FQDN and/or IP address(es)) of N3 terminations provided by a W-AGF or a TNGF or a TWIF;
   Information regarding the user plane interfaces of UPF(s). This information may be acquired by the SMF using N4;
   Information regarding the N3 User Plane termination(s) of the AN serving the UE. This may be deduced from 5G-AN-provided identities (e.g. CellID, TAI);
   Information regarding the N9 User Plane termination(s) of UPF(s) if needed;
   Information regarding the User plane termination(s) corresponding to DNAI(s).
   RSN, support for redundant GTP-U path or support for redundant transport path in the transport layer (as in clause 5.33.2) when redundant UP handling is applicable.
   Information regarding the ATSSS Steering Capability of the UE session (e.g. any combination of ATSSS-LL capability, MPTCP capability, MPQUIC capability) and information on the UPF support of RTT measurements without PMF.
   Support for UPF allocation of IP address/prefix.
   Support of the IPUPS functionality, specified in clause 5.8.2.14.
   Support for High latency communication (see clause 5.31.8).
   Support for ECN marking for L4S, specified in clause 5.37.3.
   User Plane Latency Requirements within AF request (see clause 5.6.7.1 and clause 6.3.6 of TS 23.548 [130]).
   NOTE 1: How the SMF determines information about the user plane network topology from information listed above, and what information is considered by the SMF, is based on operator configuration.
   NOTE 2: In this release the SMF uses no additional parameters for UPF selection for a PDU Session serving TSC. If a PDU Session of a specific DS-TT needs to connect to a specific UPF hosting a specific TSN 5GS bridge, this can be achieved e.g. by using a dedicated DNN/S-NSSAI combination.
A W-AGF or a TNGF may provide Identifiers of its N3 terminations when forwarding over N2 uplink NAS signalling to the 5GC. The AMF may relay this information to the SMF, as part of session management signalling for a new PDU Session.

### End of Changes for Second CR

### Examples

1. A core node 15 configured to, and/or comprising a communication interface 96 and/or comprising processing circuitry 98 configured to:
manage a first congestion mechanism based on at least one Policy and Charging Control, PCC, rule;
manage a second congestion mechanism based on the at least one PCC rule, the managing comprises one of enabling and disabling the first congestion mechanism based on the availability of the second congestion mechanism; and
optionally provide, to at least one application end point, congestion information based on one of the first and second congestion mechanism that is enabled.

2. The core node 15 of Example 1, wherein the first congestion mechanism is Quality of Service, QoS, monitoring; and
the second congestion mechanism is Low Latency, Low Loss and Scalable Throughput, L4S, marking for Explicit Congestion Notification, ECN; and

3. The core node 15 of any one of Examples 1-2, wherein the communication interface 96 and/or processing circuitry 98 is configured to prioritize the second congestion mechanism over the first congestion mechanism.

4. The core node 15 of any one of Examples 1-3, wherein the managing of the first congestion mechanism comprises activating the first congestion mechanism if the second congestion mechanism is unavailable.

5. The core node 15 of any one of Examples 1-4, wherein the communication interface 96 and/or processing circuitry 98 is configured to bind the at least one PCC rule to a Quality of Service, QoS, flow; and
one of the first and second congestion mechanism being applied to the QoS flow based on the managing of the first and second congestion mechanism.

6. The core node 15 of any one of Examples 1-5, wherein the communication interface 96 and/or processing circuitry 98 is configured to:
Receive, from a target handover network node 16, congestion information associated with the first congestion mechanism;
determine the received congestion information is different information requested during protocol data unit, PDU, session establishment or modification; and
enable the second congestion mechanism based on the determination.

7. A method implemented by a core node 15, the method comprising:
managing a first congestion mechanism based on at least one Policy and Charging Control, PCC, rule;
managing a second congestion mechanism based on the at least one PCC rule, the managing comprises one of enabling and disabling the first congestion mechanism based on the availability of the second congestion mechanism; and
optionally providing, to at least one application end point, congestion information based on one of the first and second congestion mechanism that is enabled.

8. The method of Example 7, wherein the first congestion mechanism is Quality of Service, QoS, monitoring; and
the second congestion mechanism is Low Latency, Low Loss and Scalable Throughput, L4S, marking for Explicit Congestion Notification, ECN; and

9. The method of any one of Examples 7-8, further comprising prioritizing the second congestion mechanism over the first congestion mechanism.

10. The method of any one of Examples 7-9, wherein the managing of the first congestion mechanism comprises activating the first congestion mechanism if the second congestion mechanism is unavailable.

11. The method of any one of Examples 7-10, further comprising binding the at least one PCC rule to a Quality of Service, QoS, flow; and
one of the first and second congestion mechanism being applied to the QoS flow based on the managing of the first and second congestion mechanism.

12. The method of any one of Examples 7-11, further comprising:
receiving, from a target handover network node 16, congestion information associated with the first congestion mechanism;
determining the received congestion information is different information requested during protocol data unit, PDU, session establishment or modification; and
enabling the second congestion mechanism based on the determination.

13. A non-transitory computer readable medium 102 having recorded thereon statements and instructions that, when executed by a processor of a core node 15, configure the core node 15 to implement a method according to any one of Examples 7-12.

As will be appreciated by one of skill in the art, the concepts described herein may be embodied as a method, data processing system, computer program product and/or computer storage media storing an executable computer program. Accordingly, the concepts described herein may take the form of an entirely hardware embodiment, an entirely software embodiment or an embodiment combining software and hardware aspects all generally referred to herein as a “circuit” or “module.” Any process, step, action and/or functionality described herein may be performed by, and/or associated to, a corresponding module, which may be implemented in software and/or firmware and/or hardware. Furthermore, the disclosure may take the form of a computer program product on a tangible (i.e. non-transitory) computer usable storage medium having computer program code embodied in the medium that can be executed by a computer. Any suitable tangible computer readable medium may be utilized including hard disks, CD-ROMs, electronic storage devices, optical storage devices, or magnetic storage devices.

Some embodiments are described herein with reference to flowchart illustrations and/or block diagrams of methods, systems and computer program products. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer (to thereby create a special purpose computer), special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable memory or storage medium that can direct a computer or other programmable data processing apparatus to function in a particular manner, such that the instructions stored in the computer readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

It is to be understood that the functions/acts noted in the blocks may occur out of the order noted in the operational illustrations. For example, two blocks shown in succession may in fact be executed substantially concurrently or the blocks may sometimes be executed in the reverse order, depending upon the functionality/acts involved. Although some of the diagrams include arrows on communication paths to show a primary direction of communication, it is to be understood that communication may occur in the opposite direction to the depicted arrows.

Computer program code for carrying out operations of the concepts described herein may be written in an object oriented programming language such as Python, Java® or C++. However, the computer program code for carrying out operations of the disclosure may also be written in conventional procedural programming languages, such as the “C” programming language. The program code may execute entirely on the user's computer, partly on the user's computer, as a stand-alone software package, partly on the user's computer and partly on a remote computer or entirely on the remote computer. In the latter scenario, the remote computer may be connected to the user's computer through a local area network (LAN) or a wide area network (WAN), or the connection may be made to an external computer (for example, through the Internet using an Internet Service Provider).

Many different embodiments have been disclosed herein, in connection with the above description and the drawings. It will be understood that it would be unduly repetitious and obfuscating to literally describe and illustrate every combination and subcombination of these embodiments. Accordingly, all embodiments can be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

Abbreviations that may be used in the preceding description include:

| Abbreviations | Explanation |
|---|---|
| AF | Application Function |
| AMF | Access and Mobility Function |
| API | Application Programming Interface |
| AR | Augmented Reality |
| AS | Application Server |
| CHF | Charging Function |
| DN | Data Network |
| ECN | Explicit Congestion Notification |
| IE | Information Element |
| L4S | Low Latency, Low Loss and Scalable Throughput |
| MNO | Mobile Network Operator |
| NEF | Network Exposure Function |
| NG-RAN | Next generation RAN |
| OAM | Operation and Maintenance |
| PCF | Policy Control Function |
| PSA | PDU Session Anchor |
| QoS | Quality of Service |
| RAN | Radio Access Network |
| SDF | Service Data Flow |
| SMF | Session Management Function |
| UE | User Equipment |
| UPF | User Plane Function |
| VR | Virtual Reality |
| XRM | eXtended Reality and Media |

It will be appreciated by persons skilled in the art that the embodiments described herein are not limited to what has been particularly shown and described herein above. In addition, unless mention was made above to the contrary, it should be noted that all of the accompanying drawings are not to scale. A variety of modifications and variations are possible in light of the above teachings without departing from the scope of the following claims.

1. A method implemented by a core node, the method comprising:
managing a first congestion mechanism that is based on at least one Policy and Charging Control (PCC) rule;
managing a second congestion mechanism that is based on the at least one PCC rule; and
the managing of the first congestion mechanism is associated with one of enabling and disabling the first congestion mechanism based on an availability of the second congestion mechanism.

2. The method of claim 1, wherein the first congestion mechanism is Quality of Service (QoS) monitoring; and
the second congestion mechanism is Explicit Congestion Notification (ECN) marking for Low Latency, Low Loss and Scalable Throughput (L4S).

3. The method of claim 1, wherein the managing of the first congestion mechanism is associated with enabling the first congestion mechanism if the second congestion mechanism is unavailable.

4. The method of claim 1, wherein the first congestion mechanism is Quality of Service (QoS) monitoring and the second congestion mechanism is Explicit Congestion Notification (ECN) marking for Low Latency, Low Loss and Scalable Throughput (L4S); and
the managing of the first congestion mechanism is associated with enabling the first congestion mechanism if the second congestion mechanism is unavailable.

5. The method of claim 1, further comprising prioritizing the second congestion mechanism over the first congestion mechanism.

6. The method of claim 1, further comprising binding the at least one PCC rule to a Quality of Service (QoS) flow to take into account a requirement to apply QoS monitoring; and
one of the first and second congestion mechanism being applied to the QoS flow based on the managing of the first and second congestion mechanism.

7. The method of claim 1, further comprising:
receiving, from a target handover network node, a notification indicating that at least one of the first congestion mechanism and the second congestion mechanism indicated during protocol data unit (PDU) session establishment is supported by the target network node; and
enabling one of the first congestion mechanism and the second congestion mechanism based on the notification.

8. The method of claim 1, further comprising receiving a notification that one of the first congestion mechanism and the second congestion mechanism is not supported at a target network node associated with a handover.

9. The method of claim 1, further comprising providing, to at least one application end point, congestion information based on one of the first and second congestion mechanism that is enabled.

10. The method of claim 1, wherein the core node is an application function AF.

11. A core node configured to:
manage a first congestion mechanism that is based on at least one Policy and Charging Control PCC rule;
manage a second congestion mechanism that is based on the at least one PCC rule; and
the managing of the first congestion mechanism is associated with one of enabling and disabling the first congestion mechanism based on an availability of the second congestion mechanism.

12. The core node of claim 11, wherein the first congestion mechanism is Quality of Service (QoS) monitoring; and
the second congestion mechanism is Explicit Congestion Notification (ECN) marking for Low Latency, Low Loss and Scalable Throughput (L4S).

13. The core node of claim 11, wherein the managing of the first congestion mechanism is associated with enabling the first congestion mechanism if the second congestion mechanism is unavailable.

14. The core node of claim 11, wherein the first congestion mechanism is Quality of Service (QoS) monitoring and the second congestion mechanism is Explicit Congestion Notification (ECN) marking for Low Latency, Low Loss and Scalable Throughput (L4S); and
the managing of the first congestion mechanism is associated with enabling the first congestion mechanism if the second congestion mechanism is unavailable.

15. The core node of claim 11, wherein the core node is configured to prioritize the second congestion mechanism over the first congestion mechanism.

16. The core node of claim 11, wherein the core node is configured to bind the at least one PCC rule to a Quality of Service (QoS) flow to take into account a requirement to apply QoS monitoring; and
one of the first and second congestion mechanism being applied to the QoS flow based on the managing of the first and second congestion mechanism.

17. The core node of claim 11, wherein the core node is configured to:
receive, from a target handover network node, a notification indicating that at least one of the first congestion mechanism and the second congestion mechanism indicated during protocol data unit (PDU) session establishment is supported by the target network node; and
enable one of the first congestion mechanism and the second congestion mechanism based on the notification.

18.-20. (canceled)

21. A method implemented by a network node, the method comprising:
receiving a request to implement one of a first congestion mechanism and a second congestion mechanism, the first congestion mechanism is Quality of Service (QoS) monitoring and the second congestion mechanism is Explicit Congestion Notification (ECN) marking for Low Latency, Low Loss and Scalable Throughput (L4S);
determining whether the requested one of the first congestion mechanism or the second congestion mechanism is supported at the network node; and
if the requested one of the first congestion mechanism or the second congestion mechanism is not supported by the network node, indicating, to a core node, that the request is not supported.

22. The method of claim 21, further comprising:
if the requested one of the first congestion mechanism or the second congestion mechanism is supported by the network node, indicating, to the core node, that the request is supported; and
implementing the requested one of the first congestion mechanism or the second congestion mechanism.

23. The method of claim 21, wherein the indication comprises one of:
a list of QoS flows with ECN markings for L4S that are one of enabled and disabled; and
a list of QoS flows with a QoS monitoring configuration that are one of enabled and disabled.

24. The method of claim 21, wherein the indication is an implicit indication that does not include information associated with whether one of ECN markings for L4S or QoS monitoring is enabled or disabled.

25. The method of claim 21, wherein the core node is an application function (AF).

26. The method of claim 21, wherein the network node is a target network node; and
the request is received from one of a source network node and core node.

27. A network node configured to:
receive a request to implement one of a first congestion mechanism and a second congestion mechanism, the first congestion mechanism is Quality of Service (QoS) monitoring and the second congestion mechanism is Explicit Congestion Notification (ECN) marking for Low Latency, Low Loss and Scalable Throughput (L4S);
determine whether the requested one of the first congestion mechanism or the second congestion mechanism is supported at the network node; and
if the requested one of the first congestion mechanism or the second congestion mechanism is not supported by the network node, indicate, to a core node, that the request is not supported.

28.-32. (canceled)
